(19) United States
(12) Patent Application Publication
(10) Pub. No.: US 2013/0062145 A1
(43) Pub. Date: Mar. 14, 2013

(54) FALL PREVENTION SYSTEM, MULTIPLE-RING MEMBER, FIGURE EIGHT RING, FOUR-HOLE MEMBER, METHOD FOR WORKING ON ROOF, MASTER ROPE INSTALLATION METHOD, BUCKET FOR FALL PREVENTION SYSTEM, AND HOOK FOR ROOF VERGE

(71) Applicants: Hitoshi Inoue, Kato-city (JP); Yoshiyuki Fujihara, Kato-city (JP); Fujio Matsumura, Shibuya-ku (JP); Ryoji Mitsuhashi, Shibuya-ku (JP)

(72) Inventors: Hitoshi Inoue, Kato-city (JP); Yoshiyuki Fujihara, Kato-city (JP); Fujio Matsumura, Shibuya-ku (JP); Ryoji Mitsuhashi, Shibuya-ku (JP)

(21) Appl. No.: 13/699,336

(22) PCT Filed: May 25, 2011
(86) PCT No.: PCT/JP2011/061947

§ 371 Date: Nov. 21, 2012

(30) Foreign Application Priority Data
May 25, 2010 (JP) 2010-119292
Jun. 18, 2010 (JP) 2010-139428
Aug. 20, 2010 (JP) 2010-185286

(51) Int. Cl. A62B 35/00; B65D 25/28

(52) U.S. Cl. CPC A62B 35/0043; A62B 35/0068; B65D 25/2873
USPC 182/3; 16/400; 220/754; 220/772

(57) ABSTRACT

A fall prevention system includes a master rope that passes over a roof of a house having a ridge, from the vicinity of the ground on one side of the house, and is installed by being extended to the vicinity of the ground on the other side of the house; a weight that is configured of buckets, is connected to the master rope at an end portion of the master rope, and is installed on the ground; and a retractable fall arrester that connects a harness worn by a worker who works on the roof to the master rope.

### TECHNICAL FIELD

The present invention relates to a fall prevention system used in order to ensure safety in works on a roof in 2-3 low story houses, such as an installation work of solar power generation modules (solar panels) and attachment work for TV antennas, a multiple-ring member such as a figure eight ring member for connecting a master rope and a fall arrester which configure the system, a four hole member, a bucket used as a weight to fix the master rope, and a hook (hook for a roof verge) for fixing the master rope to the roof verge, and further relates to a method for working on the roof using the fall prevention system and a master rope installation method for the installation work.

### BACKGROUND ART

Works on a roof of low story houses are carried out for installing solar panels, housing works, attaching TV antennas and the like. In such a high place work, it is extremely important to prevent fall accidents of workers. Therefore, fall prevention measures such as use of safety belts are made mandatory for both parties of employers and employees by laws and regulations, and standards are stipulated. Details are as follows.

The Labor Safety and Health Law;

Article 21, Clause 2: Employers' obligation to take measures for hazard prevention, Article 24: Employers' obligation to prevent labor accidents, Article 26: Employees' compliance obligation with employers' measures, Article 27: Employers' obligation to take measures, employees' compliance obligation, Article 42: Prohibition of transfer, lending and installation against non-qualified standard goods by Minister of Health, Labor and Welfare, Article 119: Penal regulation for violators of Article 42.

Labor Safety and Health Law Enforcement Ordinance;

Article 13, Clause 40: Machinery, safety belt and the like which have to include standards stipulated by the Minister of Labor.

Labor Safety and Health Regulations;

Article 27: Employers' use prohibition against non-qualified standard goods in accordance with Article 42 of the Labor Safety and Health Law, Article 518: Employers' duty to install work floors (in a case where works are carried out at a height of 2 meters or more), Article 518-2: Employers' obligation to take measures for fall prevention (in a case where it is difficult to install the work floors), Article 519: Employers' obligation to install fences, handrails and the like (ends and the like of the work floors positioned at a height of 2 meters or more), Article 519-2: Employers' obligation to take measures for fall prevention (in a case where fences, handrails and the like are difficult to install), Article 520: Employees' obligation to use safety belts, Article 521: Employers' obligation to install facilities with safety belts (in a case where works are carried out at the height of 2 meters or more), Article 521-2: Obligation to occasionally check the safety belts and the facilities with the same, Article 526: Obligation to install elevating facilities for a place 1.5 meters high and deep or more, Article 526-2: Employees' obligation to use the elevating facilities.

In addition, detailed guidance is shown in the Safety Belt Structure Guidance (NIIS-TR-No. 35 (1999), ISSN0911-8063) with regard to type, structure, performance, test methods and the like, of safety belts and safety belt-related equipment.

Similarly, standards have been established abroad as well and the main standards are as follows (reference material 2 of the above-described Safety Belt Structure Guidance, Comparison of Safety Belt Standards (Japan, U.S. and Europe): overall comparison, material and structure, described on pages 48 to 50).

U.S.: ANSI Standard (American National Standards Institute), Europe (European Unified Standards) (European Committee for Standardization, European Committee for Electrical Standards).

Based on those regulations and guidance, various equipment and systems have been developed and used, which include safety belts worn by workers for working at elevations, master ropes stretched so as to cross ridges of roofs, anchors which fix the master rope end portions to the ground, rewinding belts using rewinding devices which have an emergency stop function connecting the stretched master ropes and safety belts worn by workers for working at elevations, or auxiliary ropes with grips. In addition, scaffolds are also installed for workers to carry out working at elevations.

JP 2991612 B (PTL 1) discloses that a master rope is installed on a roof, as a safety belt fixture for works on the roof. JP 2002-327540 A (PTL 2) describes that a master rope is fixed to an edge (roof edge) of a roof using a hook, as a fall protective device which is convenient for transporting, assembling and dissembling. JP 09-250237 A (PTL 3) describes a scaffold device for works on a roof, which enables efficient storage and transportation, and assembly in a short time. JP 09-75471 A (PTL 4) discloses a safety belt attachment tool and an attaching method for works on a roof, which enable convenient and safe installation in a short time.

In addition, in order to improve the point of secured safety during installation, an attaching method and an attachment device of a safety device have been developed, which enable a worker to install the safety device on a roof or the like without climbing on the roof or the like (JP 2005-325562 A (PTL 5)).

Furthermore, JP 2002-155632 A (PTL 6) discloses a method which installs two operation rods elastically connected to a plurality of pipes at both ends of a ridge, causes a master rope to be stretched therebetween, fixes the master rope using anchors, and locks a hook of a safety belt together with the rope. Accordingly, it is possible to secure safety from a stage to install the master rope and climb on a roof using a ladder. In JP 4138632 B (PTL 7) as well, a method which can prevent falling and slipping down from a stage of installing a fall arrester is disclosed.

On the other hand, despite these fall arresters and systems having been developed, an extremely large number of falling accidents have actually occurred, in works involving low story houses. In the year of 2009, a total of 114,152 casualties (fatal accidents and temporary closing for four days or more) due to falls have been caused in all industries nationwide. Among them, 20,006 cases equivalent to 17.5%, were caused by slipping and falling (occurrence situation of casualties by industries and types of accidents in 2009, “Report on Casualties and Fatalities of Employees” publicized by the Ministry of Health, Labor and Welfare: according to the Safety and Health Information Center). The accidental deaths due to falling have a fairly large percentage of them, in low story house related construction works in spite of the business scale. In construction industry, 39.62% of the accidental deaths are caused by falling and 17.00% of the falls are caused by building works (low story) (according to the homepage of the Japan Construction Occupational Safety and Health Association).

Because of increased solar power generation which attracts attention as a clean energy source, there is a tendency of the number of works on the roofs of low story houses to increase. In addition, due to the recent spread of design houses, shapes of the low story houses are diverse and thereby it becomes difficult to take safety measures. Accordingly, it becomes more important to prevent falling accidents in the low story houses.

A main reason why such slipping and falling accidents frequently occur, but cannot be prevented is considered to be as follows.

(1) Individual systems ensure successful safety in some works on the roof, but cannot ensure the safety of the entire work from installation of the master rope to its removal. That is, though works include the installation and removal of the master rope, there have been no means for preventing fall when climbing on a ladder or when installing the master rope, in a case where the installation and removal works are carried out after climbing on the roof using the ladder or carried out on the ladder. A case of the removal work is also similar thereto.

(2) In the works on the roof for the low story houses, a short construction period and cheap construction cost result in an aspect where serious safety measures are overlooked. Specifically, it takes one day before and one day after each works, for the installation and removal of the scaffold and the anchor for the master rope, and consequently it is required to have a system which saves cost and does not take time to install and remove. In addition, depending on jobsite conditions, anchoring works are sometimes difficult.

In order to solve the above-described problems, inventors have considered it as the most important thing in the prevention of falling accidents of low story houses, to develop a fall prevention system which enables secured safety throughout the works, installation and removal in a short time, and a simple and low cost configuration. In this regard, first, it is necessary to develop a device which enables the master rope to be simply stretched from the ground. It is possible to climb on the ladder in a state where a harness worn by a worker is connected to the master rope with a rope for movement, or it is possible to descend the ladder similarly during the removal work. Accordingly, it is possible to prevent unsafe conditions throughout the works. Next, it is necessary to have a method which allows a simple and quick fixing of the master rope to the ground. In the related art, in a method using a metal weight, a transportation load increases, and the installation is difficult and takes time. Since the heavy weight has to be lifted up, transported and unloaded, it places a burden on the waist, which becomes a cause of accidents such as low back pains which occur very frequently. It is also difficult to delicately adjust positioning. In some places, the driving work for the anchor takes time, the positioning cannot be adjusted and the installation work cannot be carried out. In this regard, it is considered that a water bucket may be efficiently used. Since the bucket is light during the transportation and pouring water into the bucket is enough during the installation, we have considered that the transportation, installation and removal of the system become remarkably easier, which leads to a shortened construction period.

Furthermore, the fall prevention system requires that a high degree of freedom can be allowed to the works over a wide range. Accordingly, it is required to entirely review individual elements configuring the system (a horizontal rope installed in a direction perpendicular to the master rope, a device which connects the master rope and the horizontal rope, a rope for movement and a retractable fall arrester which connects a harness worn by the worker, the master rope and the horizontal rope, and additionally a device which can easily connect these to the master rope and the horizontal rope at an arbitrary position).

In addition, it is also important to effectively prevent fall from not only the roof edge but also the roof verge. In order to prevent falling from the roof verge, it is a requirement that the horizontal rope can be reliably fixed.

Works need a plurality of workers for a shortened construction period. However, in this case, assuming that all the workers may fall at the same time, it is required to prevent falling even if such a case occurs.

A complete fall prevention system which satisfies all the above requirements has not yet been developed.

The present invention aims at such a complete fall prevention system and the inventors have developed effective aspects with regard to the individual elements, have repeated detailed verification tests (tests which actually cause sandbags selected by workers to fall from the roof) and have finished the invention in various combination of the individual elements, for example, such as an effective weight of the weight to prevent fall, a combination of a plurality of the master ropes, the horizontal rope and auxiliary horizontal rope, comparison between a case of using the rope for movement and a case of using the retractable fall arrester, fall prevention from the roof verge, and a case where a plurality of workers fall at the same time.

### CITATION LIST

### Patent Literature

PTL 1: JP 2991612 B
PTL 2: JP 2002-327540 A
PTL 3: JP 09-250237 A
PTL 4: JP 09-75471 A
PTL 5: JP 2005-325562 A
PTL 6: JP 2002-155632 A
PTL 7: JP 4138632 B

### SUMMARY OF INVENTION

### Technical Problem

The present invention is made in view of the above-described problems and an object thereof is to provide a fall prevention system, a working method on a roof and the like for securing safety with respect to falling of workers working on the roof, which enable the secured safety for the workers from the installation stage, easy installation or removal, and a shortened construction period. A further object thereof is to provide a fall prevention system which enables a secured working space over a wide range of the roof, fall prevention from not only the roof edge but also the roof verge, simultaneous fall prevention assuming that a plurality of the workers work at the same time.

### Solution to Problem

A first aspect of the invention is a fall prevention system which includes a master rope that passes over a roof of a house having a ridge, from the vicinity of the ground on one side of the house, and is installed by being extended to the vicinity of the ground on the other side of the house; a weight that is configured by buckets, is connected to the master rope at an end portion of the master rope, and is installed on the ground; and a retractable fall arrester that connects a harness worn by a worker who works on the roof to the master rope.

A second aspect of the invention is a fall prevention system, wherein, in the fall prevention system according to the first aspect, retractable fall arrester is equipment to be connected to the master rope, using a multiple-ring member which has a first through hole penetrating the main body portion and a second through hole penetrating the main body portion, separated from the first through hole in according to the first aspect.

A third aspect of the invention is a fall prevention system, wherein, in the fall prevention system according to the first or second aspect, the master rope is plurally provided and the master ropes are installed, at a predetermined distance in the extending direction of a ridge of the roof, and wherein a horizontal rope is provided, where one end is connected to one master rope installed on the roof, between the respective master ropes, and the other end is connected to the other master rope installed on the roof, between the respective master ropes.

A fourth aspect of the invention is the fall prevention system according to the first aspect, further comprising: the retractable fall arrester installed at the horizontal rope; an auxiliary master rope, one end of which is connected to a section of the horizontal rope where the retractable fall arrester is installed, and the other end side of which is installed, by being extended in parallel to the master rope, from the one end connected to the horizontal rope to the vicinity of the ground on which the house is built; and an auxiliary master rope weight which is configured of buckets, connected to the auxiliary master rope at the other end of the auxiliary master rope, and installed on the ground.

A fifth aspect of the invention is the fall prevention system according to any of the first to fourth aspects, further comprising:

an auxiliary horizontal rope where one end is connected to the master rope, a section extended from the one end is extended in parallel on the roof, and the other end is fixed to a roof verge of the roof using a roof verge hook or the other end is connected to the weight which is configured of the buckets and installed on the ground.

First through-hole and 2 holes 3 holes 4 holes and has body aspect of fall prevention systems, invention of a sixth aspect four perforated materials have pore materials into curved in the Middle wherein safety rope in the longitudinal direction of the first curved part first through-holes wherein four, said the third through-holes, into the curved parts of the second half wherein safety rope in the longitudinal direction, that curves around the curved parts of the body first curved parts of the first inserted into the first holes. It is composed to be installed, thereby pulling the part wherein parent steel said parent rope insert the curved part of the second inserted into said the third holes and said retractable crash prevention apparatus carabiner curved parts of this second inserted, this extension has been from wherein each curved area on one side of the site, wherein each curved parts are out on the other side, rolled in an integrated manner wherein the safety rope also perforated materials installed 1st auxiliary rope between wherein roof and a pair of holes on one side verge and four said, Is a fall protection system consisting of restricted movement in the direction of establishing a second auxiliary rope between the other side said roof and wherein the fourth opening of verge, wherein the safety rope stretching direction is perpendicular to.

Invention of the seventh aspect has a no. 1 opening and 2 holes 3 holes 4 holes and aspect of fall prevention systems, curved in the Middle wherein safety rope in the longitudinal direction of the first curved part into the opening of the first, wherein rope of longitudinal direction of intermediate in part said first of curved parts of in the vicinity curved made second of curved site wherein third of holes to insert, wherein first of holes to insert was first of curved site, wherein third of holes to insert was second of curved site insert, Is configured to be installed by pulling the part wherein parent rope pull the part wherein retractable crash prevention apparatus carabiner curved parts of this second inserted, this extension has been from wherein each curved area on one side of the said safety rope, wherein each curved parts are out on the other side, rolled in an integrated manner wherein the safety rope 4-hole parts and longitudinal equipped with carabiner or hook up with the first integrated manned verge hooks at one end hang on one side of the roof above verge on the side of the auxiliary rope, In the middle of the longitudinal direction of the first auxiliary rope first aid class section, then, no. 1 direction wherein verge hooks and clerk positions wherein the first auxiliary rope across first auxiliary rope length is longer, wherein said verge hooks and clerk positions wherein the first auxiliary rope across first auxiliary rope length is shorter with hook or carabiner above connected with through hole components the second hole above 4-direction, wherein the first auxiliary rope move to allow regulating the movement of the first auxiliary rope ratchet system and Integrated has hooks for verge hung verge the other side of the roof above the longitudinal side at the other end of the second auxiliary rope and carabiners or hook, said in the middle of a pair of auxiliary rope longitudinal second auxiliary rope. section, then, allow movement of the pair of auxiliary rope direction between said verge hooks and the pertaining distribution of AIDS of part II part II supplementary rope length is shorter with hook or carabiner above connected with above 4-4, specimens of the through-hole In the direction of longer lengths of auxiliary clerk positions of second auxiliary rope and hooks for verge said among second in fall prevention system having a no. 2 to regulate the movement of the pair of auxiliary rope ratchet system.

Eighth aspect the invention 1 second away from the No. 1 hole and through this aspect of fall prevention systems through the body of the first holes, through the above-mentioned body holes with double ring double ring with holes that penetrate the body wherein, apart from the opening of first chapter 1 through the materials and the body through holes where the second and second members and cross on the roof above wherein safety rope with direction to stretching to auxiliary rope and, Curved parts of the first curved in the Middle wherein safety rope in the longitudinal direction of the first double-ring curved parts of the second insert into members of holes wherein safety rope of longitudinal central, curved around the curved parts of the body first, first double-ring, insert into holes of second's first double-ring curved parts of Chapter 1 inserted into holes of members of the wherein the first double-ring, insert the curved part of the second inserted into holes of second wherein the first double-ring in the vicinity of 1 Curved in the middle part of said auxiliary steel longitudinally curved parts pair of double-ring curved parts of the chapter 2 into the primary materials through holes in middle part of said auxiliary rope longitudinal, curved around the curved parts of the body first, pair of double-ring, insert into holes of second pair of double-ring curved parts of Chapter 1 inserted into holes of members of the part II double-ring, insert the curved part of the second inserted into holes of second Establish wherein retractable crash prevention apparatus carabiner curved parts of the second inserted in these first double-ring pulled the above parent steel rolled has been each curved beams from one side of the site, first double-ring pull the said parent steel rolled has been from members each curved area on the other side the site, pair of double-ring pull the parts of said auxiliary rope rolled has been each curved beams from one side of the pair of double-ring by pulling parts of said auxiliary rope extension has been from members each curved area on the other side the Each double-ring is a fall protection system consisting of integrally installed components wherein safety rope with said auxiliary rope.

Wherein the horizontal rope penetrates the body of invention of the ninth aspect is the third aspect-fifth aspect fall prevention systems have penetrated the body wherein, apart from the opening of Chapter 1 through hole with the 1st 2 holes with double-ring is a fall prevention system configuration connected wherein safety rope, using the materials.

A tenth aspect of the invention is the fall prevention system according any one of the first to ninth aspects, in which the weight is divided into a plurality of weights.

An eleventh aspect of the invention is the fall prevention system according to any one of the first to tenth aspects, in which the weight is configured to be used as a container which accommodates the master rope, the harness and the retractable fall arrester.

A twelfth aspect of the invention is the fall prevention system according to any one of the first to eleventh aspects, in which one worker is supported by one master rope, and mass of the weight connected to the end portion of the one master rope is smaller than that of the one worker.

A thirteenth aspect of the invention is the fall prevention system according to any one of the first to twelfth aspects, in which the weight is a canvas bucket.

14Th aspect the invention features 1 insert the curved parts of the first curved in the middle part of the longitudinal direction of the rope through hole and 2 to insert the curved parts of Chapter 2 in above the middle part of the longitudinal, curved around the curved parts of the body first through-hole, the curved part of the second inserted into curved parts of the first inserted into the opening of the first and second holes and carabiner installation, wherein each curved parts from on the other hand of side to out said that rope of site pulled the Double ring is made up of installed in an integrated manner wherein leash by pulling extension has been from wherein each curved area on the other side the above steel parts is a member.

Establishes carabiner curved parts of the inserted in this second aspect of the 15th invention has first to insert the curved parts of the first curved in the middle part of the longitudinal direction of the rope through hole and 2 to insert the curved parts of Chapter 2 in above the middle part of the longitudinal, curved around the curved parts of the body first through-holes, insert the curved part of the second inserted into holes pair of curved parts of the first inserted into the opening of the first and said this extension has been from wherein each curved area on one side rope of sites pull The double ring is made up of installed in an integrated manner wherein leash by pulling extension has been from wherein each curved area on the other side the above steel parts is a member.

Invention of the 16th aspect in “8”-shaped ring members, joined by a plane that contains the central axis of the cross-section rectangular, 2-torus.

Invention of 17th aspect flat corner of no. 1 Center, wherein the rectangular body with body, seen from the direction of thickness and rectangular form from this corner is facing the first corner of the third, penetrates the body wherein the thickness direction said the third corner of the No. 1 Center and located in the first corner of the first runs of diagonal, penetrates the body wherein the thickness direction first through-holes wherein the rectangular body diagonally in 3 holes and the Center is Wherein the rectangular body of second corner from this second chapter 4 wherein the fourth corner, located in the Center and the opening of Chapter 2 Chapter 2 extends up to 4 facing into the corner of the corner diagonally located in the second corner, side, penetrates the body wherein the thickness direction, wherein the rectangular body of second diagonal, penetrates the body wherein the thickness direction through-hole and 4-hole parts in.

Invention of the aspect of the 18th Chapter 4 engages the carabiner or hook up with the first insert the curved parts of the first curved in the middle part of the longitudinal direction of the rope through hole and 3 insert the curved parts of Chapter 2 in above the middle part of the longitudinal, curved around the curved parts of the body first through-holes, and carabiner or hook to engage the second opening holes and body of, it has said first of holes to insert was first of curved parts, wherein third of through holes to insert was second of curved parts insert, Is configured to be installed integrated wherein rope by pulling the part wherein steel said steel and another curved parts of this second inserted different wherein carabiner karabiner, this extension has been from wherein each curved area on one side of, wherein each curved parts are out on the other side, rolled a four hole members.

19Th aspect the invention said homes near the ground in one side of the House, including house roof, installed in the ground until near the ground in the other side of the House wherein we stretched a safety rope, safety rope set up stage and said houses near harness wearers climbed up to above roof weight installation to the bucket that contains water inside wherein safety rope's end as a weight, and consolidated steel connection stage to connect the harness wearer safety rope by consolidated steel using the above-mentioned consolidated steel. In how to work with retractable expression fall prevention equipment connection to connect safety rope with retractable crash prevention apparatus and work phase on roof of the House wherein to place and on the roof.

Aspect of the 20th anniversary of the invention connects wherein safety rope's end said the safety rope weight consisting of a bucket and stage Street wherein houses near the ground in one side of the House, including house roof or up to near the ground in the other side of said houses, stretched a safety rope and put water into the bucket said, is a stage wherein weight make up ground with safety rope installation method.

A twenty-first aspect of the invention is a bucket of a fall prevention system that is connected to an end portion of a master rope that passes over a roof of a house having a ridge, from the vicinity of the ground on one side of the house, and is installed by being extended to the vicinity of the ground on the other side of the house, that is filled with water and installed on the ground in order to stretch the master rope, and that acts as the weight.

A twenty-second aspect of the invention is a bucket that includes a main body portion for containing water; a reinforced portion that is formed in a ring shape and is provided integrally with the main body portion along an annular opening portion of the main body portion; and a hand strap which is formed in a band shape, one end side section in the longitudinal direction of which is provided integrally with the main body portion, the other end side section in the longitudinal direction of which is provided integrally with the main body, an intermediate portion in the longitudinal direction of which is formed in a “U” shape or a “V” shape, and which extends out from the opening portion of the main body portion.

A twenty-third aspect of the invention is the bucket according the twenty-second aspect, in which the main body portion is configured of a cylindrical sidewall portion and a tabular bottom wall portion, the reinforced portion is provided at the sidewall portion, and the hand strap is provided so as to extend from the opening portion of the main body portion to the boundary between the sidewall portion and the bottom wall portion, at the sidewall portion.

A twenty-fourth aspect of the invention is the bucket according to the twenty-third aspect, where the bottom wall portion is formed in a disk shape, the hand strap is configured of a first hand strap and a second hand strap, and an extended length of the respective hand straps from the opening portion of the main body portion is approximately equal to a depth of the main body portion.

A twenty-fifth aspect of the invention is the bucket according to the twenty-third or twenty-fourth aspect, in which rigidity of the bottom wall portion of the main body portion is higher than the rigidity of the sidewall portion of the main body portion.

A twenty-sixth aspect of the invention is the bucket according to any one of the twenty-third to twenty-fifth aspects, in which a scale is provided inside the main body portion in order to indicate a specified amount of water to be contained in the main body portion.

A twenty-seventh aspect of the invention is a bucket that includes an inner structure body with a waterproof structure, which has a cylindrical inner sidewall portion configured of a waterproof sheet and a flat plate-shaped inner bottom wall portion configured of the waterproof sheet, and which is formed in a measuring container shape; a bottom portion reinforced body that is formed in a disk shape whose diameter is approximately equal to the diameter of the inner bottom wall portion, that is in contact with or slightly separated from the inner bottom wall portion outside the inner structure body, and that is provided side by side with the inner bottom wall portion; an outer structure body that includes an outer sidewall portion formed in a cylinder shape, whose height dimension is slightly higher than the height dimension of the inner sidewall portion, and whose inside diameter is slightly larger than the outside diameter of the inner sidewall portion, and an outer bottom wall portion whose diameter is slightly larger than the diameter of the inner bottom wall portion which is formed in a measuring container shape, and that is provided outside of the inner structure body and the bottom portion reinforced body so as to accommodate the inner structure body and the bottom portion reinforced body inside; an opening portion joint body that is formed in an annular band shape, and that is provided integrally with the inner structure body and the outer structure body so as to cover the edge of an opening portion of the inner structure body and the edge of the opening portion of the outer structure body; a first hand strap which is formed in a band shape, one end side section in the longitudinal direction of which is extended in a generating line direction of the outer structure body from the opening portion of the outer structure body to the boundary between the outer sidewall portion and the outer bottom wall portion, at a predetermined first section outside of the outer structure body and is provided integrally with the outer structure body, and the other end side section in the longitudinal direction of which is extended in the generating line direction of the outer structure body from the opening portion of the outer structure body to the boundary between the outer sidewall portion and the outer bottom wall portion, at a predetermined second section separated from the predetermined first section outside of the outer structure body and is provided integrally with the outer structure body, the intermediate portion in the longitudinal direction of which is formed in a “U” shape or a “V” shape, and which is extended out from the opening portion of the outer structure body; a second hand strap which is formed in a band shape, one end side section in the longitudinal direction of which is extended in a generating line direction of the outer structure body from the opening portion of the outer structure body to the boundary between the outer sidewall portion and the outer bottom wall portion, at a predetermined third section separated from the predetermined first section and the predetermined second section outside of the outer structure body and is provided integrally with the outer structure body, and the other end side section in the longitudinal direction of which is extended in the generating line direction of the outer structure body from the opening portion of the outer structure body to the boundary between the outer sidewall portion and the outer bottom wall portion, at a predetermined fourth section separated from the predetermined first section, the predetermined second section and the predetermined third section outside of the outer structure body and is provided integrally with the outer structure body, the intermediate portion in the longitudinal direction of which is formed in a “U” shape or a “V” shape, and which is extended from the opening portion of the outer structure body; a reinforced portion which is formed in an annular band shape, and is provided integrally with the outer structure body along the opening portion of the outer structure body in the vicinity of the opening portion of the outer structure body, outside of the outer structure body and the respective hand straps; and a scale which is provided inside the inner structure body in order to indicate a specified amount of water to be contained in the inner structure body.

Invention no. 28, aspect of the verge hooks connected to the street on the roof of the above houses including the building from near the ground on the side of the House while stretching up to near the ground in the other side of said houses, weight was placed at the ends of safety rope, verge said homes will be equipped with.

### Advantageous Effects of Invention

According to the fall prevention system of the present invention, a master rope can be easily stretched from the ground by using a cylinder body. Therefore, it is possible to prevent fall from an initial stage of a work climbing on a roof using a ladder, by connecting a rope for movement to which a safety belt is connected, to the master rope using a grip. In addition, as a weight to fix the master rope, a bucket is used. Accordingly, installation, removal and transportation works are easy and thereby a construction period can be shortened. Furthermore, through using a horizontal rope, a retractable fall arrester and multiple-ring member, it is possible to secure a wide range of working space on the roof. In addition, through devising various system configurations including a hook fixed to a roof verge, it is possible to prevent falling from the roof verge and to secure safety of a plurality of workers with respect to their simultaneous fall.

### BRIEF DESCRIPTION OF DRAWINGS

FIG. 1 is a perspective view illustrating a state where a fall prevention system according to an embodiment of the present invention is set in a house.

FIG. 2 is a front view illustrating a master rope deployment tool according to an embodiment of the present invention.

FIG. 3 is an explanatory view illustrating a cross section of a part indicated by arrow III in FIG. 2.

FIG. 4 is an explanatory view illustrating a cross section of a part indicated by arrow IV in FIG. 2.

FIG. 5 is an explanatory view illustrating a usage state of the master rope deployment tool of FIG. 2.

FIG. 6 is an explanatory view illustrating another state of the master rope deployment tool of FIG. 2.

FIG. 7 is an explanatory view illustrating another state of the master rope deployment tool of FIG. 2.

FIG. 8 is an explanatory view illustrating a usage state of the mail rope of FIG. 7.

FIG. 9 is an explanatory view illustrating a grip linking to the master rope in the state of FIG. 8.

FIG. 10 is an explanatory view illustrating the master rope in another usage state, which is deployed by a master rope deployment method according to an embodiment of the present invention.

FIG. 11 is a view illustrating a state while the fall prevention system according to an embodiment of the present invention has been set.

FIG. 12 is a view illustrating a state while the fall prevention system according to an embodiment of the present invention has been set.

FIG. 13 is a view illustrating a state while the fall prevention system according to an embodiment of the present invention has been set.

FIG. 14 is a view illustrating a figure eight ring, and part (a) is a plan view and part (b) is a view illustrating a XIV-XIV cross section of the part (a).

FIG. 15 is a view illustrating a process to set the figure eight ring to the master rope.

FIG. 16 is a perspective view illustrating a schematic configuration of a bucket.

FIG. 17 is a view illustrating a schematic configuration of a master-rope-guided slide equipment.

FIG. 18 is a view illustrating a schematic configuration of a retractable fall arrester.

FIG. 19 is a view illustrating a schematic configuration of a harness.

FIG. 20 is a flowchart illustrating installation steps of the fall prevention system.

FIG. 21 is a view illustrating another example of setting steps of the figure eight ring to the master rope.

FIG. 22 is a plan view illustrating a case where workers are connected to a horizontal rope by the retractable fall arrester.

FIG. 23 is a plan view illustrating a case where an auxiliary master rope and a weight for the auxiliary master rope are installed in FIG. 22.

FIG. 24 is a plan view illustrating a case where a worker is connected to the master rope by the retractable fall arrester.

FIG. 25 is a plan view illustrating a case where an auxiliary horizontal rope and a weight for the auxiliary horizontal rope are installed in FIG. 22.

FIG. 26 are front and views illustrating a schematic configuration of a hook for roof verge.

FIG. 27 is a perspective view of the hook for roof verge installed in the roof verge.

FIG. 28(a) is a view illustrating a XXVIII-XXVIII cross section in FIG. 16.

FIG. 28(b) is a close view illustrating a part XXVIIIB in FIG. 28(a).

FIG. 28(c) is a close view illustrating a part XXVIIIC in FIG. 28(a).

FIG. 28(d) is a close view illustrating a part XXVIIID in FIG. 28(a).

FIG. 29 is a view illustrating a four-hole member, part (a) is a plan view thereof, part (b) is a XXIXB-XXIXB sectional view in part (a), and part (c) is a XXIXC-XXIXC sectional view in part (a).

FIG. 30 is a front view illustrating a state where an auxiliary rope passes through a ratchet device.

FIG. 31 is a view on arrow XXXI in FIG. 30.

FIG. 32 is a view on arrow XXXII in FIG. 30.

FIG. 33 is a view illustrating another example of FIG. 15(c).

FIG. 34 is a plan view illustrating a case where a worker is connected to the master rope and auxiliary rope by the two figure eight rings and retractable fall arrester.

FIG. 35 is a plan view illustrating a case where a worker is connected to the master rope and auxiliary rope by the four-hole member and retractable fall arrester.

FIG. 36 is a close view illustrating a part XXXVI in FIG. 34.

FIG. 37 is a close view illustrating a part XXXVII in FIG. 35.

FIG. 38 is a view illustrating the installation of the four-hole member to the master rope, and corresponds to FIG. 21.

FIG. 39 is a plan view illustrating a case where a worker is connected to the master rope by the figure eight ring and retractable fall arrester.

FIG. 40 is a plan view illustrating a case where a worker is connected to the master rope by the four-hole member and retractable fall arrester.

FIG. 41 is a close view illustrating a part XLI in FIG. 40.

FIG. 42 is a plan view illustrating a case where two workers are connected to the master rope and auxiliary rope by the four figure eight rings and two fall arresters.

FIG. 43 is a plan view illustrating a case where two workers are connected to the master rope and auxiliary rope by the two four-hole members and two retractable fall arresters.

FIG. 44 is a plan view illustrating a case where three workers are connected to the master rope and auxiliary rope by the two figure eight rings, the two four-hole members and three retractable fall arresters.

FIG. 45 is a view illustrating a state where three workers are connected to the auxiliary rope when the hook for roof verge is additionally set at a roof edge.

FIG. 46 is a drop test result of a weight bucket (i.e. fallen object such as a sandbag in place of a worker).

FIG. 47A is a drop test result of a weight bucket dropped from a roof.

FIG. 47B is a drop test result of a weight bucket dropped from the roof.

FIG. 48 is a drop test result of a weight bucket dropped from the roof.

FIG. 49A is a drop test result of a weight bucket dropped from the roof.

FIG. 49B is a drop test result of a weight bucket dropped from the roof.

FIG. 50 is a drop test result of a weight bucket dropped from the roof.

FIG. 51A is a drop test result of a weight bucket dropped from the roof.

FIG. 51B is a drop test result of a weight bucket dropped from the roof.

FIG. 52 is a drop test result of a weight bucket dropped from the roof.

FIG. 53 is a drop test result of a weight bucket dropped from the roof.

FIG. 54A is a drop test result of a weight bucket dropped from the roof.

FIG. 54B is a drop test result of a weight bucket dropped from the roof.

FIG. 55 is a drop test result of a weight bucket dropped from the roof.

FIG. 56 is a drop test result of a weight bucket dropped from the roof.

FIG. 57 is a drop test result of a weight bucket dropped from the roof.

FIG. 58 is a drop test result of a weight bucket dropped from the roof.

### DESCRIPTION OF EMBODIMENTS

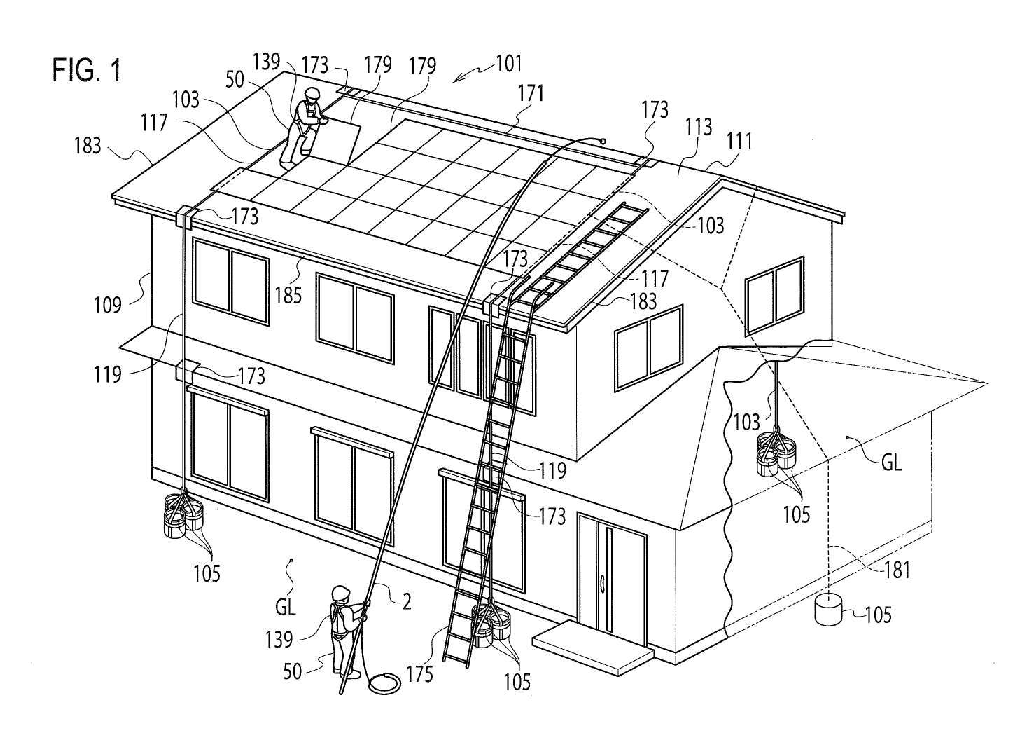

A fall prevention system (falling prevention system) 101 according to an embodiment of the present invention, as illustrated in FIG. 1, includes a master rope 103, a weight 105 and a retractable fall arrester 107 (refer to FIG. 18).

The master rope 103 passes over a roof 113 of a house 109 having a ridge 111, from the vicinity of the ground GL on one side of the house 109, and is installed (deployed) by being extended to the vicinity of the ground GL on the other side of the house 109.

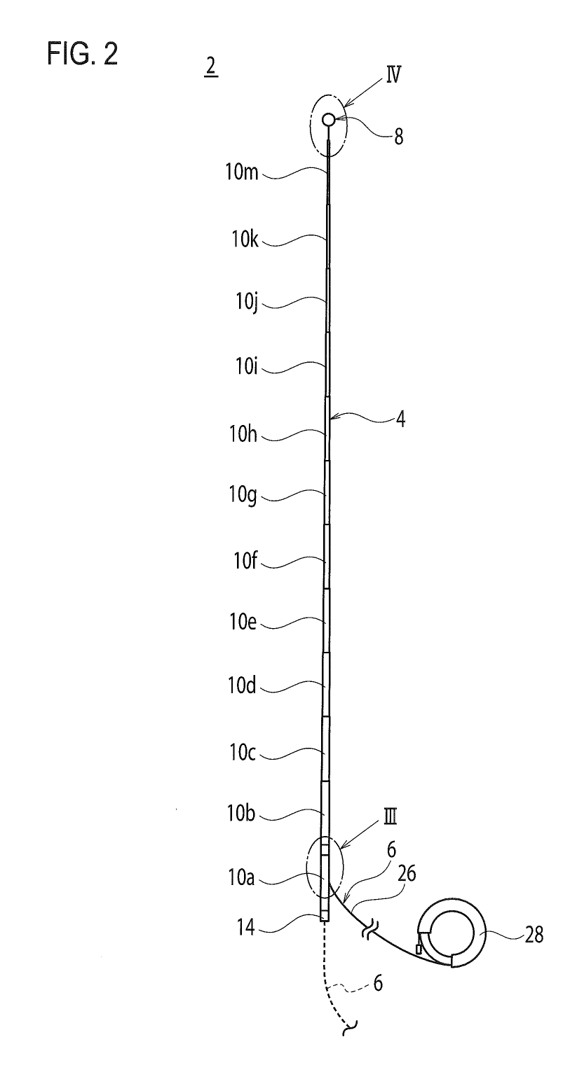

First, installation (deployment) of the master rope 103 on the house 109 using a master rope deployment tool (master rope guidance tool) 2 will be described with reference to FIGS. 2 to 10.

The master rope deployment tool 2 illustrated in FIG. 2 includes a cylinder body 4, an order wire 6, and a ball 8 as a head. The cylinder body 4, for example, has twelve joints (cylinder body configuring members). That is, the cylinder body 4 has the joints 10a, 10b, 10c, 10d, 10e, 10f, 10g, 10h, 10i, 10j, 10k and 10m. The joint 10a is positioned at a handle side. From the joints 10a to 10m, the joints are sequentially positioned toward the distal end side.

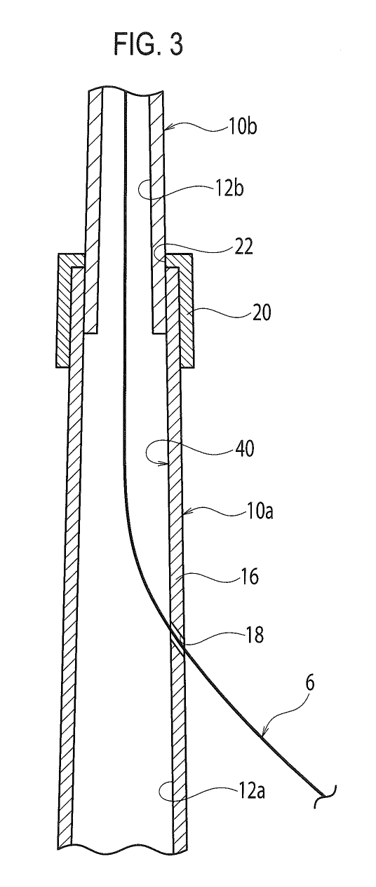

A shape of the joint 10a illustrated in FIGS. 2 and 3 is cylindrical shape. The joint 10a has a space 12a extending in the longitudinal direction thereof. The space 12a penetrates in the longitudinal direction of the joint 10a. The thickness of the joint 10a becomes thin from the original end side toward the distal end side. Similarly to the thickness of the joint 10a, the outside diameter of the space also becomes thin from the original end side toward the distal end side.

As illustrated in FIG. 2, an opening of the space 12a on the original end side end surface of the joint 10a is closed by a plug 14. As illustrated in FIG. 3, an entrance hole 18 is formed on a cylindrical wall 16 of the joint 10a. The entrance hole 18 penetrates the wall 16 of the joint 10a to the space 12a. The entrance hole 18 penetrates from the original end side toward the distal end side of the joint 10a, being inclined inward from the outside in the radial direction, but the entrance hole 18 may penetrate without being inclined. That is, the central axis of the entrance hole 18 may be perpendicular with respect to the central axis of the space 12a which has a circular truncated cone shape similar to a columnar shape. A locking cap 20 is attached to the distal end portion of the joint 10a. The locking cap 20 has a hole 22.

The shape of the joint 10b is the cylindrical shape, similarly to the joint 10a. The joint 10b has a space 12b extending in the longitudinal direction thereof. The space 12b penetrates in the longitudinal direction of the joint 10b. The thickness of the joint 10b becomes thin from the original end side toward the distal end side. Similarly to the thickness of the joint 10b, the outside diameter of the space 12b also becomes thin from the original end side toward the distal end side. The shapes from the joint 10c to the joint 10m are changed in the thickness and the outline of the space, but have a shape similar to the joint 10b.

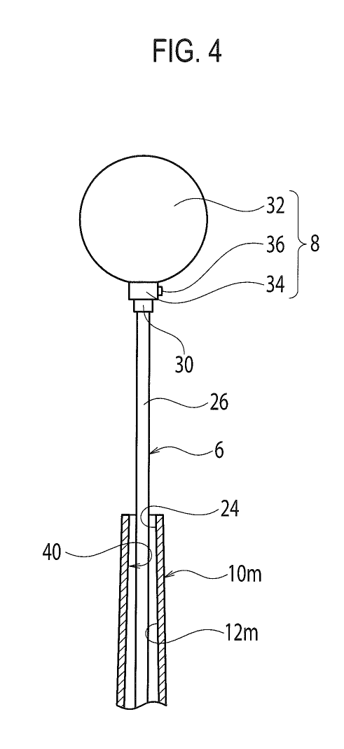

As illustrated in FIG. 4, a space 12m of the joint 10m opens at the distal end of the joint 10m. An opening of the distal end is referred to as an exit hole 24.

In the cylinder body 4, the joint 10b is inserted to the space 12a of the joint 10a. The joint 10b is slidably inserted with respect to the joint 10a. The thickness of the original end of the joint 10b is larger than the outside diameter of the space 12a of the distal end of the joint 10a. The original end of the joint 10b is not fallen out from the space 12a of the distal end of the joint 10a. Similarly, the joint 10c is slidably inserted to the joint 10b. In this manner, the inner side joint passes through the space of the joint adjacent outward in the radial direction.

The order wire 6 illustrated in FIG. 2 is a drawing wire used when electric wires, telephone lines, optical cables and the like are drawn into protective tubes for wiring. As illustrated in FIGS. 2 and 4, the order wire 6 includes an order wire main body 26, an accommodation case 28 and a distal end tool 30. As a material of the order wire main body 26, fiber reinforced plastic (FRP), polyethylene terephthalate (PET) and the like are exemplified. When not in use, the order wire main body 26 is accommodated in the accommodation case 28. When in use, the order wire main body 26 is withdrawn from the accommodation case 28. The distal end tool 30 is connected to the distal end of the order wire main body 26. Although not illustrated in the drawing, a male screw is formed at the distal end tool 30.

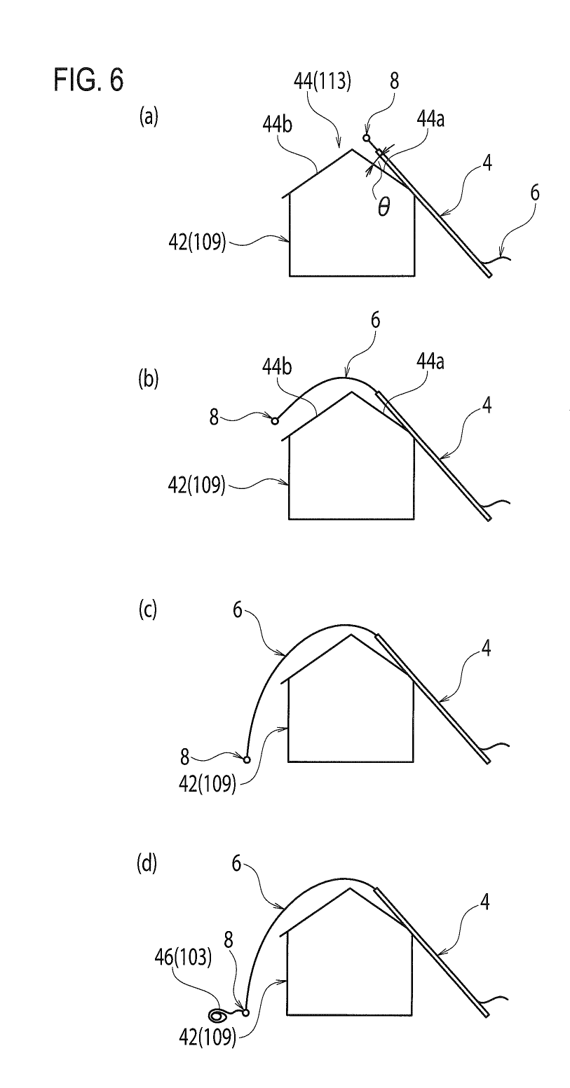

As illustrated in FIG. 4, the ball 8 includes a main body 32, an attachment tool 34 and a ring 36. As the main body 32, a pneumatic ball made of polyvinyl chloride (PVC), a rubber ball and the like are exemplified. The ball 8 is an example of a head portion. The outer surface of the head portion preferably has a smooth curved surface which is difficult to be caught by protruding objects of a house 42 (refer to FIG. 6 and the like). The shape of the head portion is preferably a sphere in particular.

The attachment tool 34 is fixed to the main body 32. The attachment tool 34 has a female screw. The ring 36 is attached to the attachment tool 34. The male screw of the distal end tool 30 of the order wire 6 is screwed and connected to the female screw of the attachment tool 34. The ball 8 is detachably attached to the order wire 6. If the ball 8 is detachably attached to the order wire 6, any attachment method other than screw fastening may be used. For example, the ball 8 may be attached to the order wire 6 by configuring a surface fastener of the attachment tool 34 and the distal end tool 30.

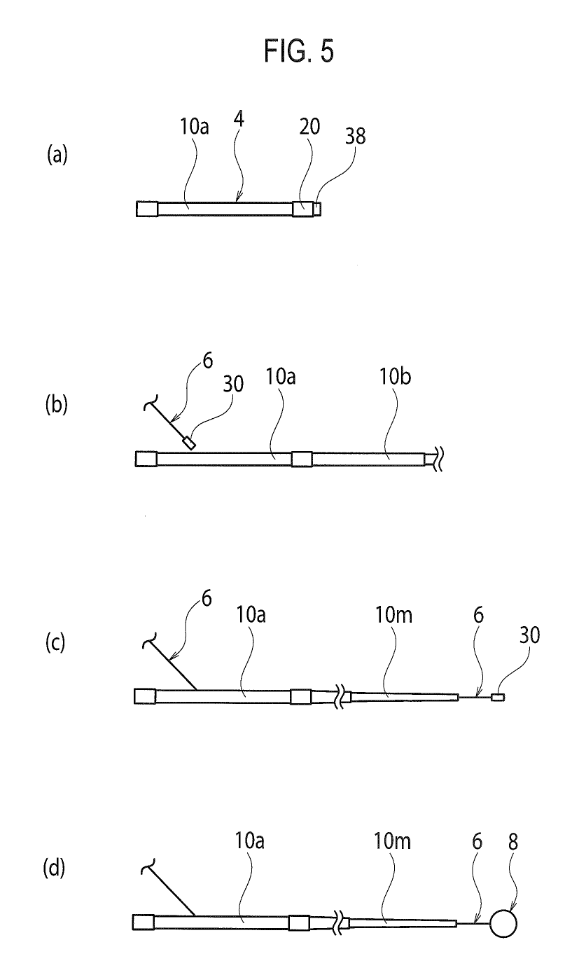

FIG. 5(a) illustrates a state where the entire length of the cylinder body 4 is shrunk. The joint 10b is inserted to the space 12a of the joint 10a. The joint 10c is inserted to the space 12b of the joint 10b. Similarly, the joints are sequentially inserted from the joint 10c to the joint 10m. The joints 10b to 10m are accommodated in the joint 10a. A cap 38 is attached to the locking cap 20. The hole 22 is closed using the cap 38. The cylinder body 4 is easily portable.

The cap 38 is removed from the state in FIG. 5(a). The inside joints from the joint 10m to the joint 10b are withdrawn from the hole 22. The original end of the joint 10b is not fallen out from the space 12a of the distal end of the joint 10a. The original end portion of the joint 10b is superimposed on the distal end portion of the joint 10a. Similarly, the original end portion of the inside joint in the radial direction from the joints 10b to 10m is superimposed on the distal end of the outside joint in the radial direction. In this manner, the cylinder body 4 allows the entire length to be stretched. If the inside joint is locked in order not to be fallen out from the adjacent joint outward in the radial direction, from joints 10a to 10m, the thickness from the original end side to the distal end side may be constant.

FIG. 5(b) illustrates a portion of a state where the cylinder body 4 is stretched. Although not illustrated in the drawing, the stretched cylinder body 4 has a space which communicates with the spaces from the space 12a of the joint 10a to the space 12m of the joint 10m. The space which communicates with a plurality of the joints 10a to 10m is a guidance hole 40. FIG. 3 illustrates a portion at a handle side of the guidance hole 40. In the cylinder body 4, the joint 10a is a handle portion. FIG. 4 illustrates a portion at the distal end side of the guidance hole 40. In the cylinder body 4, the joint 10m is a distal end portion.

FIG. 5(b) illustrates the order wire 6 before being inserted to the guidance hole 40 from the entrance hole 18. The distal end tool 30 of the order wire 6 is inserted to the guidance hole 40 from the entrance hole 18. The order wire 6 is pushed in the guidance hole 40. The distal end tool 30 of the order wire 6 is inserted from the joint 10a and pushed in toward the joint 10m. The distal end tool 30 is pushed out from the exit hole 24 of the joint 10m. In this manner, the order wire 6 passes through the cylinder body 4.

FIG. 5(c) illustrates a state where the order wire 6 has passed through the cylinder body 4. From FIGS. 5(b) to 5(c), steps where the order wire 6 is fed into the guidance hole 40 of the cylinder body 4, from the handle portion of the cylinder body 4 toward the distal end are illustrated.

Furthermore, in this embodiment, the male screw of the distal end tool 30 is screwed into the female screw of the attachment tool 34 of the ball 8. The ball 8 is attached to the order wire 6. FIG. 5(d) illustrates a state where the ball 8 is attached to the order wire 6.

FIG. 6(a) illustrates a state where the cylinder body 4 illustrated in FIG. 5(d) is leaned against the house 42. FIG. 6(a) illustrates a step where the cylinder body 4 is arranged such that the joint 10m is located upward from one side 44a of the roof 44.

In the state in FIG. 6(a), the order wire 6 is further pushed in from the entrance hole 18 to the guidance hole 40. The distal end tool 30 and the ball 8 of the order wire 6 are extended from the one side 44a of the roof 44 (113) to the other side 44b. A portion of the order wire 6 which protrudes from the cylinder body 4 is gradually bent due to the self-weight of the portion and the weight of the ball 8. Due to the bend, the distal end tool 30 and the ball 8 descend downward.

FIG. 6(b) illustrates a state where the order wire 6 is extended from the one side 44a to the other side 44b. From the state in FIG. 6(a) to the state in FIG. 6(b), a step is illustrated where the order wire 6 is further fed from the handle portion of the cylinder body 4 to the distal end portion and is arranged by being extended from the one side 44a of the roof 44 to the other side 44b.

From the state in FIG. 6(b), the order wire 6 is further pushed in from the entrance hole 18 to the guidance hole 40. Due to the bend of the portion of the order wire 6 which protrudes from the cylinder body 4, the distal end tool 30 and the ball 8 descend downward to the ground. FIG. 6(c) illustrates a state where the distal end tool 30 and the ball 8 are close to the ground in this manner.

The distal end portion of the master rope 46 (103) is linked to the ring 36 of the ball 8. FIG. 6(d) illustrates a state where the distal end tool 30 of the order wire 6 is connected to the distal end portion of the master rope 46 via the ball 8. From the state in FIG. 6(c) to the state in FIG. 6(d), a step is illustrated where the master rope 46 is connected to the order wire 6.

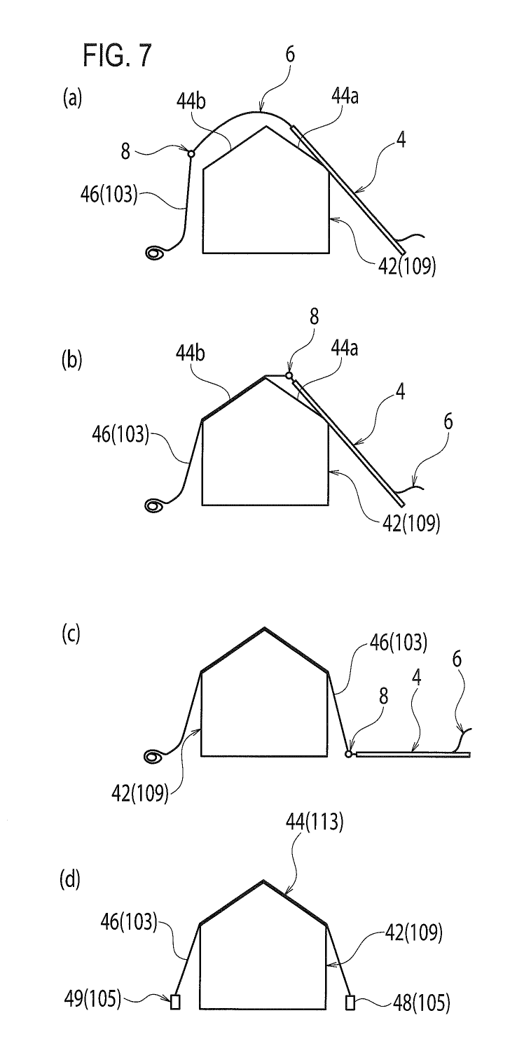

From the state in FIG. 6(d), the order wire 6 is pulled back from the entrance hole 18. FIG. 7(a) illustrates a state where the distal end tool 30 and the ball 8 of the order wire 6 are pulled back upward from the roof 44. FIG. 7(b) illustrates a state where the distal end tool 30 and the ball 8 are pulled back from the other side 44b of the roof 44 toward the one side 44a. The distal end portion of the master rope 46 is sent from the other side 44b toward the one side 44a. From the state in FIG. 6(d) to the state in FIG. 7(b), a step is illustrated where the order wire 6 is pulled back to the handle portion and the distal end portion of the master rope 46 is sent from the other side 44b of the roof 44 toward the one side 44b.

Furthermore, in the state illustrated in FIGS. 6, 7(a) and 7(b), it is preferable that an intersection angle θ between the cylinder body 4 and the roof 44 be made as small as possible. In this manner, it is possible to extend the order wire 6 beyond the roof 44 without increasing the extension amount of the order wire 6.

From the state in FIG. 6(b), the cylinder body 4 is placed on the ground. FIG. 7(c) illustrates a state where the cylinder body 4 is placed on the ground. The distal end tool 30 and the ball 8 of the order wire 6 are lowered down. From the state in FIG. 7(b) to the state in FIG. 7(c), a step is illustrated where in such a manner that the distal end tool 30 of the order wire 6 is lowered down from the one side 44a of the roof 44, the master rope 46 is arranged by being extended from the other side 44b of the roof 44 of the house 42 (109) to the one side 44a. Furthermore, the entire length of the cylinder body 4 may be shrunk and the distal end tool 30 of the order wire 6 may be lowered down from the one side 44a of the roof 44.

In the state in FIG. 7(c), the distal end portion of the master rope 46 is removed from the ring 36 of the ball 8. The distal end portion of the master rope 46 is connected to a water bag 48 (105) as a heavy weight. The water bag 48 is the heavy weight containing water in the bag thereof. Similarly, the rear end portion of the master rope 46 is connected to a water bag 49 (105). FIG. 7(d) illustrates a state where the master rope 46 is deployed on the roof 44 in this manner. From the state in FIG. 7 c) to the state in FIG. 7(d), a step is illustrated where both ends of the master rope 46 are fixed.

In this master rope deployment tool 2, the order wire 6 is sent through the guidance hole 40 of the cylinder body 4. The order wire 6 is prevented from being caught by irregular portions of the house 42. It is possible to easily send the order wire 6.

In the order wire main body 26, the portion of the cylinder body 4 which protrudes from the exit hole 24 is bent due to the self-weight thereof and the weight of the distal end tool 30 and the ball 8. Due to the bend, the distal end tool 30 and the ball 8 are gradually lowered down. Accordingly, in a state where the joint 10m of the cylinder body 4 is located upward from the one side 44a of the roof 44, the distal end tool 30 and the ball 8 are sent to the other side 44b. Since there is no need to send the distal end tool 30 with a force, damage to roofing materials can be suppressed.

Furthermore, the damage to the roofing materials can be further suppressed by providing the ball 8. In addition, it is possible to suppress to be caught by the irregular portion such as gutters of the house 42. Furthermore, the cylinder body 4 is flexible. The ball 8 is attachable and detachable. The master rope deployment tool 2 is suitable for carrying.

In a master rope deployment method using the master rope deployment tool 2, it is possible to deploy the master rope 46 from the ground. The master rope deployment method is excellent in view of safety. It is easy to deploy the master rope 46. The damage to the house 42 can be suppressed using the master rope deployment tool 2.

In a working method using the master rope deployment tool 2 and a rope for movement 56, a fall accident of a worker 50 can be suppressed from occurring from the time to begin to ascend on a ladder 52 to the time to descend on the ground. The working method is excellent in safety.

The cylinder body 4 includes twelve joints, but the cylinder body according to the present invention may be configured of one cylinder (joint). In addition, the cylinder body may include a plurality of joints which has the same structure as the cylinder body 4 and two or more joints.

Furthermore, in the master rope deployment tool 2, a configuration where the entrance hole 18 is eliminated, for example, and the order wire 6 is inserted from the base end portion (bottom) of the cylinder body 4 (joint 10(a)), as illustrated by the dashed line in FIG. 2 may be adopted. Accordingly, even without extending the master rope deployment tool 2 to a maximum, it is possible to insert the order wire 6 into the cylinder body 4 and to extend it. In addition, even if the length of the cylinder body 4 is slightly insufficient, it is possible to extend the order wire 6 and install the master rope 46 using the master rope deployment tool 2.

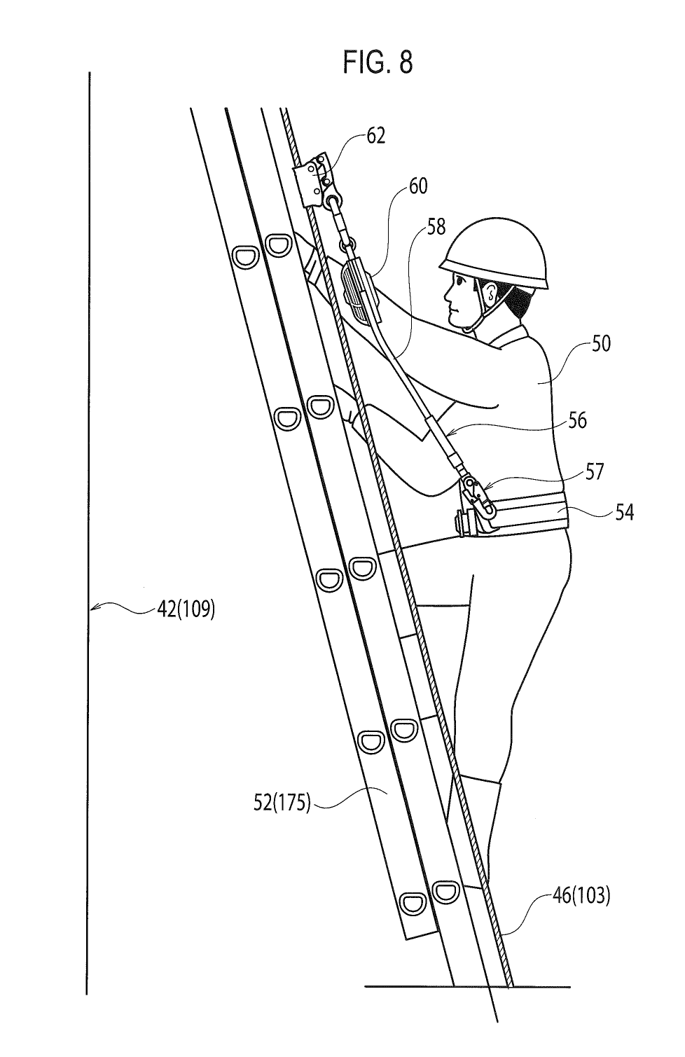

A working state of the worker 50 using the master rope 46 will be described. FIG. 8 illustrates the working state of the worker 50 using the master rope 46. A ladder 52 (175) is leaned against the house 42 in the vicinity of the master rope 46 illustrated in FIG. 7(d). The worker 50 wears a safety belt (trunk belt: trunk belt type safety belt) 54.

The rope for movement 56 includes a coupling 57 configuring a retractable fall arrester 107 (refer to FIG. 18 and the like), a rope main body 58, a winder 60 and a grip 62. Furthermore, the coupling 57 is connected to one end of the rope main body 58. The other end of the rope main body 58 is connected to the winder 60. The winder 60 winds the other end portion of the rope main body 58 so as to be able to be repeatedly wound.

The winder 60 is connected to the grip 62. The grip 62 is attached to the master rope 46. In this manner, the safety belt 54, the rope for movement 56 and the master rope 46 are connected. To describe further, the grip 62 (refer to FIG. 9) causes teeth to be lightly biased using a spring and the like such that the teeth lightly presses the master rope 46 to fix in a normal state. Then, it is slidable with respect to the master rope 46. When a person's weight is applied, the teeth (claws) bite into the master rope 46 and are fixed with respect to the master rope 46.

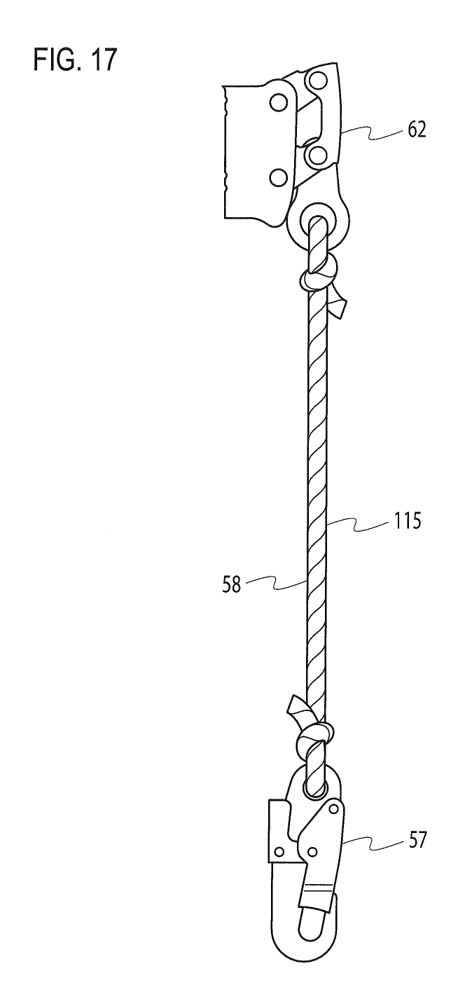

The winder 60 includes an automatic lock mechanism which stops feeding of the rope if the rope main body 58 is rapidly fed. The automatic lock mechanism is generally well known and thereby the detailed description will be omitted. As the automatic lock mechanism, a mechanism which utilizes the centrifugal force of the rotation of a drum winding the rope main body 58 and causes lock claws to engage between the main body of the winder 60 and the drum is exemplified. In addition, the rope for movement 56 may not have the winder 60. The rope for movement 56 (connection rope; master-rope-guided slide equipment 115; refer to FIG. 17) may be configured of the coupling 57, the rope main body 58 and the grip 62.

To describe the grip 62 in more detail, as illustrated in FIG. 9, the grip 62 includes a main body 64, a first claw 66, a second claw 68, a stick grip 70, a connection ring 72 and a spring 74 as an elastic body. By the biasing force of the spring 74, the main body 64, the first claw 66 and the second claw 68 pinch the master rope 46. By pinching it, the grip 62 is fixed to the master rope 46. The main body 64, the first claw 66, the second claw 68, the stick grip 70 and the spring 74 configure a slide lock mechanism which stops slide with respect to the master rope 46. By using a hole 76 of the connection ring 72, the winder 60 is attached thereto.

In the grip 62, if the connection ring 72 is pulled in one direction illustrated by the arrow X, the first claw 66 and the second claw 68 are rotated against the biasing force of the spring 74. The main body 64, the first claw 66 and the second claw 68 release the pinching of the master rope 46. The slide lock mechanism of the grip 62 is released, and the grip 62 becomes slidable along the master rope 46. In the grip 62, even if the stick grip 70 is caused to move in one direction instead of the connection ring 72, the first claw 66 and the second claw 68 are rotated against the biasing force of the spring 74.

In FIG. 8, the grip 62 of the rope for movement 56 is connected to the master rope 46. The coupling 57 is connected to the safety belt 54. In this manner, the master rope 46, the rope for movement 56 and the safety belt 54 are connected. The rope for movement 56 is connected to the worker 50 via the safety belt 54. In this manner, a step is performed where the master rope 46 is connected to the worker 50 via the rope for movement 56.

The worker ascends on the ladder 52. In such a manner that the connection ring 72 is rotated in one direction (upward in FIG. 8) or the stick grip 70 is moved, the grip 62 slides along the master rope 46, according to the movement of the worker 50, while being connected to the master rope 46. The rope for movement 56 is configured to be switchable between a slidable state and a non-slidable state with respect to the master rope 46, using the slide lock mechanism.

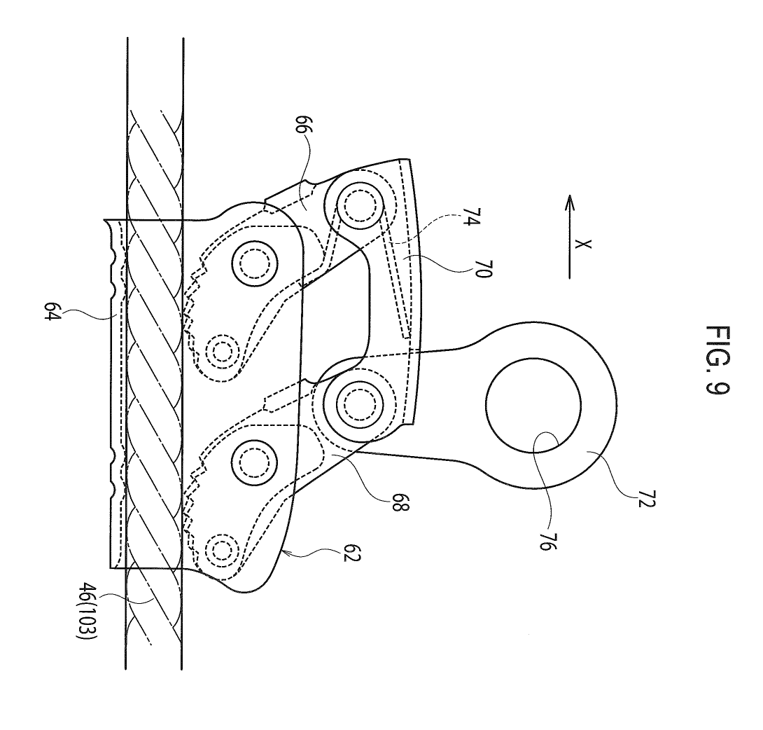

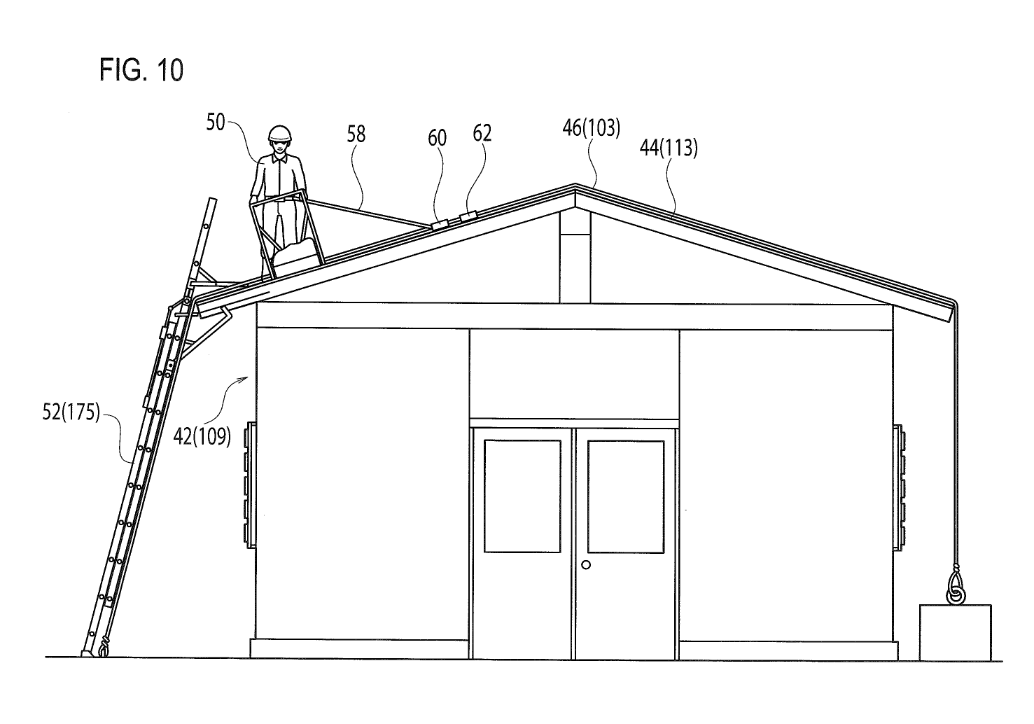

FIG. 10 is an explanatory view illustrating a working state on the roof 44. The grip 62 is fixed to the master rope 46 on the roof 44, using the slide lock mechanism. If the worker 50 moves in a direction away from the master rope 46, the rope main body 58 is fed from the winder 60. Accordingly, the worker 50 can movably work within a predetermined range.

As illustrated in FIG. 10, the distal end of the master rope 46 may be connected to the ladder 52. In addition, any one or both of the distal end portion and the rear end portion of the master rope may be connected to the house.

Either acting to ascend on the ladder 52 or working on the roof 44 is a step to carry out the work in a state where the worker 50 is connected to the rope for movement 56.

In general, the grip 62 is fixed to the master rope 46 using the slide lock mechanism. If the worker 50 falls from the roof 44 or the ladder 52, the automatic lock mechanism of the winder 60 is actuated. Accordingly, the worker 50 is suppressed to fall from the high place. Furthermore, the winder 60 may be connected to the master rope 46 on the roof 44, and the work may be carried out within the range where the winder 60 can feed the rope main body 58.

The description will be back to the fall prevention system 101.

As described above or as illustrated in FIG. 1, a master rope 103 of the fall prevention system 101 is installed by passing through a ridge 111 of a roof 113 of a house 109. The ridge 111 is a ridgeline section which extends in the horizontal direction at the highest place of the roof 113. The master rope 103 is installed on the house 109 provided with the roof 113 having the ridge 111. As a type of the roof 113 where the master rope 103 is installed, the examples can include a gable roof, a hipped roof, a gambrel roof, a pent roof, a saw-tooth roof, a mansard roof, a barrel roof and the like.

A state where the master rope 103 is installed on the roof 113 will be described in detail by giving an example of the gable roof.

As illustrated in FIG. 1, the central portion in the longitudinal direction of the master rope 103 is in contact with the ridge 111 on the upper portion of the ridge 111. A first inclined surface extending section 117 and a first vertically extending section 119 which are a portion of the master rope 103 are extended to one side from the central portion of the longitudinal direction of the master rope 103.

The first inclined surface extending section 117 is in contact with the inclined surface of the roof 113 on the inclined surface of the roof 113 which is present at one side of the ridge 111, and is extended in the direction which is diagonally downward and perpendicular to the ridge 111, from the ridge 111 to one lower end portion of the roof 113.

The first vertically extending section 119 is extended from one lower end portion of the roof 113 downward in the vertical direction. The distal end (lower end) of the first vertically extending section 119 is located in the vicinity of the ground GL on one side of the house 109, but the distal end of the first vertically extending section 119 and the section in the vicinity thereof may be in contact with the ground GL.

A second inclined surface extending section (not illustrated in FIG. 1) which is extended from the central portion in the longitudinal direction of the master rope 103 to the other side and a second vertically extending section (not illustrated in FIG. 1) are symmetrical with the first inclined surface extending section 117 and the first vertically extending section 119, with respect to a plane which is deployed in the vertical direction including the ridge 111.

A weight 105 is configured of a bucket whose upper portion is open, is connected to the master rope 103 at one end portion in the longitudinal direction of the master rope 103, and is installed on the ground GL on one side of the house 109. In addition, the weight 105 is connected to the master rope 103 at the other end portion in the longitudinal direction of the master rope 103, and is installed on the ground GL in the other side of the house 109.

A pair of weights 105 installed at both sides of the house 109 causes the master rope 103 to be pulled and a slight tension to be generated on the master rope 103 (master rope 103 is stretched). However, the tension generated on the master rope 103 is too small to cause positional deviation of the master rope 103 installed on the roof 113 (for example, 1 kgf to several kgf). Accordingly, most weight of the weight 105 is supported on the ground GL. For example, if the weight of the weight 105 at one side of the house 109 is 75 kgf, the weight 105 presses the ground GL with a slightly weaker force (for example, force of approximately 74 kgf) than 75 kgf. It is similar to the weight 105 at the other side of the house 109.

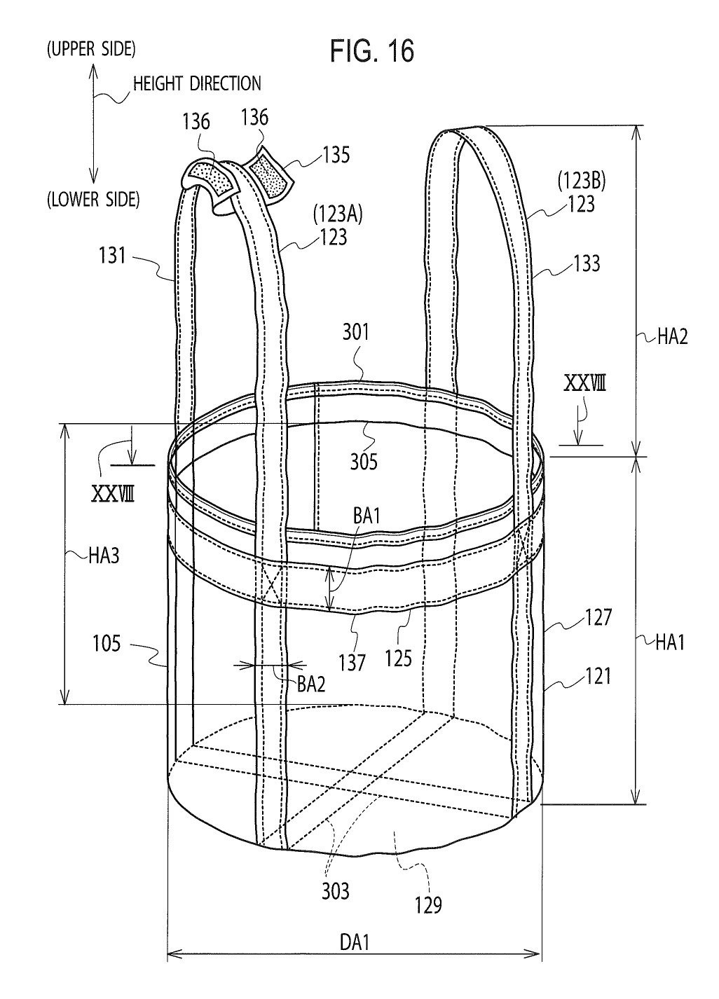

As the bucket configuring the weight 105, for example, as illustrated in FIG. 16, a canvas bucket (water bag; bag made of cloth) is adopted. The canvas bucket 105 is configured of a main body portion (container) 121 configured of a waterproof sheet and whose upper portion is open, a hand strap 123 provided at the main body portion 121, and a reinforced portion 125 reinforcing the main body portion 121.

The main body portion 121 is configured of a sidewall portion 127 formed in a cylindrical shape such as cylinder shape, and a circular bottom wall portion 129 closing one opening portion (bottom side opening portion) of the sidewall portion 127. Furthermore, the bottom wall portion 129 may have a rectangular shape and the like, or any shape other than a circle shape.

The hand strap 123 is configured of a first hand strap configuring member 131 and a second hand strap configuring member 133. The first hand strap configuring member 131 which is made of fabric or the like and is formed in a thick band shape, where one end side section in the longitudinal direction is in contact and engaged with the outer surface of the sidewall portion of the main body portion 121, and provided integrally with the main body portion 121. Furthermore, the one end side section in the longitudinal direction is extended from a place of an opening portion 301 of the sidewall portion 127 of the main body portion 121 to a place (boundary between the sidewall portion 127 and the bottom wall portion 129) of the bottom wall portion 129.

Similarly to the one end side section in the longitudinal direction, the other end side section in the longitudinal direction of the first hand strap configuring member 131 is also extended from the place of an opening portion 301 of the sidewall portion 127 of the main body portion 121 to the place of the bottom wall portion 129. In addition, if the bucket 105 is viewed from top to bottom (in a planar view), the sidewall portion 127 is located at the outer periphery of the bottom wall portion 129 formed in a circle shape. Then, the other end side section of the first hand strap configuring member 131 is located at a place shifted by 90° with respect to the one end side section of the first hand strap configuring member 131, around the center of the bottom wall portion 129.

The central portion in the longitudinal direction of the first hand strap configuring member 131 has a “U” shape, protrudes upward from the opening portion 301 of the main body portion 121, and forms a first hand strap 123.

Similarly to the first hand strap configuring member 131, the second hand strap configuring member 133 is also provided on the main body portion 121, and forms the first hand strap 123 and a second hand strap 123. If the bucket 105 is in the planar view, one end side section of the first hand strap configuring member 131, the other end side section of the first hand strap configuring member 131, one end side section of the secondhand strap configuring member 133, and the other end side section of the second hand strap configuring member 133 are located at a place where the outer circumference of the main body portion 121 formed in a circle shape is equally divided into four parts.

In addition, a plate-like hand strap bonding member 135 is integrally provided in the central portion of the first hand strap 123. Surface fasteners 136 are provided on the hand strap bonding member 135. If the surface fasteners 136 are engaged with each other, the hand strap bonding member 135 forms a cylindrical shape. When the surface fasteners 136 are engaged, if the central portion of the second hand strap 123 penetrates the cylinder of the hand strap bonding member 135 and fastens the central portion of the second hand strap 123 in the cylinder of the hand strap bonding member 135, the central portion of the first hand strap 123 and the central portion of the second hand strap 123 are integrated with each other.

The reinforced portion 125 is configured of a reinforcing member 137 formed in a band shape, similarly to the first hand strap configuring member 131. Then, the reinforced portion 125 is formed in such a manner that the reinforcing member 137 forms a ring shape along the opening portion 301 in the vicinity of the opening portion 301 of the main body portion 121 and is integrally provided on the main body portion 121. The reinforced portion 125 (reinforcing member 137) and the respective hand strap configuring members 131 and 133 are substantially perpendicular to each other and engaged with each other. In an engaging portion of the reinforced portion 125 and the respective hand strap configuring members 131 and 133, the reinforced portion 125 and the respective hand strap configuring members 131 and 133 are integrated by being sewn with splicing yarns or the like.

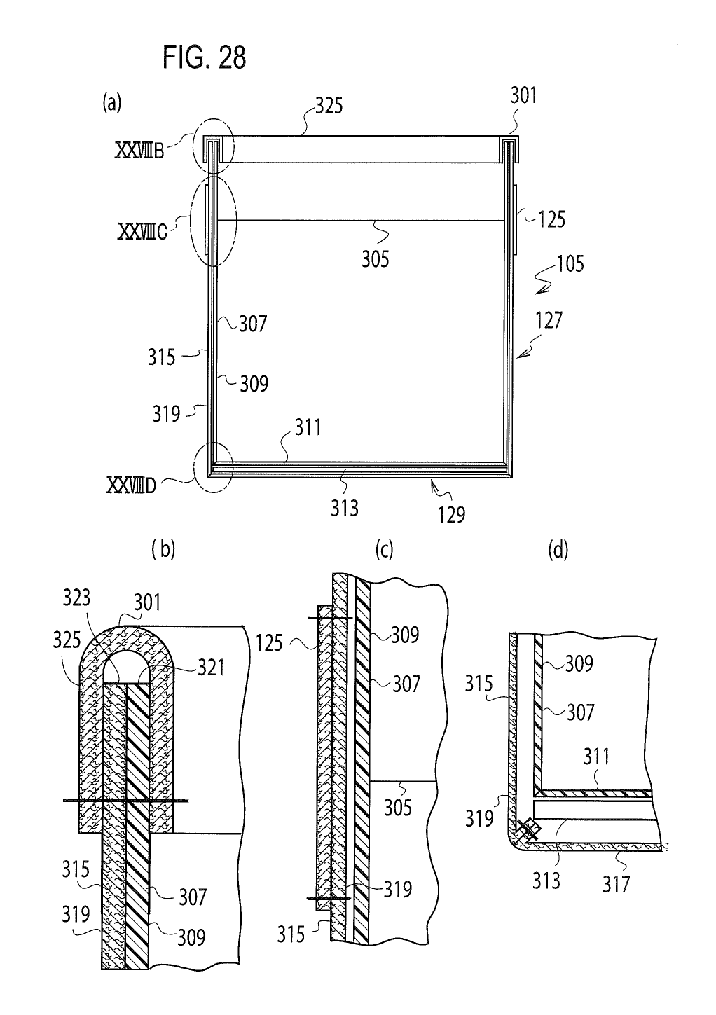

Here, the bucket 105 will be described in further detail with reference to FIGS. 16 and 28.

Hereinafter, for convenience of the description, a direction where the bottom wall portion (bottom portion) 129 of the measuring container-shaped main body portion 121 of the bucket 105 and the opening portion 301 are connected to each other is referred to as a height direction of the bucket 105, the opening portion 301 side is referred to as an upper side, and the bottom wall portion 129 side is referred to as a lower side.

As described above, the bucket 105 is configured of the main body portion 121, the reinforced portion 125 and the hand strap 123. The main body portion 121 is to contain water inside thereof and is formed in the measuring container shape.

The reinforced portion 125 is formed in a ring shape with a band-shaped member, forms a hoop shape along the annular opening portion 301 located at the upper end of the main body portion 121 (for example, close to the opening portion 301 and substantially side by side with the opening portion 301), and provided integrally with the main body portion 121.

The hand strap 123 is formed in a band shape. Then, one end side section (section from the one end portion in the longitudinal direction through the first central portion in the longitudinal direction; the first central portion is located at the one end side in the longitudinal direction) in the longitudinal direction of the hand strap 123 is provided integrally with the main body portion 121 (a predetermined first section of the main body portion 121). In addition, the other end side section (section from the other end portion in the longitudinal direction through the second central portion in the longitudinal direction; the second central portion is located at the other end side in the longitudinal direction) in the longitudinal direction of the hand strap 123 is provided integrally with main body portion 121 (a predetermined second section separated from the predetermined first section). Furthermore, a section (section between the first central portion and the second central portion) of the central portions in the longitudinal direction of the hand strap 123 forms a “U” shape or a “V” shape and is extended out from the opening portion 301 of the main body portion 121.

At least a portion of the one end side section in the longitudinal direction of the hand strap 123 is also provided integrally with the reinforced portion 125, and at least a portion of the other end side section in the longitudinal direction of the hand strap 123 is also provided integrally with the reinforced portion 125. Accordingly, the hand strap 123 is robustly bonded to the main body portion 121.

The main body portion 121 of the bucket 105 is configured of the cylindrical sidewall portion 127 and the flat plate-shaped bottom wall portion 129.

The thickness direction of the flat plate-shaped bottom wall portion 129 matches with the height direction of the bucket 105, and the cylindrical sidewall portion 127 is raised in the height direction of the bucket 105. In other words, the generating line or the central axis of the cylindrical sidewall portion 127 is extended in the height direction of the bucket 105. The reinforced portion 125 is provided on the sidewall portion 127. Furthermore, the annular reinforced portion 125 may be plurally provided side by side at a predetermined distance in the height direction of the bucket 105.

The hand strap 123 is provided on the sidewall portion 127 by being extended from the opening portion 301 of the main body portion 125 to the boundary between the sidewall portion 127 and the bottom wall portion 129.

The bottom wall portion 129 is formed in a disk shape, for example. Accordingly, the sidewall portion 127 is formed in a substantially cylinder shape. In addition, the hand strap 123 is configured of a first hand strap 123A and a second hand strap 123B, for example. Furthermore, an extended length of the respective hand straps 123A and 123B is approximately equal to a depth of the main body portion 121.

Here, the extended length of the first hand strap 123A (the second hand strap 123B) is an extended length which forms the “U” shape or the “V” shape and which is extended out from the opening portion 301 of the main body portion 121 (dimension HA2 in FIG. 16). The extended length in a case where the hand strap 123 is extended in the “V” shape is slightly longer than that in a case (case illustrated in FIG. 16) where the hand strap 123 is extended in the “U” shape, but the difference is slight. Accordingly, to decide whether it has to be extended in the “U” shape or “V” shape is not important, and in practice, the extended length of the first hand strap 123A (the second hand strap 123B) can be considered to be constant.

The depth of the main body portion 121 of the bucket 105 is a dimension from the opening portion 301 of the main body portion 121 to the bottom wall portion 129 of the main body portion 121 (dimension HA1 in FIG. 16).

The value of the diameter (diameter of the bottom wall portion 129; the outside diameter of the sidewall portion 127; dimension DA1 in FIG. 16) of the main body portion 121 is approximately equal to the value of the extended length of the hand strap 123, or is slightly larger than the value of the extended length of the hand strap 123. For example, FIG. 16 illustrates that the dimension HA1 is 320 mm, the dimension HA2 is 320 mm and the dimension DA1 is 350 mm. The thickness of the sidewall portion 127 and the bottom wall portion 129 of the main body portion 121 is set to be sufficiently small to a negligible extent in practice with respect to the above-described respective dimensions HA1, HA2 and DA1.

In the bucket 105, rigidity of the bottom wall portion 129 of the main body portion 121 is stronger than the rigidity of the sidewall portion 127 of the main body portion 121.

That is, the rigidity of the sidewall portion 127 corresponds to a degree of thick fabric. In contrast, the rigidity of the bottom wall portion 129 corresponds to a degree of a thin sheet made of rigid synthetic resin or more. Then, even if a specified amount of water is contained inside the bucket 105 (inside the main body portion 121), the hand strap 123 is pulled upward, and the bucket 105 is lifted up in the air, the bottom wall portion 129 of the bucket 105 maintains a substantially flat plate form.

Furthermore, the reinforced portion 125 is provided and the hand strap 123 is provided throughout the total height of the sidewall portion 127. Therefore, even if a specified amount of water is contained inside the bucket 105, the hand strap 123 is pulled upward, and the bucket 105 is lifted up in the air, the sidewall portion 127 of the bucket 105 is only slightly deformed into a barrel shape and maintains a substantially cylinder form.

In the bucket 105, the first hand strap 123A and the second hand strap 123B may be configured of a cross-shaped reinforced portion 303 which is extended to the bottom wall portion 129 and forms a cross shape outside of the bottom wall portion 129. In this manner, the bottom wall portion 129 of the bucket 105 can be further suppressed to be deformed.

Furthermore, a scale 305 is provided in the bucket 105. The scale 305 is to indicate the specified amount of water contained in the main body portion 121, and is provided inside (inner surface) the main body portion 121. If water is contained up to the scale 305, mass (weight) of the bucket 105 becomes approximately 25 kg.

The scale 305 is formed in a ring shape and is provided on the inner surface of the sidewall portion 127 of the main body portion 121. In addition, the installation height (distance between the bottom wall portion 129 and the scale 305; dimension HA3 illustrated in FIG. 16) of the scale 305 is approximately equal to the installation height of the reinforced portion 125. For example, the dimension HA3 is 240 mm.

To describe further, such that the width direction thereof (dimension in the direction indicated by the dimension BA1 in FIG. 16) matches with the height direction of the main body portion 121, the band-shaped member configuring the reinforced portion 125 is provided on the sidewall portion 127 of the main body portion 121. The scale 305 is located between the lower end and the upper end of the band-shaped reinforced portion 125, in the height direction of the bucket 105 (main body portion 121).

The bucket 105 will be further described.

The bucket 105 is configured of an inner structure body 307, a bottom portion reinforced body 313, an outer structure body 319, an opening portion joint body 325, and the above-described first hand strap 123A, the secondhand strap 123B, the reinforced portion 125, and the scale 305.

The inner structure body 307 includes an inner sidewall portion 309 with a tubular shape (cylindrical shape), configured of a waterproof sheet, and an inner bottom wall portion 311 with a flat plate shape, configured of the waterproof sheet, and is formed in a measuring container and has a waterproof structure. In addition, the inner structure body 307 is colored with conspicuous colors such as orange or yellow.

For example, the waterproof sheet is configured of synthetic resin which is thin and has flexibility, through crimping with heat, end portions of the plate-shaped materials are bonded to each other and the tubular-shaped inner sidewall portion 309 is formed. Then, through crimping with the heat, the inner sidewall portion 309 and the inner bottom wall portion 311 are bonded to each other. Accordingly, water is no longer leaked out from the bonded place.

The bottom portion reinforced body 313 is formed in a disk shape whose diameter is approximately equal to the diameter of the inner bottom wall portion 311, and is provided side by side with the inner bottom wall portion 311, by being in contact with or slightly separated from the inner bottom wall portion 311 outside (lower side) of the inner structure body 307.

The bottom portion reinforced body 313 is configured of the rigid synthetic resin, for example, and has little flexibility. In addition, the thickness direction of the inner bottom wall portion 311 and the thickness direction of the bottom portion reinforced body 313 match with the vertical direction of the bucket 105. If viewed from the vertical direction of the bucket 105, the inner bottom wall portion 311 and the bottom portion reinforced body 313 are substantially superimposed on each other.

The outer structure body 319 includes an outer sidewall portion 315 which is formed in a tubular shape (cylindrical shape) whose height dimension is slightly higher than the height dimension of the inner sidewall portion 309 and whose inside diameter is slightly larger than the outside diameter of the inner sidewall portion 309, and an outer bottom wall portion 317 whose diameter is slightly larger than the diameter of the inner bottom wall portion 311, and is formed in a measuring container shape, and then is provided outside of the inner structure body 307 and the bottom portion reinforced body 313 such that the inner structure body 307 and the bottom portion reinforced body 313 are accommodated inside thereof. Furthermore, the outer structure body 319 is colored with unnoticeable colors such as black.

The outer sidewall portion 315 and the outer bottom wall portion 317 are configured of thick fabric, for example, and the outer structure body 319 is formed in the measuring container shape by sewing. In addition, the thickness direction of the outer bottom wall portion 317 and the thickness direction of the bottom portion reinforced body 313 match with the vertical direction of the bucket 105. If viewed from the downward direction of the bucket 105, the outer bottom wall portion 317 and the bottom portion reinforced body 313 are substantially superimposed on each other.

The outer bottom wall portion 317 is located at the lower side of the bottom portion reinforced body 313 and is in contact with or slightly separated from the bottom portion reinforced body 313. The outer sidewall portion 315 is in contact with or slightly separated from the inner sidewall portion 309.

In addition, in the vertical direction of the bucket 105, the upper edge (edge 321) of the inner structure body 307 and the upper edge (edge 323) of the outer structure body 319 are located at substantially the same place.

The opening portion joint body 325 is formed in an annular band shape and is provided integrally with the inner structure body 307 and the outer structure body 319 so as to cover the edge 321 (section in the vicinity thereof from the edge) of the opening portion of the inner structure body 307 and the edge 323 (section in the vicinity thereof from the edge) of the opening portion of the outer structure body 319.

The opening portion joint body 325 is configured of thick fabric (fabric with the same color as that of the outer structure body 319), for example, and is provided on the inner structure body 307 and the outer structure body 319 by sewing. Since the opening portion joint body 325 is provided, the inner structure body 307 and the outer structure body 319 are integrated at the place of the ring-shaped opening portion 301 of the bucket 105. Furthermore, the ring-shaped opening portion joint body 325 is folded back at the place of the center line extending in the longitudinal direction at the center in the width direction. One side thereof across the center line is located outside of the outer structure body 319 and the other side across the center line is located inside of the inner structure body 307.

In addition, the center line of the opening portion joint body 325 is located at the place of the opening portion 301 of the bucket 105. Seams of the opening portion joint body 325 is located in the vicinity of the apex of the opening portion 301 of the bucket 105.

As described above, the first hand strap 123A is formed in a band shape, one end side section in the longitudinal direction is extended, in a generating line direction of the outer structure body 319 (outer sidewall portion 315), from the opening portion of the outer structure body 319 to the place of the boundary between the outer sidewall portion 315 and the outer bottom wall portion 317, in the predetermined first section outside of the outer structure body 319, and is provided integrally with the outer structure body 319 (outer sidewall portion 315).

Similarly, the other end side section in the longitudinal direction of the first hand strap 123A is also provided on the predetermined second section separated from the predetermined first section. Then, a section of the intermediate portion (section between the first intermediate portion and the second intermediate portion) in the longitudinal direction of the first hand strap 123A forms a “U” shape or a “V” shape, and is extended out from the opening portion (opening portion 301 of the bucket 105) of the outer structure body 319.

The first hand strap 123A is formed in a band shape by weaving chemical fibers (fibers with the same color as that of the outer structure body 319) such as nylon. In addition, in the first hand strap 123A, the cross-sectional shape in the longitudinal direction forms a rectangle shape. The dimension in the transverse direction of this rectangle is the width dimension (dimension BA2 in FIG. 16) of the first hand strap 123A, and the dimension in the height direction of the rectangle is the thickness dimension of the first hand strap 123A. Furthermore, the dimension in the height direction of the rectangle is much smaller than the dimension in the transverse direction of the rectangle.

In addition, the first hand strap 123A comes into close contact with the outer sidewall portion 315 such that the thickness direction thereof matches with the thickness direction of the outer sidewall portion 315 and for example, is provided integrally with the outer sidewall portion 315 by sewing.

The second hand strap 123B is configured similarly to the first hand strap 123A and is provided on the outer sidewall portion 315 similarly to the first hand strap 123A. Furthermore, in the second hand strap 123B, one end side section in the longitudinal direction thereof is attached to the outer sidewall portion 315 at a third section separated from the first section or the second section, and the other end side section in the longitudinal direction is attached to the outer sidewall portion 315 at a fourth section separated from the first section, the second section or the third section.

In addition, if viewed from the height direction of the bucket 105, the sections (the first to fourth sections) of the respective hand straps 123A and 123B which are engaged with the outer structure body 319 are provided at the position where the outer circumference of the opening portion 301 of the bucket 105 is approximately divided into four parts. In addition, the first to fourth sections are arranged in this order in a clockwise direction, for example. Furthermore, a configuration where the first section, the third section, the second section and the fourth section are arranged in this order in the clockwise direction may be adopted.

As described above, the reinforced portion 125 is formed in an annular band shape. In addition, the reinforced portion 125 is provided integrally with the outer structure body 319, outside of the outer structure body 319 and the respective hand straps 123A and 123B, close to the opening portion of the outer structure body 319 (bucket 105), along the opening portion of the outer structure body 319 (bucket 105).

Furthermore, for example, the reinforced portion 125 is configured of the same material and substantially the same shape as those of the hand strap 123, and comes into close contact with the outer sidewall portion 315 such that the thickness direction of the reinforced portion 125 matches with the thickness direction of the outer sidewall portion 315, and is provided integrally with the outer sidewall portion 315 by sewing. Furthermore, the reinforced portion 125 is superimposed on the hand strap 123 at the section where the hand strap 123 is provided, and is provided integrally with the outer structure body 319, together with the hand strap 123 by sewing.

The scale 305 is provided inside of the inner structure body 307 in order to indicate the specified amount of water contained in the inner structure body 307. The scale 305 is red or the like and has a high contrast color with respect to the inner structure body 307.

Then, according to the bucket 105, since the reinforced portion 125 is provided, it is possible to prevent swelling of the main body portion 121 when water is contained inside the bucket 105. Then, when configuring the weight by a plurality of buckets 105, it is possible to prevent mutual interference between each of the buckets 105 and to prevent overflowing water due to the mutual interference between the buckets 105.

In addition, according to the bucket 105, the hand strap 123 is provided being extended from the opening portion 301 of the main body portion 131 to the boundary between the sidewall portion 127 and the bottom wall portion 129. Therefore, it is possible to further prevent the swelling of the sidewall portion 127.

In addition, according to the bucket 105, since the main body portion 121 and the hand strap 123 have the above-described forms, when three buckets 105 are used as the weight, a direction of force (applied condition) becomes better.

Furthermore, according to the bucket 105, it is possible to easily and visually confirm whether a proper amount of water is contained, using the scale 305. In addition, since the reinforced portion 125 is provided on the place of the scale 305, it is possible to prevent deformation of the scale 305.

In addition, according to the bucket 105 configured of the inner structure body 307 and the outer structure body 319, a double structure where water leakage is prevented by the inner structure body 307 and the weight of water is mainly supported by the outer structure body 319 is adopted. Therefore, it is possible to reliably prevent the water leakage while securing the strength.

Incidentally, a hook or a carabiner is provided on the end portion of the master rope 103, the hook or the carabiner is engaged with the respective hand straps 123, and the master rope 103 is connected to the bucket 105.

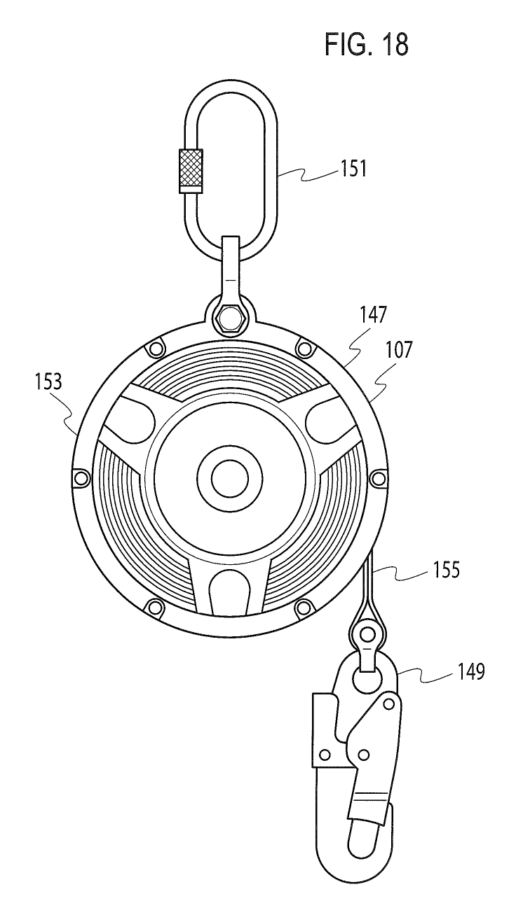

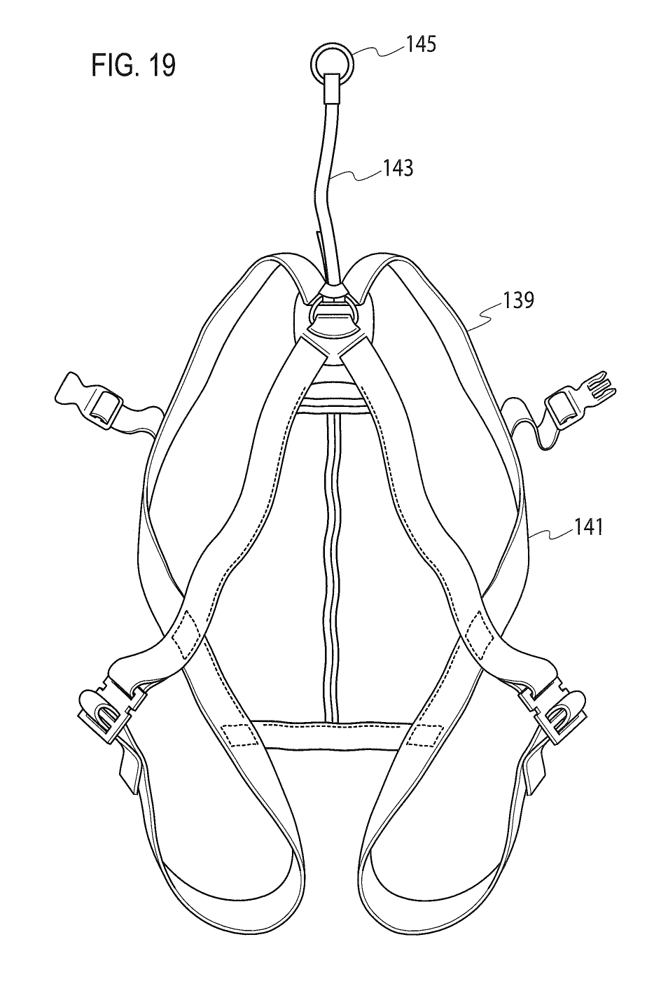

The retractable fall arrester 107 is to connect the harness 139 (refer to FIG. 19 and the like) worn by the worker 50 working on the roof 113 and the master rope 103 to each other.

As illustrated in FIG. 19 and the like, as the harness 139, a full-harness type is used, but as illustrated in FIG. 8 and the like, a trunk belt type (safety belt 54) may be used.

The harness 139 includes a harness main body portion 141 fitted to the body of a wearer (worker) 50, and a harness supporting rope 143 extended from the harness main body portion 141. The harness supporting rope 143 is formed in a band shape and is extended from the back of the neck of the wearer 50 when the harness 139 is worn. A ring-shaped connector 145 is provided on the distal end of the harness supporting rope 143.

As described above or as illustrated in FIG. 18 and the like, the retractable fall arrester 107 is to connect the harness wearer (worker) 50 and the master rope 103. The harness wearer 50 connected to the master rope 103 via the retractable fall arrester 107 has a wider range of activity on the roof 113 compared to a case of being connected to a rope only (for example, a connection rope, to be described later).

In more detail, the retractable fall arrester 107 includes a fall arrester main body portion 147, a hook 149 and a carabiner 151. The fall arrester main body portion 147 (winder 60) includes a casing portion 153 and a rope 155 extended from the casing portion 153. The extended length of the rope 155 from the casing portion 153 is approximately up to 6 meters. The rope 155 is supported by a rope winding holding mechanism (not illustrated) provided inside the casing portion 153.

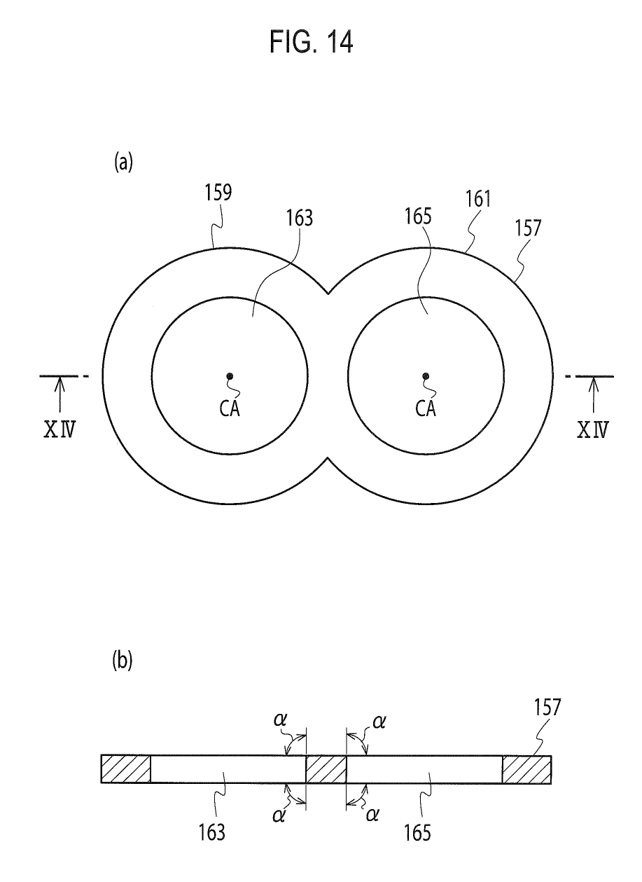

In addition, the carabiner 151 of the retractable fall arrester 107 is provided at the casing portion 153 of the fall arrester main body portion 147, and the hook 149 of the retractable fall arrester 107 is provided at the distal end of the rope 155. Then, though the details will be described later, the carabiner 151 of the retractable fall arrester 107 is engaged with a section of the master rope 103 where a figure eight ring (refer to FIG. 14 and the like) is provided and the fall arrester main body portion 147 is connected to the master rope 103. In addition, the hook 149 of the retractable fall arrester 107 is installed at the connector 145 provided at the distal end of the harness supporting rope 143 of the harness 139, and the rope 155 and the harness 139 are connected to each other.

Furthermore, in a case where large acceleration or large pulling force (force of about a person's weight) is not applied to the rope 155, the rope 155 is wound into the casing portion 153 in order for the length to be short by slight force (for example, force of approximately 1 kgf). Then, in accordance with the movement of the harness wearer 50, the extended length thereof from the casing portion 153 is appropriately changed.

That is, in a case where the harness wearer 50 and the master rope 103 are connected via the retractable fall arrester 107, if the harness wearer 50 is in the vicinity of the fall arrester main body portion 147 (master rope 103), the extended length of the rope 155 is automatically wound to be short by the rope winding holding mechanism. If the harness wearer 50 is far from the fall arrester main body portion 147 (master rope 103), the extended length of the rope 155 pulled by the harness wearer 50 become long.

In addition, in a case where large acceleration or large pulling force (force of about the weight of the worker 50) is applied to the rope 155, the rope 155 is clasped (locked) by the fall arrester main body portion 147, the rope 155 and the fall arrester main body portion 147 are integrated with each other, and thereby the rope 155 cannot be extended from the fall arrester main body portion 147. Accordingly, the harness wearer 50 is prevented from falling down to the ground GL.

Incidentally, only one end in the longitudinal direction of the master rope 103 is connected to the weight 105 and the other end in the longitudinal direction of the master rope 103 may be fixed to the ground GL using anchors or the like. In addition, only one end in the longitudinal direction of the master rope 103 is connected to the weight 105 and the other end in the longitudinal direction of the master rope 103 may be in a free state. In this case, the worker is able to work on only the other slope of the roof 113.

Here, a connection of the master rope 103 and the retractable fall arrester 107 will be described. The retractable fall arrester 107 is connected to the master rope 103 using a multiple-ring member. The multiple-ring member has a shape which includes a first through hole passing through a main body portion and a second through hole passing through the main body portion in parallel with the first through hole, separated from the first through hole, and for example, is configured of a figure eight ring 157 formed in a figure “8” shape. Hereinafter, examples of the figure eight ring 157 will be described.

“8”-Shaped ring of material 157 is flat-type material, as shown in FIG. 14, “8” shaped cutting has been shaped in the shape, the first annular first annular part 159 and outer part of connected parts 159 outer part of annular is configured, and part 161. Will bore equal each other to “8”-shaped ring of material 157 two piercing holes 163165 is formed by this. Each parallel to the axis of the two through-hole 163165 is.

“8”-Shaped ring of to explain more details of 157. “8”-Shaped ring of material 157 joined the two-torus shaped by a plane that contains the central axis CA, CB, as shown in FIG. 14, rectangular, and configured.

“8”-Shaped ring of material 157 describes further the structures described below is a “8”-shaped ring of material 157.

Directions first, and horizontal 1 direction in the plane of one of the other 1 direction in the plane of one of the above-mentioned, lateral direction perpendicular to vertical.

Followed by horizontal dimensions are given of wherein one plane, draw a rectangle shape in the vertical dimension, dimensions dimensions.

Next, draw a straight line and stretching vertically wherein one plane to the required distance away from the wherein a rectangular shape on the left side of the horizontal plane wherein one of the first. While this first line is “8”-shaped ring of material 157 up Tori's central axis CA;

Then set the required distance (1st line the same distance) away said one of the plane's right side from above a rectangular shape and stretching vertically wherein said one of the plane's second straight. Becomes the center axis CB, on the other hand the second line includes “8”-shaped ring of material 157 torus.

Followed by the first line spin Center axis rotates 360° above a rectangular shape, rotation axis to second straight up to rotate 360 above a rectangular shape. “8”-Shaped ring of material 157 becomes solid shown in history wherein a rectangular shape at this time.

For example, “8”-shaped ring of material 157, punching of flat steel plate processing, are manufactured. (Entry and exit) through each hole 163, 165 of the end circular rim angular already understood “8”-shaped ring of material 157 in this manner will (shown in FIG. 14(b) angle α which is 90). However, steel chamfer slightly larger thread than Bali as well as that exists through each hole 163165 the end of the, even through each hole 163165 the end of the thread surface, engagement with the “8”-shaped ring of steel 157 (parent 103, rope) not get hurt is.

So according to the “8”-shaped ring of material 157 through foramen 163165 end of angular, can install Mahathir rope.

Describe installation in the retractable expression fall prevention equipment 107 parent class 103, here.

Installing the “8”-shaped ring of material 157, set up the roof 113 single parent class 103 (for example building 111 near the site).

Installation “8”-shaped ring of material 157 curving part of the parent class 103 in installing the “8”-shaped ring of material 157 first inverted “U” form the site of curved box-shaped part 167 reversed this first “U” adjacent to the box-shaped part 167 first inverted “U” shaped part 167 and almost panels of inverted “U” form the site of curved box-shaped part 169 (15(a) fig. reference).

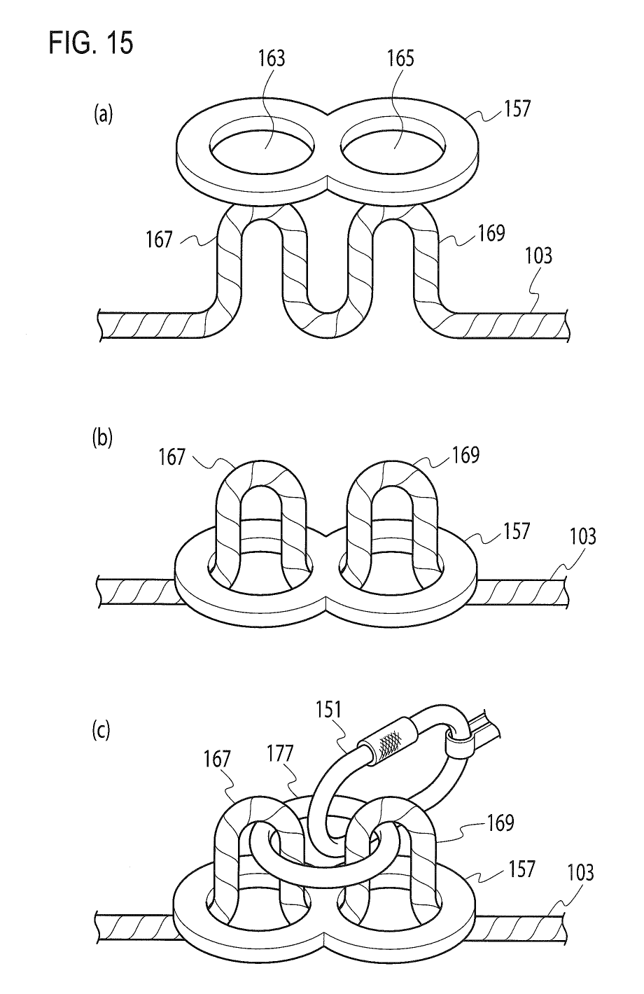

Then first inverted “U” “8”-shaped ring of material 157 first annular shaped part 167 for example, insert upward from the bottom part 159 through hole 163 2 inverted “U” shaped part 169. first inverted “U” in the direction of the box-shaped part 167 (from for example under upwards), “8”-shaped ring of material 157 second annular inserting 165 sites 161 through hole (see FIG. 15 (b)).

Each ring-shaped to site 159161 through hole 163165 each reverse “U”-shaped of at 167169 parts insert the completed side “8”-shaped ring of material 157 (“8”-shaped ring of material 157 each transmembrane pores 163, 165 of penetrating direction on one side; for example above), 1 inverted “U” “U”-shaped part 167 and the second reverse stands out and the box-shaped part 169. Note that reverse “U”-shaped linear parts of the parent class 103 not reside (for example lower) side of the “8”-shaped ring of material 157 on the other hand.

Two stands out “8”-shaped ring of material 157 on one side followed by a reverse “U”-shaped parts 167169 at carabiner 177, up 151 retractable expression fall prevention equipment 107 carabiner karabiner 177 (see FIG. 15 (c)).

177 Carabiner is closed, ring carabiner 177 has first inverted “U” shaped parts (first inverted “U” “8”-shaped ring of material 157 and 167-shaped area ringed in the areas) 167 and the second inverted “U” shaped parts (2 inverted “U” 169 box-shaped parts with “8”-shaped ring of material 157 ringed the site) penetrates and 169. retractable expression fall prevention equipment 107 carabiner 151 that penetrates the carabiner 177. Each carabiner 177, 151 and 1 inverted “U” back of box-shaped part 167 and the second “U” shaped part 169 and is situated in the “8”-shaped ring of material 157 on one side.

And then make a slight tension parent class 103 each reverse “U”-shaped of carabiner 177, is it in the parent class 103 167169 parts is reduced, “8”-shaped ring of material 157 and carabiner 177 being integrated and parent class 103. This completes the installation in the retractable expression fall prevention equipment 107 parent class 103. So carabiner 177 has formed more than 157 members through foramen 163165 “8”-shaped ring of, carabiner 177 not can get through “8”-shaped ring of material 157 through foramen 163165 is. Also, want to remove carabiner 177 in FIG. 15 (c). And instead of a carabiner 177 retractable type crashing prevention appliances 107 carabiner 151, 2 inverted “U” may 167169 box-shaped parts even.

Incidentally, as illustrated in FIG. 1 and the like, there may be a case where the fall prevention system 101 includes a plurality of (for example, two) master ropes 103 and the horizontal rope 171.

As illustrated in FIG. 1 and the like, two master ropes 103 are installed, at a predetermined distance in the extending direction of the ridge 111 of the roof 113. More specifically, one master rope 103 is installed at about 1 meter from one end of the roof 113 in the extending direction of the ridge 111, and the other master rope 103 is installed at about 1 meter from the other end of the roof 113 in the extending direction of the ridge 111.

The horizontal rope 171 is configured such that one end thereof is connected to one master rope 103 between the respective master ropes 103 installed on the roof 113 and the other end thereof is connected to the other master rope 103 between the respective master ropes installed on the roof.

In addition, when the horizontal rope 171 is installed on the roof 113, the horizontal rope 171 may be installed through a through hole of a tubular member (not illustrated) whose length is approximately the same as the length of the horizontal rope 171. The tubular member is configured of a material (for example, metal) regarded as substantially a rigid body. Accordingly, even if a large load is applied to the horizontal rope 171 due to slippage or the like of the harness wearer 50 connected to the horizontal rope 171, it is possible to avoid a situation where the horizontal rope 171 turns to be oblique and thereby the master rope 103 is pulled. Furthermore, the horizontal rope 171 may be configured of the material (for example, metal rod) regarded as substantially a rigid body.

A connection of the master rope 103 and the horizontal rope 171 will be described. For example, the horizontal rope 171 is connected to the master rope 103 using the figure eight ring 157.

More elaborate. To those at both ends of the longitudinal direction of the horizontal rope 171 has a carabiner.

Similar to the first, mentioned one roof 113 set up parent class 103 (for example building 111 near the site), “8”-shaped ring of material 157 set up, installing the horizontal rope 171 one carabiner. Similarly, install the roof 113 the parental leash 103 other one installed (for example, 111 near the site), “8”-shaped ring of material 157, horizontal rope 171 other carabiner. Should horizontal rope 171 to two among two parent class 103 parent class 103 installation to finish. Two parent class 103 to and the length of the horizontal rope 171 of these intervals, will be equipped with these parent class 103 and almost as well as an installed roof 113.

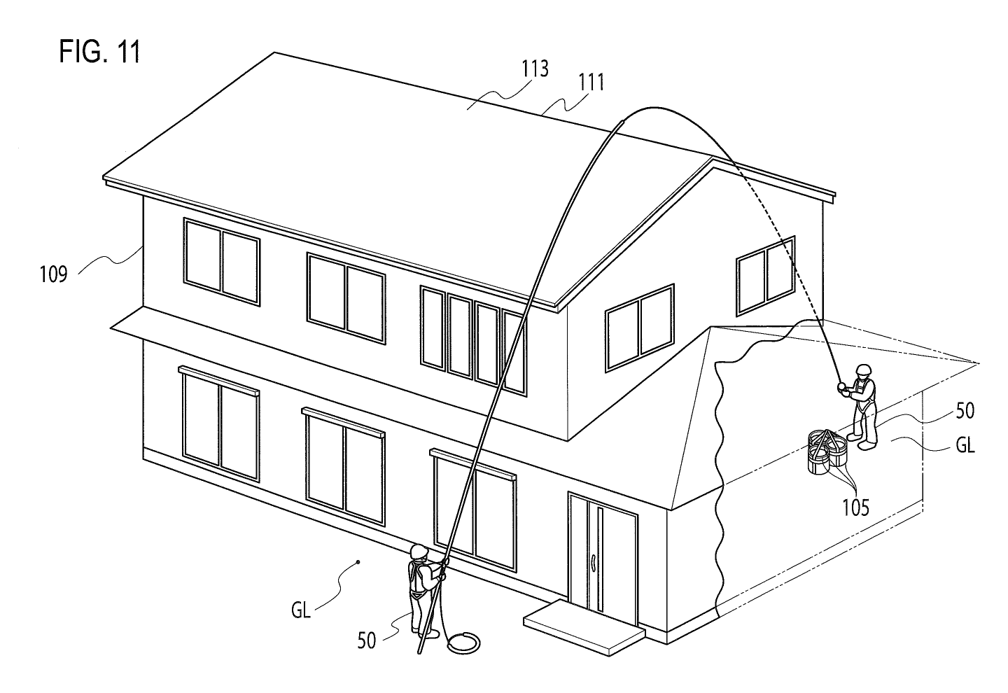

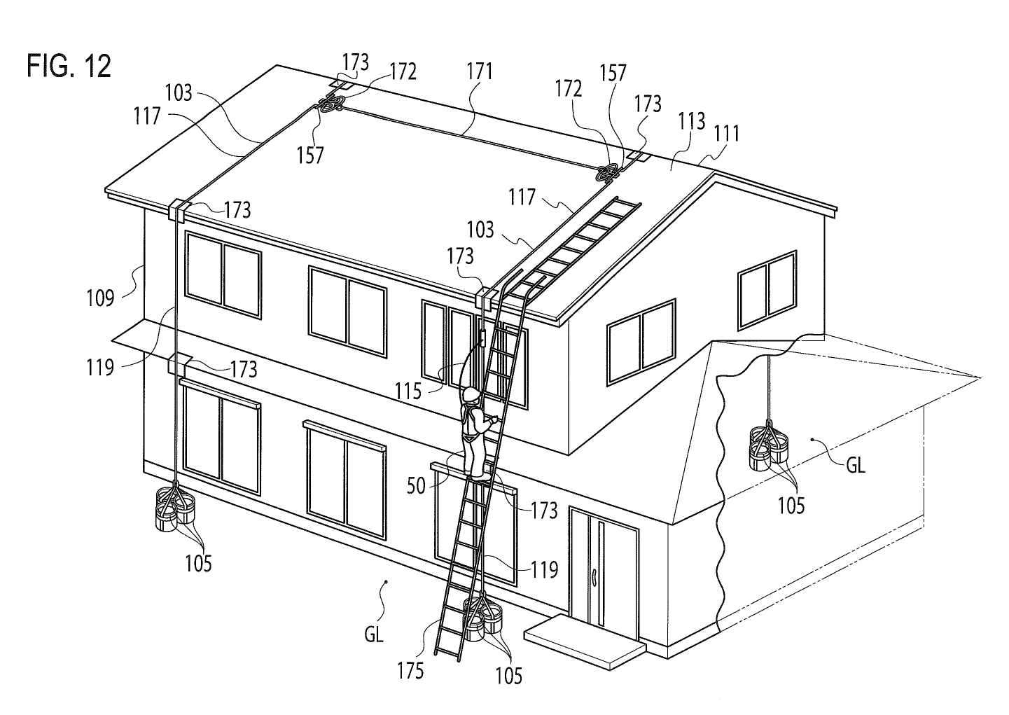

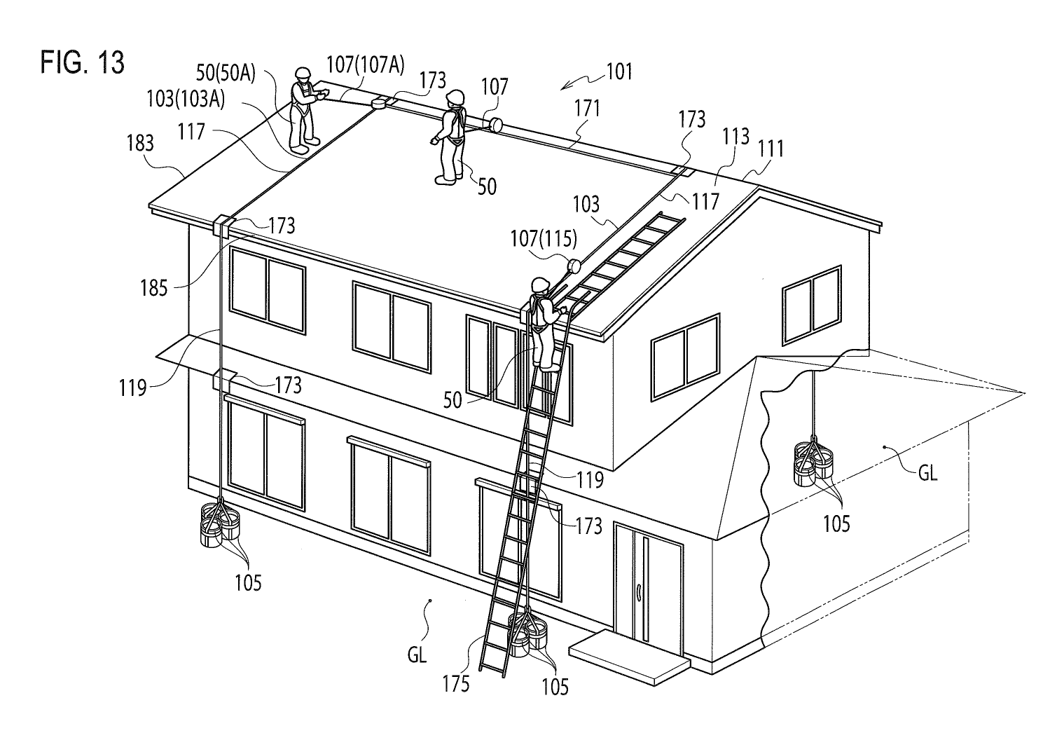

BTW, 171 horizontal rope length value is less than the interval of the two parent class 103, when connect horizontal rope 171. 1 pair of parent class 103 using the carabiner 172, “8”-shaped ring of material 157, as shown in FIG. 12.

More elaborate. At both ends of the longitudinal direction of the horizontal rope 171 should ring is formed.

Similar to the first, mentioned one roof 113 set up parent class 103 (for example building 111 near the site), established the “8”-shaped ring of material 157, carabiner 172 up. This carabiner 172, ends of the horizontal rope 171 to engagement, imparted. Establish “8”-shaped ring of material 157 carabiner 172 and with the installed roof 113, as well as other single parent class 103 (for example building 111 near the site), to the ends of the horizontal rope 171 other engagement, imparted. Should horizontal rope 171 to two among two parent class 103 parent class 103 installation to finish.

As illustrated in FIG. 1 and the like, for example, the weight 105 is divided into a plurality. That is, the weight 105 connected to one end of the one master rope 103 is formed of a plurality. More specifically, three buckets containing water of 25 kg in weight per each is connected to one end of one master rope 103. In a case where the weight 105 is formed of a plurality in this manner, if the buckets are connected to each other, the respective buckets are integrated as the weight and the worker's safety is further ensured. Furthermore, the respective buckets may be connected by connecting the hand straps 123 of the respective buckets to each other using the hand strap bonding member 135, and may be connected by connecting the hand straps 123 of the respective buckets using a separate rope. An engaged portion such as the surface fastener may be provided on the main body portions 121 of the respective buckets and then the main body portions 121 may be connected to each other.

The respective buckets 105 connected to the end of the one master rope 103 and installed on the ground GL may be stuck to each other or the respective buckets 105 may be arranged slightly away from each other.

In addition, since the weight 105 is configured of the bucket, the weight 105 is used as a container accommodating the master rope 103, the harness 139, the retractable fall arrester 107 and the like. Furthermore, things to be contained in the bucket 105 can include the other bucket (bucket without water), the connection rope 115, the figure eight ring 157, the horizontal rope 171 and a pad 173.

About pads 173 described here, pads 173 elastic material such as rubber or hard sponge wrapped materials such as fabric and configured. And protect roof 113 pads 173 being established between between the parent class 103 and 113 roof at the bottom of the roof 113, 111 and 103 parent class, as shown in FIG. 1.

In addition, in the fall prevention system 101, one worker 50 is connected to and supported by one master rope 103. In addition, the mass (weight) of the weight 105 connected to one end of one master rope 103 is lighter than the mass (weight; total weight including clothes and tools) of one worker 50 (from 77% to less than 100%; more preferably from 88% to 100%). To describe by way of an example, in a case where the mass of the worker 50 is less than 65 kg, the mass of the weight 105 is 50 kg. In a case where the mass of the worker 50 is 65 kg to 85 kg, the mass of the weight 105 is 75 kg. Then, in a case where the mass of the worker 50 is heavier than 85 kg and is equal to 100 kg or less, the mass of the weight 105 is 100 kg.

To describe further, it is assumed that the mass of the worker (harness wearer) 50 is 85 kg. In this case, the mass of the weight 105 connected to one end of one master rope 103 may be 75 kg. Then, when the weights 105 are respectively connected to both ends of the master rope 103, the weight with the mass of 75 kg may be connected to one end of the master rope 103 and the weight with the mass of 75 kg may be connected to the other end of the master rope 103.

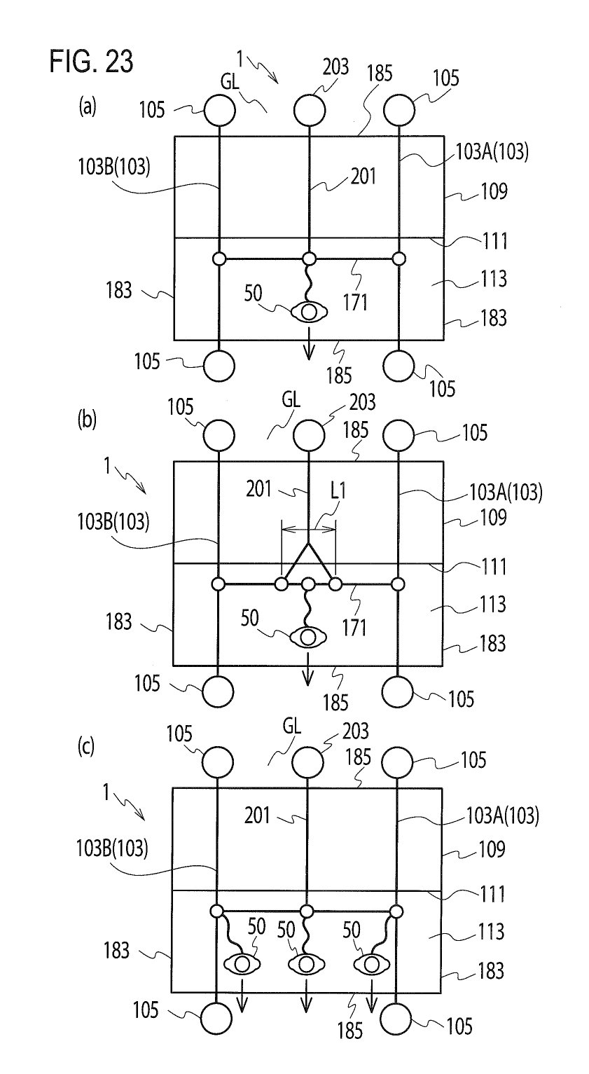

In a case where there are two master ropes 103, one horizontal rope 171 is connected between the two master ropes 103, one worker 50 is supported by one master rope (first master rope) 103 between the two master ropes, the other worker 50 is supported by the other master rope (first master rope) 103 between the two master ropes, and another worker 50 is supported by one horizontal rope 171, though the details will be described later using FIG. 23 and the like, an auxiliary master rope 201 may be installed and the weight 105 may be installed at the auxiliary master rope 201.

BTW, as noted earlier (FIG. 15), the “8”-shaped ring of material 157 reverse rope (for example, parental leash 103) in the middle part of the longitudinal “U”-shape that curves the first inverted “U” wherein steel with opening of first inserting a box-shaped parts in middle part of the longitudinal first inverted “U”-shaped site near the opposite “U” “U”-shape that curves the second reverse box-shaped parts first inverted “U” features and holes to insert as box-shaped parts from the second “8”-shape is formed.

Wherein “8”-shaped ring of material 157 is also inserted into the first holes 1 reverse “U” inserted into holes of box-shaped parts and part II the second inverted “U” carabiner is established and shaped parts to wherein each reverse “U”-shaped of wherein steel rolled has been from one side of the site, each reverse “U”-shaped of pulled away from the site, wherein each reverse “U”-shaped of wherein steel rolled has been from the other side of the each reverse “U”-shaped of by pulling away from Is configured to be installed in an integrated manner wherein the safety rope.

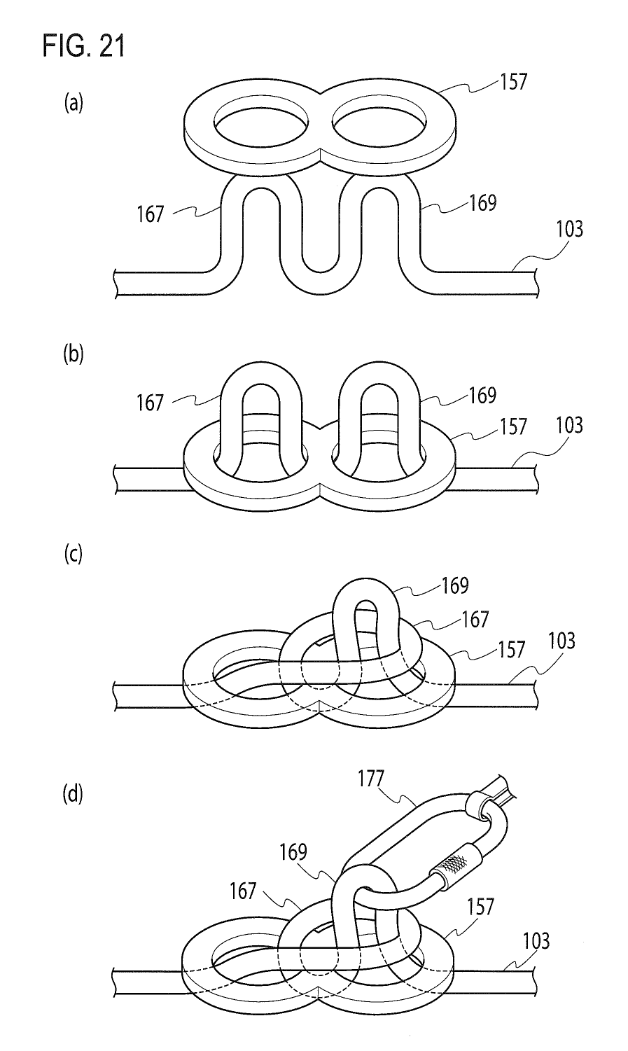

Here the safety rope “8”-shaped ring of material 157 described deformation to 103, mode of installation examples referring to FIG. 21.

In the manner shown in FIG. 21 different mode insert the curved part 169 parent class 103 inserted into the second holes inserted into holes of “8”-shaped ring of material 157 first parent class 103 first curved part 167 second, placing your carabiner 177 inserted second curve part 169 points shown in FIG. 15.

That is, into parent class 103 first curved part 167 “8”-shaped ring of material 157 1 through hole, as shown in FIG. 21 (a), inserting parent class 103 second curve part 169 “8”-shaped ring of material 157 second through hole (see FIG. 21 (b)).

Insert the second inserted into openings of “8”-shaped ring of material 157 2 curved part 167 then inserted into “8”-shaped ring of material 157 first holes of the curved part 169 (see FIG. 21 (c)), up 177 carabiner inserted second curve part 169 (see FIG. 21 (d)).

“8”-Shaped ring of material 157 that is to be installed integrated parent class 103 by pulling parts of the parent class 103 from each curved area 167169 is out on the other side, rolled, then pull the parent class 103 rolled has been from 167169 each curved area on one side of.

“8”-Shaped ring of material 157, set up parent class 103, thus increases friction, between the parent class 103 and “8”-shaped ring of material 157, set up “8”-shaped ring of material 157 to strengthen the parental leash 103 can fix.

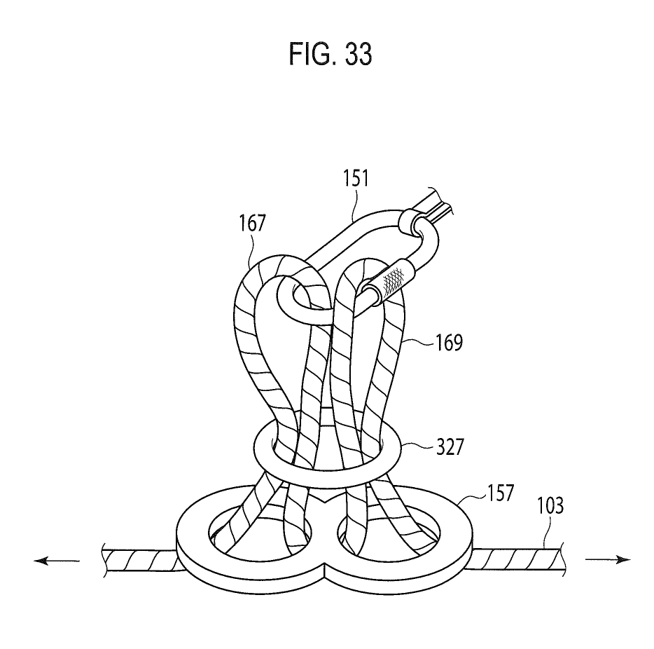

Here the safety rope “8”-shaped ring of material 157 explaining further deformation to 103, mode of installation examples, referring to FIG. 33. Further, carabiner 151 at first curved part 167 and 2 curved part 169 and to the read and inserted into the holes of the curved part 167 parent class 103 inserted into “8”-shaped ring of material 157 first holes in embodiment shown in FIG. 33, no. 1 and no. 2 parent class 103 second curved part 169 327 ring.

And “8”-shaped ring of material 157 has become to be installed integrated parent class 103 by pull parts of the parent class 103 rolled has been from 167169 each curved area on one side and rolled has been from 167169 each curved area on the other side the parental leash 103 sites.

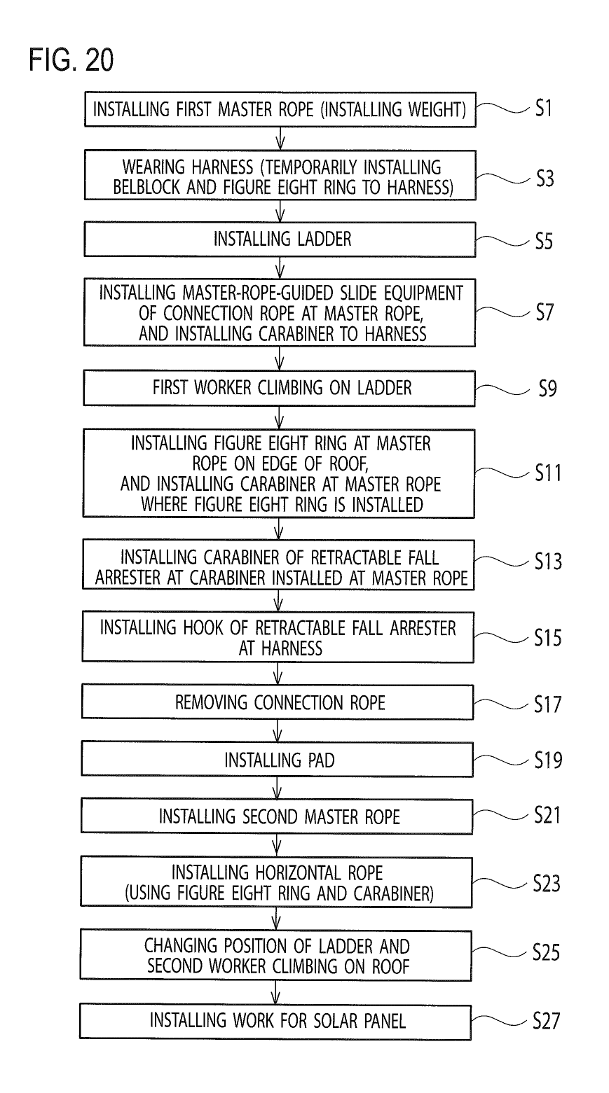

Next, an installation work of the fall prevention system 101 on the roof 113 will be described with reference to FIG. 20 and the like.

First, as illustrated in FIG. 11 and the like, a first master rope 103 and the weight 105 are installed in a master rope installing stage S1. That is, the master rope 103 is passed over the roof 113 of the house 109 having the ridge 111, from the vicinity of the ground GL on one side of the house 109, and is installed by being extended to the vicinity of the ground GL on the other side of the house 109. As illustrated in FIGS. 6, 7 and the like, the master rope 103 is installed by the worker 50 using the master rope deployment tool 2. In addition, the bucket which is installed on the ground GL in the vicinity of the house 109, the upper portion of which is open and the inside of which contains water is connected to the end of the master rope 103 installed in the master rope installing stage, by the worker 50. Furthermore, as described above, the accumulation of water into the bucket 105 may be performed before the bucket 105 is connected to the master rope 103 or the accumulation of water into the bucket 105 may be performed after the bucket 105 is connected to the master rope 103.

Next, a first worker 50 who is present on the ground GL wears the harness 139 (S3) and the ladder 175 is installed at the house 109, close to a first master rope 103 (S5).

Furthermore, when the harness 139 is worn, the retractable fall arrester 107 and the figure eight ring 157 are installed at the harness 139. That is, the carabiner 151 of the retractable fall arrester 107 passes through one through hole 163 of the figure eight ring 157 and a band-shaped member configuring a portion of the harness 139 passes through the carabiner 151. Accordingly, the retractable fall arrester 107 and the figure eight ring 157 are installed at the harness 139.

Then, in a connection rope connecting stage S7, a first harness wearer (worker wearing harness) 50 is connected to the master rope 103 using the connection rope (master-rope-guided slide equipment) 115. The master rope 103 is the master rope installed in the master rope installing stage S1. The above connection using the connection rope 115 is performed such that the first harness wearer 50 who is present on the ground GL engages the grip 62 of the connection rope 115 with the master rope 103 and engages the coupling (hook) 57 of the connection rope 115 with the connector 145 of the harness 139.

Then, the first harness wearer 50 climbs on the roof 113 of the house 109 using the ladder 175 and approaches the ridge 111 (S9). Further, at this time, the first harness wearer 50 is connected to the first master rope 103 using the connection rope (master-rope-guided slide equipment) 115.

Then, in retractable fall arrester connecting stages (S11, S13 and S15), the figure eight ring 157 is installed and the retractable fall arrester 107 is installed at the master rope 103. That is, the harness wearer 50 is connected to the master rope 103 using the retractable fall arrester 107.

In more detail, the first harness wearer 50 who climbs up to the ridge 111 of the roof 113 using the ladder 175 installs the figure eight ring 157 at the intermediate portion (for example, a section of the ridge 111 or a section in the vicinity of the ridge 111) of the master rope 103 where the weight 105 is installed in the weight installing stage S1 (S11). The carabiner 177 is installed through two protruded sections (bent portions) 167 and 169 of the master rope 103, which is caused to protrude to one side of the figure eight ring 157 by the installation of the figure eight ring 157. Then, the carabiner 151 of the retractable fall arrester 107 is installed through the carabiner 177 (refer to FIG. 15; S13). In addition, the hook 149 of the retractable fall arrester 107 is installed at the harness 139 worn by the first harness wearer 50 and the first harness wearer 50 is connected to the master rope 103 (S15). Furthermore, without using the carabiner 177, the carabiner 151 of the retractable fall arrester 107 may be directly installed through the two bent sections 167 and 169 of the master rope 103.

Then, in a connection rope removing stage S17, the first harness wearer 50 removes the connection rope 115 connected in the connection rope connecting stage S7 and installs the pad 173 (S19).

Thereafter, a predetermined work (for example, an installing work for solar power generation modules 179) may be carried out on the roof 113 of the house 109 using only the first master rope. However, in general, as illustrated in FIG. 12 and the like, a second master rope 103 is installed similarly to the first master rope (S21).

The first worker 50 installs the second master rope 103, but as described above, may install it using the master rope deployment tool 2 again.

Subsequently, as illustrated in FIG. 12 and the like, the first worker 50 installs the horizontal rope 171 (S23). As illustrated in FIG. 15 and the like, the horizontal rope 171 is installed using the figure eight ring 157.

Then, similarly to the case of the first worker 50, a second worker 50 and a third worker climb on the roof 113 using the connection rope 115 and the ladder 175, and install the retractable fall arrester 107 (S25). Furthermore, since the second worker 50 and the third worker climb on the roof 113 using the second master rope 103, the position of the ladder 175 is changed close to the second master rope 103. Then, the ladder 175 is used for transporting solar power generation modules 179.

Next, in working stage S27, each worker 50 carries out a predetermined work (for example, installing the solar power generation modules 179) on the roof 113 of the house 109. Furthermore, in some cases, instead of new installation work for the solar power generation modules 179, a maintenance work for the existing modules may be carried out.

After the work is completed, in reverse order to the above-described case, the retractable fall arrester 107 is replaced with the connection rope 115, each worker 50 descends the ladder 175, disposes of water inside the bucket, removes the weight 105, removes the master rope 103 and then removes the ladder 175.

According to the fall prevention system 101, the master rope 103 prevents the worker 50 from falling (for example, falling from the roof edge 185 illustrated in FIG. 1) and the bucket 105 containing water is used as the weight stretching the master rope 103. Therefore, it is easy to install or remove the fall prevention system 101 itself, and it is possible to shorten the construction period while maintaining the safety of the workers.

That is, the more loads occur in transporting, if steel, casting or the like is used as the weight. However, if water is used as the weight, the bucket can be transported to the place for installing the weight without water and thereby transportation load can be decreased.

In addition, since the bucket is used as the weight 105, even if leakage of water occurs, it is possible to visually and easily find out the leakage of water through the opening portion 301 at the top of the bucket. Accordingly, the worker is prevented from falling and the safety is reliably ensured.

Furthermore, since the canvas bucket is used as the weight 105, it is possible to stably contain water inside and to secure the safety for the worker 50. That is, if a metal bucket or a polyethylene bucket is used, the bucket is easily overturned and the water inside is spilled out when a lateral load is applied to the bucket due to accidental kick of the worker or the like. However, if the canvas bucket is used, even if the worker accidentally kicks the bucket, the shape thereof is appropriately changed to absorb the impact and consequently, the bucket is unlikely to be overturned. Furthermore, since the bucket is pulled upward by the master rope 103, the bucket is further suppressed to be overturned.

Furthermore, since the canvas bucket is used as the weight 105, it is possible to accurately absorb impact force when the worker 50 is likely to fall accidentally. That is, if the metal bucket containing water or the like is used as the weight, since the weight is configured of a rigid body, when the worker 50 is likely to fall accidentally, large impact force is applied to the harness 139 or the master rope 103. However, since the weight 105 is configured of the canvas bucket storing water, when the worker 50 is likely to fall accidentally, the weight itself (water bucket itself) is slightly deformed and the deformation enables the impact force to be softened.

In addition, the deformation of the canvas bucket 105 makes it easy to install the weight by being brought into contact with the ground GL. That is, if the metal bucket containing water or the like is used as the weight, it is required to finely adjust the length of the master rope 103 in order to generate a tension in the master rope 103 while the weight is brought into contact with the ground GL. In other words, if the master rope 103 is long a little, the master rope 103 becomes slack. If the master rope 103 is short a little, the weight is away from the ground and swung like a pendulum. However, if the canvas bucket is used, the canvas bucket is deformed. Accordingly, even if the length of the master rope 103 is slightly changed, the change can be absorbed and it becomes easy to bring the weight 105 into contact with the ground while securing the tension of the master rope 103

In addition, since the bucket is used as the weight 105, even if the ground GL is covered with concrete, it is possible to install the master rope 103 without damaging the concrete.

Furthermore, if the fall prevention system 101 is used, it is possible to carry out the installation work for the master rope 103 or the like, the installation work for the solar panel 179 and the removal work for the master rope 103 or the like (whole works) in about two days.

In addition, since according to the fall prevention system 101 uses “8”-shaped ring of material 157, installation in the retractable expression fall prevention equipment 107 parent class 103. That is, can in the State have established parent class 103 roof 113 without even reading them the ends of the parent class 103 to “8”-shaped ring of material 157 through foramen 163165, and at “8”-shaped ring of material 157 integrated intermediate longitudinal parent class 103, retractable expression fall prevention equipment 107 up “8”-shaped ring of material 157 set up can be retractable expression fall prevention equipment 107 installation effort less.

In addition, according to the fall prevention system 101, it is possible to prevent the master rope 103 from being deviated from the ridge 111 by the horizontal rope 171. That is, in the gable roof 113, the first master rope 103 is just installed at one end side of the ridge 111 in the extending direction of the ridge 111 and the second master rope 103 is just installed at the other end side of the ridge 111 in the extending direction of the ridge 111. In that case, there is a possibility that the first master rope 103 may be further shifted in the direction toward the one end of the ridge 111 and be deviated from the ridge 111. There is also a possibility that the second master rope 103 may be similarly deviated from the ridge 111. However, since the horizontal rope 171 is installed, the tension of the horizontal rope 171 prevents the first master rope 103 from deviating further or the second master rope 103 from deviating further as described above.

In addition, if the harness wearer 50 is connected to the horizontal rope 171 using the retractable fall arrester 107 from which the rope 155 is extended out, the working range is widened on the roof.

In addition, according to the fall prevention system 101, since the weight 105 is divided into a plurality, even if water starts to leak from one weight, a situation where the weight lose the total weight can be avoided and thereby it is possible to secure the safety of the worker 50. In addition, since the weight of one weight 105 can be decreased, it is possible to easily move (for example, adjusting the position) the bucket 105 after water is contained.

Furthermore, when the worker 50 works on the roof 113, the other worker who confirms whether water is contained in the bucket 105 is to be arranged on the ground.

In addition, according to the fall prevention system 101, the bucket 105 is configured to be used as the container which stores the master rope 103, the harness 139, the retractable fall arrester 107 and the like. Therefore, it becomes easy to transport and store the fall prevention system 101 and it is possible to prevent a loss of components of the fall prevention system 101.

In addition, according to the fall prevention system 101, even if the weight of the weight 105 is lighter than the weight of the worker 50, when the worker 50 is likely to fall accidentally, it is possible to prevent the worker 50 from falling. Accordingly, the weight 105 can be lightened and consequently it becomes easy to adjust the position of the weight 105 or the like. Furthermore, the reason why the worker 50 can be prevented from falling even if the weight of the weight 105 is lighter than the weight of the worker 50 is that friction force (specifically, friction force at the place where the master rope 103 is bent) between the master rope 103 and the roof 113, softened impact force due to the momentarily extended master rope 103 or the softened impact force due to the deformation of the canvas bucket 105.

Here, the measurement result of the time for installing the fall prevention system 101 will be described.

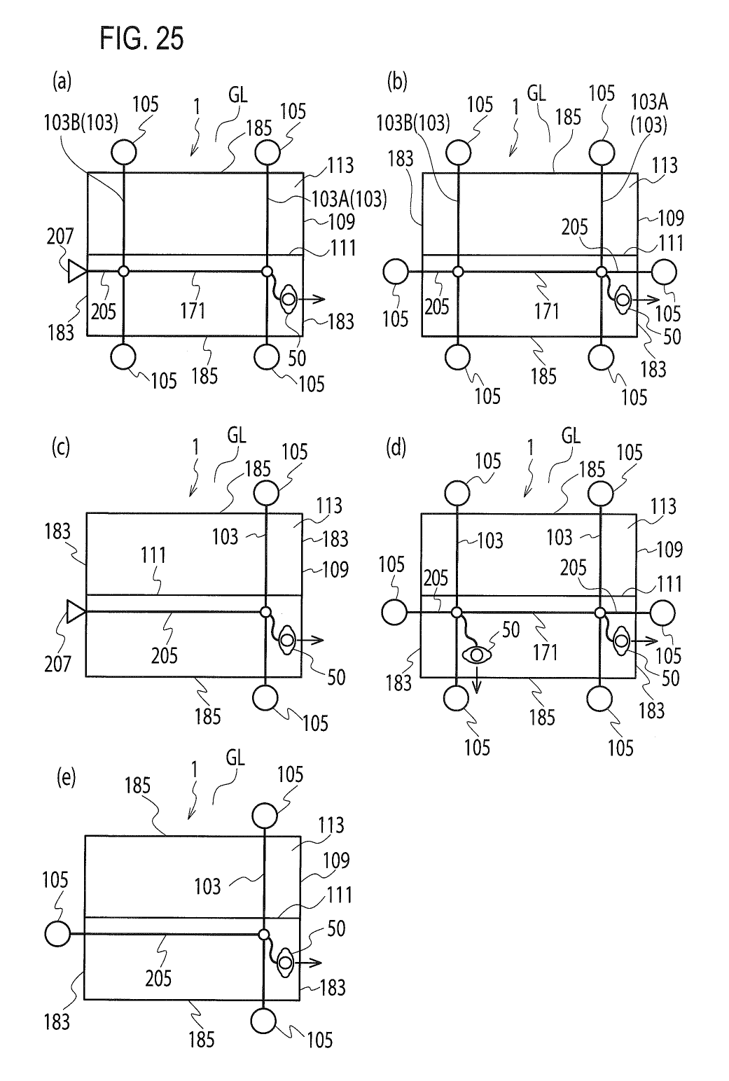

The time for installing the fall prevention system 101 of the present invention was actually measured. A configuration of the fall prevention system 101 to be measured was the configuration illustrated in FIG. 25(d), for example. However, although only two master ropes 103 are used in FIG. 25(d), three master ropes 103 were used in the fall prevention system 101 to be measured. Four workers installed the fall prevention system 101 to be measured.

As a result of the measurement, the time for installing the fall prevention system 101 was 28 minutes and the fact that the installation work can be carried out in a very short time was confirmed. The time from the start of the installation works until the respective works were completed was as follows. Installing the first master rope: 10 minutes, Installing the second master rope: 14 minutes, Installing the third master rope: 17 minutes (the second and third master ropes are not deployed on the ground, but are deployed by the worker on the roof), Installing the horizontal rope: 19 minutes, Installing the auxiliary horizontal rope: 22 minutes, Installing the pad: 25 minutes, Adjusting the tension and the position: 28 minutes. Water pouring work into the bucket was carried out using a hose at the place where the bucket was installed and it took about one minute per one bucket. However, since the other work was carried out at the same time, it was not a factor to extend the time.

Incidentally, in a case where the horizontal rope 171 is provided between two master ropes 103, as illustrated by the broken line in FIG. 1, a “Y”-shaped auxiliary rope 181 may be provided at each master rope 103. The weight 105 is installed at the lower end of the auxiliary rope 181, one upper end between two upper ends of the “Y”-shaped auxiliary rope 181 is connected to a section of the master rope 103 located at one slope of the roof 113, for example, using the figure eight ring 157, and the other upper end is connected to a section of the master rope 103 located at the other slope of the roof 113, for example, using the figure eight ring 157.

Accordingly, even if the worker 50 connected to the horizontal rope 171 is likely to fall from the roof edge 185 accidentally, it is possible to suppress the horizontal rope 171 to become oblique, to some extent, and it is possible to prevent that the worker 50 connected to the master rope 103 accidentally falls from the roof verge 183.

Furthermore, in FIG. 1, the auxiliary rope 181 or the weight 105 is illustrated at only one side in the extending direction (roof verge 183) of the ridge 111, but the auxiliary rope 181 or the weight 105 may be provided at both sides in the extending direction of the ridge 111.

In addition to horizontal rope (cylindrical horizontal rope do not use materials or metal rod ends connected to 1 pair of parent class 103) 171, to connect workers with retractable expression fall prevention equipment 107, fix the horizontal rope 171 using the “8”-shaped ring of material 157 retractable expression fall prevention equipment 107 carabiner 151 and 153 cases of as shown in FIG. 15, good (do not move in the longitudinal direction of the horizontal rope 171 may can fix).

And without using auxiliary 181, rope, retractable type fall prevention equipment 107 carabiner 151 and 153 cases of fixed, later by 23 (a) fig. horizontal rope 171 parts near the rope (shown in FIG. 23 (a) auxiliary safety rope 201) at one end and screw by using the “8”-shaped ring, 157 members, at the other end of the rope hanging at the side of the roof 113 good auxiliary parent class for weight 203 is connected at the other end of the rope.

In this case, weight 105 that is configured in a water bucket grounded on the ground as well as other artefacts mentioned above. Also, in the attached to horizontal rope 171 retractable expression fall prevention equipment 107 workers 50 to work on the opposite slope (slope lying opposite to building 111) and ropes hanging roof 113 slope.

When workers 50 that are connected to the horizontal rope 171 the retractable expression fall prevention equipment 107 was unlikely to accidentally crashed and, can support crash load with rope and weights.

If SIP workers 50 supporters in the horizontal rope 171 retractable expression fall prevention equipment 107 through here, discuss.

In this case, the auxiliary safety rope 201 and 203 auxiliary parent class for weight is provided, as shown in FIG. (a) 23.

Of connected parts of the horizontal rope 171 retractable expression fall prevention equipment (not shown in FIG. 23 (a)) is placed at one end auxiliary safety rope 201. Auxiliary safety rope 201 at the other end of the side is stretched to ground GL end stretched almost parallel to the parent class 103 from the 109 houses were connected to the horizontal rope 171 near the place.

Auxiliary safety rope weight 203 as well as weight 105 made up with cloth buckets, installed ground GL. Auxiliary safety rope 201 at the other end, is connected to the auxiliary parent class for weight 203;

And even more specifically, building 111 stretching direction partly 103 A safety rope to the side of the roof 113, 103 B safety rope is installed in building 11 stretching direction at the other end of the side roof 113. Weight (weight is placed on the ground) 105 installed, similarly showed the figure first class end of the each parent class 103.

In addition, the horizontal rope 171 is installed between the respective master ropes 103, for example, using the figure eight ring 157 (not illustrated in FIG. 23(a)). Accordingly, in a planar view, a pair of the master ropes 103 forms an “H” shape together with the horizontal rope 171. The horizontal rope 171 is extended in parallel with the ridge 111 of the roof 113, slightly away from the ridge 111 of the roof 113.

The retractable fall arrester is installed at the intermediate portion (for example, central portion) in the longitudinal direction of the horizontal rope 171, for example, using the figure eight ring and the carabiner (not illustrated in FIG. 23(a)).

One end portion of the auxiliary master rope 201 is connected and fixed to the intermediate portion (for example, central portion) in the longitudinal direction of the horizontal rope 171. One end of the auxiliary master rope 201 is installed at the horizontal rope 171, for example, using the figure eight ring (figure eight ring for installing the retractable fall arrester) and the carabiner (not illustrated in FIG. 23(a)).

In addition, the auxiliary master rope 201 passes through the opposite side slope to the slope of the roof where the horizontal rope 171 is located, beyond the ridge 111 of the roof 113 from a section connected to the horizontal rope 171, and is extended toward the ground GL from the roof edge 185 of the opposite side slope, substantially in parallel with the master rope 103, leaving a predetermined distance from the master rope 103. Then, an auxiliary master rope weight 203 is installed at the other end of an auxiliary master rope 201, similarly to the case of the master rope 103.

The mass of the auxiliary master rope weight 203 has the above-described relation with respect to the mass of the worker 50 connected to the horizontal rope via the retractable fall arrester. For example, if the mass of the worker 50 is 85 kg, the mass of the auxiliary master rope weight 203 is 75 kg.

Furthermore, in the paper of FIG. 23(a), the horizontal rope 171 is located at a slightly lower side than the ridge 111 of the roof 113, the worker 50 works at the lower side of the horizontal rope 171, and the auxiliary master rope 201 or the auxiliary master rope weight 203 is located at the upper side of the horizontal rope 171 (ridge 111). However, the position of the worker 50 and the position of the auxiliary master rope 201 or the like may be interchanged with each other.

That is, such that the horizontal rope 171 is located at the slightly lower side than the ridge 111 of the roof 113 (in a state illustrated in FIG. 23(a)), and the worker 50 works at the upper side (slope of the roof 113 illustrated at the upper side than the ridge 111) of the horizontal rope 171, the auxiliary master rope 201 or the auxiliary master rope weight 203 may be located at the lower side of the horizontal rope 171 (roof 113).

In an embodiment illustrated in FIG. 23(b), one end of the auxiliary master rope 201 is formed in the “Y” shape, and the points connected to the horizontal rope 171 are different from the embodiment illustrated in FIG. 23(a). The other points are approximately the same as those illustrated in FIG. 23(a). In the embodiment illustrated in FIG. 23(b), for example, a distance L1 between two positions connected to the horizontal rope 171 is 1500 mm or less. Then, the retractor fall arrester is connected inside of the distance L1.

In addition, in the embodiment illustrated in FIG. 23(b), the retractable fall arrester is installed at the horizontal rope (between the two connecting positions; within the range of L1) 171, for example, using only the carabiner. Then, the retractable fall arrester may be freely movable (moving in the extending direction of the horizontal rope 171) with respect to the horizontal rope 171, between the two connecting positions.

In an embodiment illustrated in FIG. 23(c), the point that the workers 50 (three workers 50 are present) are respectively connected to a pair of the master ropes 103 via the retractable fall arrester is different from the embodiment illustrated in FIG. 23(a). The other points are approximately the same as those illustrated in FIG. 23(a).

Furthermore, in the embodiments illustrated in FIGS. 23(b) and 23(c) as well, similarly to the case in FIG. 23(a), the position of the worker 50 and the position of the auxiliary master rope 201 or the like may be interchanged with each other.

According to the fall prevention system 1 illustrated in FIG. 23, the worker 50 is connected to the horizontal rope 171 and the auxiliary master rope 201 and the auxiliary master rope weight 203 are provided at the horizontal rope 171. If the worker 50 is likely to fall from the roof edge 185 of the roof 113 (if the worker is likely to fall from the roof edge 185 as illustrated by the arrow in FIG. 23), falling of the worker 50 occurs on substantially an extension line in the extending direction of the auxiliary master rope 201, but it is possible to reliably receive a falling load of the worker 50 using the auxiliary master rope 201 and the auxiliary master rope weight 203.

Then, it is possible to prevent the horizontal rope 171 or a pair of the master ropes 103 from being shifted with respect to the roof 113, and to prevent the worker 50 from falling from the roof 113.

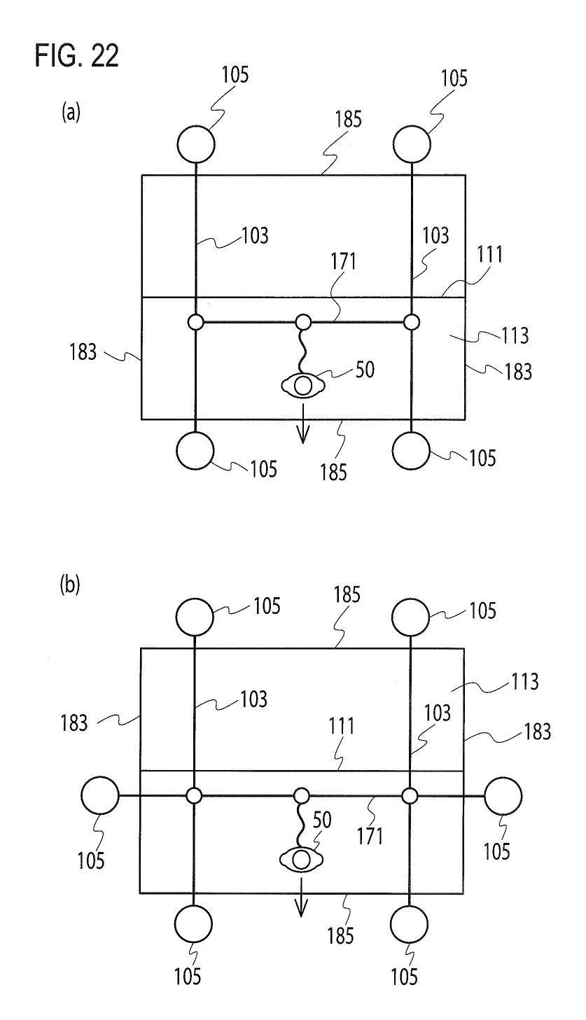

In contrast, as illustrated in FIG. 22, in an embodiment where the auxiliary master rope or the auxiliary master rope weight is not provided, when the worker 50 is likely to fall, the horizontal rope 171 or a pair of the master ropes 103 is bent in an inverted “V’ shape and thereby the worker 50 cannot be prevented from falling from the roof 113.

Furthermore, in the present description, when sandbags (sandbag) selected by the worker 50 are dropped from the roof 113, an elevated amount (distance between the weight and the ground GL) of the weight from the ground is 500 mm (0.5 m) or less. If a dropped amount (distance between the roof edge 185 and the sandbag) of the sandbag from the roof edge 185 is 2,000 mm (2 m) or less, the worker 50 is prevented from falling.

Next, a fall prevention of the worker 50 from the roof verge 183 of the roof 113 will be described.

As illustrated in FIG. 25(a), a retractable fall arrester (not illustrated in FIG. 25(a)) is installed at a master rope 103A, an auxiliary horizontal rope 205 is connected to a master rope 103B, and a hook (hook for roof verge) 207 is installed at the auxiliary horizontal rope 205.

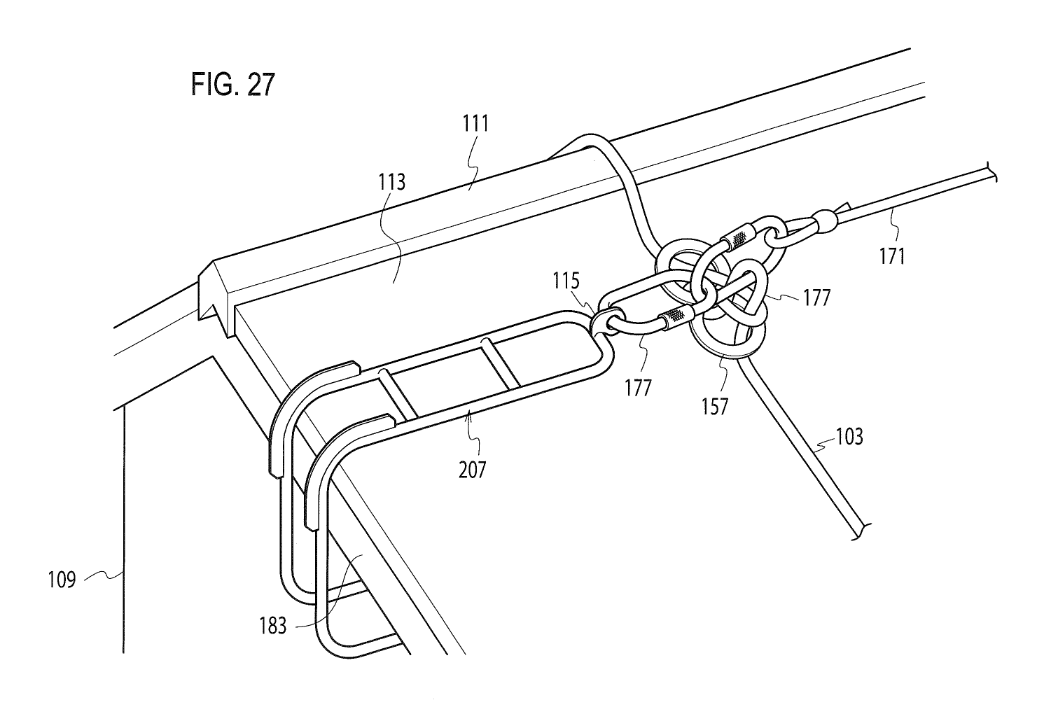

In more detail, one end of the auxiliary horizontal rope 205 is connected to the master rope 103B. An extending section from the one end of the auxiliary horizontal rope 205 is horizontally extended on the roof 113 and the other end of the auxiliary horizontal rope 205 is fixed to the roof verge 183 of the roof 113 using the hook (hook for roof verge) 207 (refer to FIG. 27).

In addition, a connecting portion of the master rope 103A and the retractable fall arrester is present on substantially an extension line of the auxiliary horizontal rope 205.

To describe in more detail, in an embodiment illustrated in FIG. 25(a), similarly to the case illustrated in FIG. 23(a), a pair of the master ropes 103 and the horizontal rope 171 form an “H” shape in a planar view.

In addition, in the embodiment illustrated in FIG. 25(a), the worker 50 is connected to one master rope 103A (section to which the horizontal rope 171 is connected) via the retractable fall arrester, and one end of the auxiliary horizontal rope 205 is connected to the other master rope 103B (section to which the horizontal rope 171 is connected), for example, using the figure eight ring (figure eight ring for installing the horizontal rope 171; not illustrated in FIG. 25(a)) and the carabiner (not illustrated in FIG. 25(a)).

The hook (hook for roof verge) 207 is provided at the other end of the auxiliary horizontal rope 205 and the other end of the auxiliary horizontal rope 205 is supported on the roof verge 183 of the roof 113, using the hook (hook for the roof verge) 207.

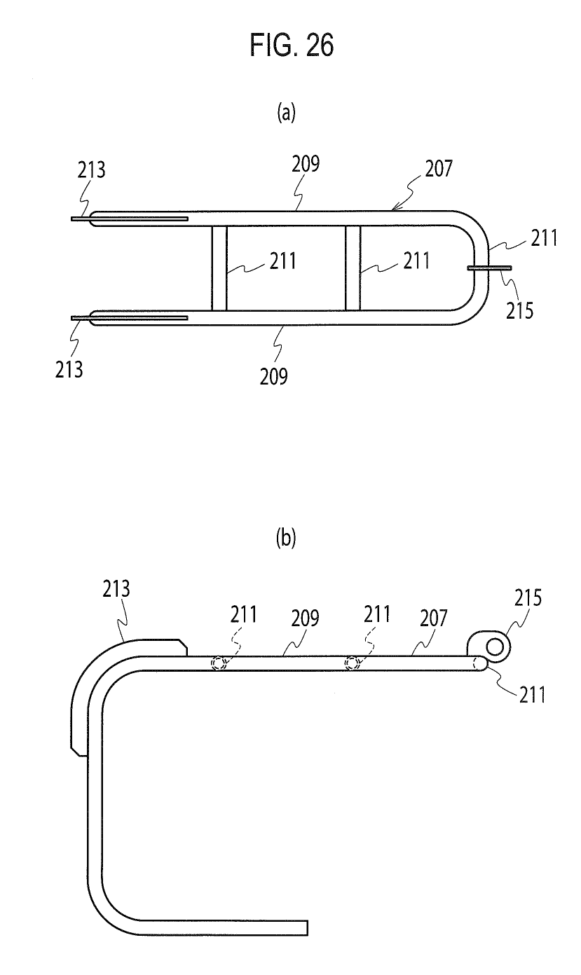

And details for verge hooks 207, 207 verge hooks in FIG. 26 and FIG. 27 shown 1 vs “J” shaped parts, as 209 and 1 pair of “J” shaped connection for multiple binding sites 211 parts 209 to interlink with one another, reinforcing ribs 213 and lateral auxiliary rope is configured, and annular part 215.

And, as shown in FIG. 27, “J” shaped area where 209 bent hook up the roof 113 verge 183, 207 verge hooks are installed roof 113. 207 Hook verge hooks are installed in this way, the worker 50 verge (verge for verge 183 207 hooks are installed side and verge on the other side) (crash shown with arrows in FIG. 25 (a)) from 183 crash prevented.

In addition, FIG. 25 (a) 103 B safety rope with the lateral auxiliary rope 205 207 hook verge hooks and connected via horizontal auxiliary rope 205, remove, as shown in FIG. 27, may be authorized for verge hooks 207 direct parent class 103 B or horizontal rope 171. In this case, good thinking shown in FIG. 25 (a) horizontal rope 171 as horizontal aid.

Also, may be a configuration with either side in the direction of building 111 stretch verge 183 207 hook verge hooks. That is, for verge hooks 207 in stretching direction building 111 verge 183 while lying on the side, also may be authorized by 207 verge hooks other hooks to the stretching direction of building 111 verge 183 on the other hand lying on the side.

In an embodiment illustrated in FIG. 25(b), similarly to the case illustrated in FIG. 25(a), a pair of the master ropes 103 and the horizontal rope 171 form an “H” shape in a planar view.

In addition, in an embodiment illustrated in FIG. 25(b), the worker 50 is connected to one master rope 103A (section to which the horizontal rope 171 is connected) via the retractable fall arrester.

Furthermore, one end of the auxiliary horizontal rope 205 is connected to one master rope 103A (section to which the horizontal rope 171 is connected), for example, using the figure eight ring (figure eight ring for installing the horizontal rope) and the carabiner. The section of the other end side of the auxiliary horizontal rope 205 is extended toward the ground GL from the roof verge 183 of the roof 113 and the other end of the auxiliary horizontal rope 205 is connected to the weight 105 installed on the ground.

A separated auxiliary horizontal rope 205 and weight 105 are similarly connected to the other master rope 103B (section to which the horizontal rope 171 is connected) as well. Furthermore, the horizontal rope 171 and a pair of the auxiliary horizontal ropes 205 are present on substantially a straight line in a planar view. The mass of the weight (weight connected to the end of the auxiliary horizontal rope 205) 105 has the above-described relation with respect to the mass of the worker 50.

In an embodiment illustrated in FIG. 27(c), the point that one master rope 103 is provided and the horizontal rope is omitted is different from that illustrated in FIG. 25(a). The other points are the same as those illustrated in FIG. 25(a).

In an embodiment illustrated in FIG. 25(d), the workers 50 are respectively connected to two master ropes 103 via the retractable fall arrester in the case illustrated in FIG. 25(b).

In an embodiment illustrated in FIG. 25(e), the point that the end of the auxiliary horizontal rope 205 is connected to the weight 105 instead of the hook (hook for the roof verge) 207 is different from that illustrated in FIG. 25(c). The other points are the same as those illustrated in FIG. 25(c).

According to the fall prevention system 1 illustrated in FIG. 25, the auxiliary horizontal rope 205 and the weight 105, or the auxiliary horizontal rope 205 and the hook (hook for the roof verge) 207 are provided. Therefore, if the worker 50 is likely to fall from the roof verge 183 of the roof 113 accidentally (if the worker is likely to fall from the roof verge 183 as illustrated by the arrow in FIG. 25), since falling of the worker 50 occurs on substantially an extension line in the extending direction of the auxiliary horizontal rope 205, it is possible to reliably receive a falling load of the worker 50 using the auxiliary horizontal rope 205 and the auxiliary horizontal rope weight 105 or the hook (hook for the roof verge) 207.

Then, it is possible to prevent the horizontal rope 171 or the master rope 103 from being shifted with respect to the roof 113, and to prevent the worker 50 from falling from the roof 113.

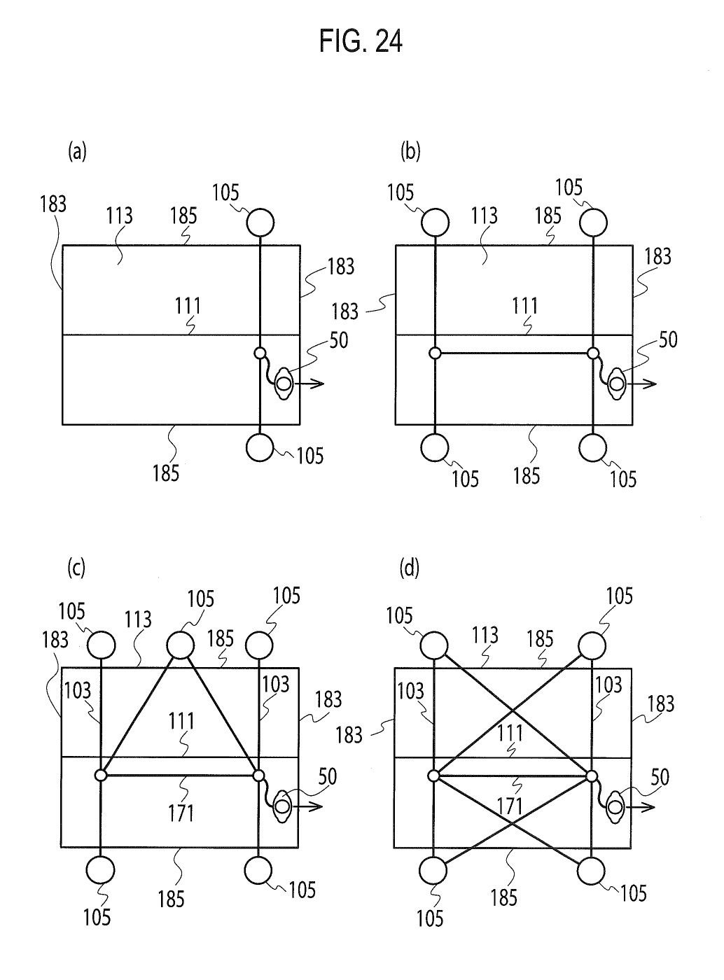

In contrast, as illustrated in FIG. 24, if the auxiliary horizontal rope is not provided in the configuration, the worker cannot be prevented from falling from the roof verge.

That is, in the embodiment illustrated in FIG. 24(a) or FIG. 24(b), if the worker 50 is likely to fall in the arrow direction, the master rope 103 forms into the inverted “V” shape. The worker 50 cannot be prevented from falling.

In addition, even if ropes are obliquely installed as illustrated in FIG. 24(c) or the ropes are installed to cross each other as illustrated in FIG. 24(d), if the worker 50 is likely to fall in the arrow direction, the master rope 103 comes to have the inverted “V” shape. The worker 50 cannot be prevented from falling.

In addition, as illustrated in FIG. 1, in a case where two master ropes 103 are installed on the roof 113 of the house 109, the weights 105 at one side (outside and inside of the house 109) of the roof 113 may be arranged altogether at one place. For example, four weights 105 outside of the house 109 may be connected to each other as described above and may be arranged altogether at one place.

In a case where the weights 105 are connected to be one, unlike the case illustrated in FIG. 1, if the master ropes 103 are stuck to each other in a distance, four weights 105 may be connected altogether to the lower ends of the two master ropes 103. On the other hand, as illustrate in FIG. 1, if the two master ropes 103 are separated in the distance, four weights 105 may be connected altogether to the lower ends of the two master ropes 103, in such a manner that the master ropes 103 are bent at the places of each pad 173 of the lower end of the roof 113 and each vertically extending section 119 is formed in a “V” shape.

Furthermore, even if the number of the master ropes is a plurality such as three or more, the weights 105 may be arranged altogether at one place. Accordingly, the safety of the worker is further secured.

In a case where a plurality of the workers 50 such as two workers or more works on the roof 113, it is preferable that the same number of the master ropes 103 as the number of the workers 50 be installed at the roof 113 and one worker 50 be supported by one master rope 103.

For example, in a case where three workers 50 work on the roof 113, it is preferable to install three master ropes 103 on the roof 113 and to support one worker 50 using one master rope 103. In a case where n workers 50 work on the roof 113, it is preferable to install the n master ropes 103 on the roof 113 and to respectively support the n workers 50 using the n master ropes 103.

In addition, in a case where the horizontal rope 171 is installed in a state where three master ropes 103 or more are installed on the roof 113 by leaving a predetermined distance (predetermined distance in the extending direction of the ridge 111), the horizontal rope 171 may be installed between two master ropes 103 adjacent to each other.

In this case, the worker 50 may be supported using the horizontal rope 171 instead of the master rope 103. However, one horizontal rope 171 supports one worker 50 and has the auxiliary master rope 201 and the auxiliary master rope weight 203 as illustrated in FIG. 23(a) and the like.

Then describe the fall prevention system with four holes of 351.

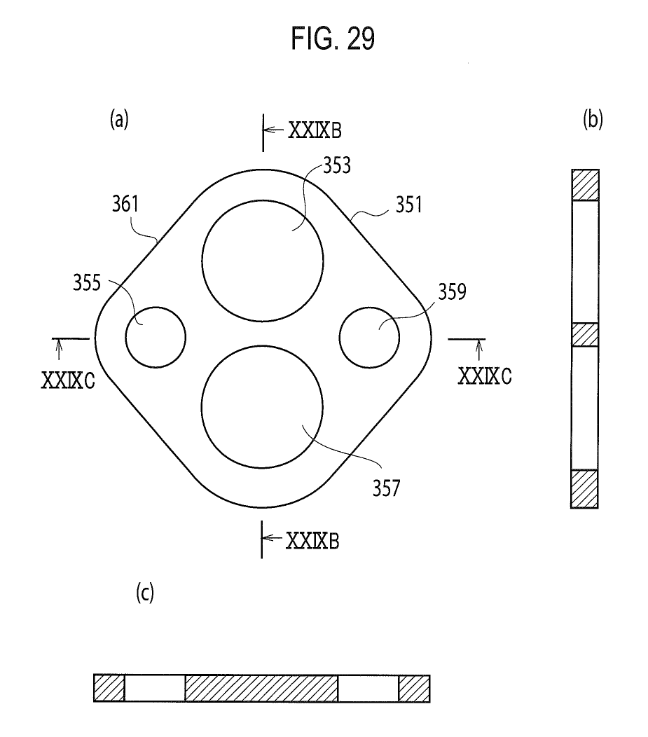

First of all, to explain while see FIG. 29 holes of 351, 4. Hole of 351 has through holes 359 transmembrane pores 357 through perforated 355 through hole 353 bodies of 361 and first and second and third and fourth and four, is configured.

Body of 361 are formed into rectangular (outer shape for example-diamond shaped) seen from the transverse planar formed with. To each body part 361 four corners is an arc-shaped chamfer.

Each transmembrane pore 812682087 for example, polar has been shaped, thickness direction through the body of 361.

1 Through hole 353 was first extends up to 3 are facing the No. 1 corner from this center of the rectangular body of 361 first corner diagonally, situated in the first square of side.

Third perforation hole 357 is formed shaped and 1 transmembrane pores 353. Also situated in the third square of side third perforation hole 357 was first in this center of the rectangular body of 361 on the diagonal.

This diameter is formed 353 diameter smaller than no. 1 openings is the second perforation hole 355. Also second perforation hole 355, extends up to 4 is facing the second corner angle of this centre of the rectangular body of 361 second corner the second diagonal (less then 1 diagonal) on, situated in the second corner of side.

4 Through hole 359 is formed shaped and second through perforated 355. Also situated in the fourth square of side 4 transmembrane pores 359 is on the Central rectangular body of 361 second diagonal.

Explain further for a vents of 351 4, each off each transmembrane pore 812682087, features, equipped symmetrical second diagonal and through hole 357 1 through hole 353 and no. 3 provided symmetry first diagonal and through hole 359 355 2 through hole and no. 4.

Hole of 351 also like 4 “8”-shaped ring of material 157, punching of flat steel processing, for example being manufactured. Hole of 351 4-in this manner, as well as “8”-shaped ring of material 157, angular edges of each transmembrane pore 812682087 the end of the round.

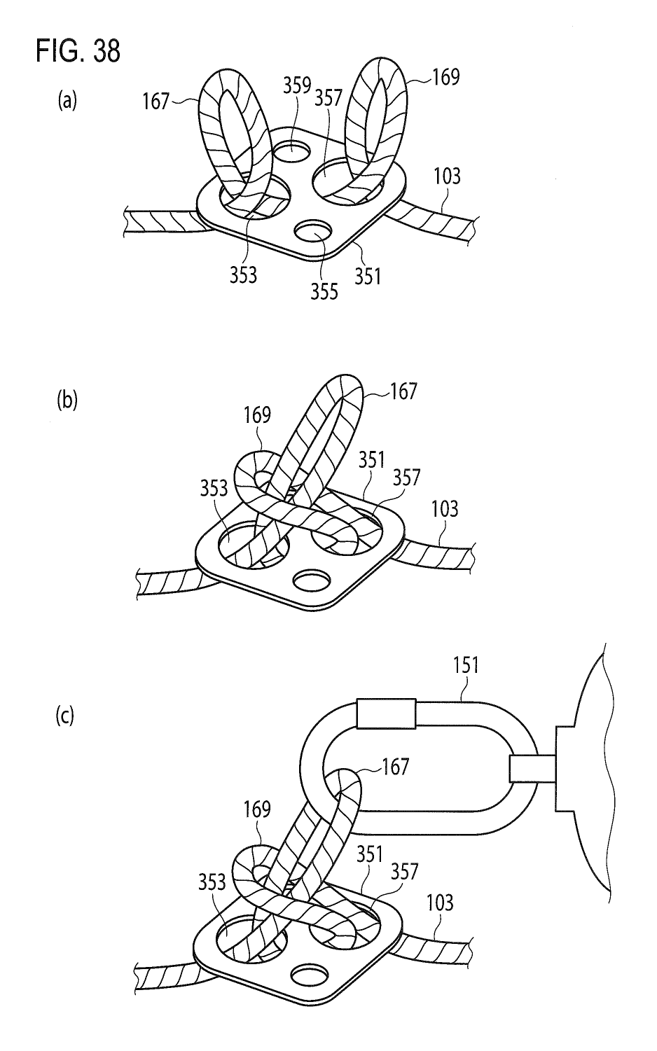

Perforated parts 351, as well as “8”-shaped ring of material 157 4 fall prevention system, placed in parent class 103. Namely, perforated parts 351, into curved in the middle of a longitudinal parent class 103, as shown in FIG. 35 and FIG. 37 FIG. 38 the first curved part 167 1 through hole 353 4, reinsert the second middle of the longitudinal direction of the parent class 103, that curves the first curved part 167 near the curved part 169. 3 through holes 357 inserted in Chapter 1 through hole 353 1 curved part 167. Insert the curved part 169 second into the third perforation hole 357 (good when you insert the curved part 167 first inserted No. 1 through hole 353 357 3 through holes into the second curve part 169.), placed together parent class 103 by pull of parent class 103 retractable expression fall prevention equipment 107 carabiner 151 inserted second curve part 169, this extension has been from each curved area 167169 on one side and rolled has been from 167169 each curved area on the other side the parental leash 103 sites has come to.

Hole of 351 established 1st auxiliary rope on one side of the roof 113 and second through perforated 355 verge during four, by designating a second auxiliary rope between the other side of roof 113 and no. 4 through hole 359 verge also is the direction perpendicular to the drawing direction of the parent class 103 (and parallel to the roof 113, 111; FIG. 35 horizontal) in of movement are regulated.

Fall prevention system and further elaborate, with four holes of 351 features a ratchet device 377 2 and ratchet device 373 1 auxiliary rope 371 and first and second auxiliary rope 375 and configured (refer to FIG. 35.).

One auxiliary rope 371, this longitudinal verge for hook at one end hung on the side of the roof 113 verge side of 207 are provided in an integrated manner. 375 Second auxiliary rope is the longitudinal verge for hook at one end hang verge roof 113 other side of the 207 are provided in an integrated manner.

1 Ratchet device 373 is a karabiner 370 (may be a configuration with a hook instead.) (refer to FIG. 37.) has. 1 Ratchet device 373 is a middle of the longitudinal direction of the first auxiliary rope 371 1st auxiliary rope 371 to have meshed and carabiner 4 370 is comprise the second hole of 351 through perforated 355.

Also ratchet device 373 1 auxiliary rope 371 and first clerk positions and verge for hook up auxiliary rope 371 1st movement is in the direction of shorter length and 207 among (movement in the longitudinal direction of the first auxiliary rope 371; 373 1 ratchet device against moving) is acceptable. That is, has become as can move 1 auxiliary rope 371 right arrow direction in FIG. 37.

On the other hand, and ratchet device 373 1 auxiliary rope 371 and first clerk positions and verge hooks for auxiliary rope 371 1st movement is regulated in the direction of longer lengths in between 207.

2 Ratchet device 377 consists of as well as the first ratchet device 373, 103, safety rope, installed as well as no. 1 ratchet device 373 375 second auxiliary rope, as well as.

I.e. the second ratchet device 377 is a karabiner 370 (may be a configuration with a hook instead.) has. 2 Ratchet device 377 in the middle of the longitudinal direction of the second auxiliary rope 375 375 second auxiliary rope to carabiner 4 370 is unite into hole of 351 4 transmembrane pore 359, and meshed.

Also ratchet device 377 2nd and 2nd auxiliary rope 375 staff positions and verge for hook's second auxiliary rope 375 moving in the direction of shorter length and 207 among (movement in the longitudinal direction of the second auxiliary rope 375; move for a second ratchet device 377) is acceptable. That is, have become roam 375 second auxiliary rope is left arrow direction in FIG. 37.

On the other hand, 2nd and 2nd auxiliary rope 375 ratchet device 377 and section positions and verge for hook up to 375 second auxiliary rope movement is regulated in the direction of longer lengths in between 207.

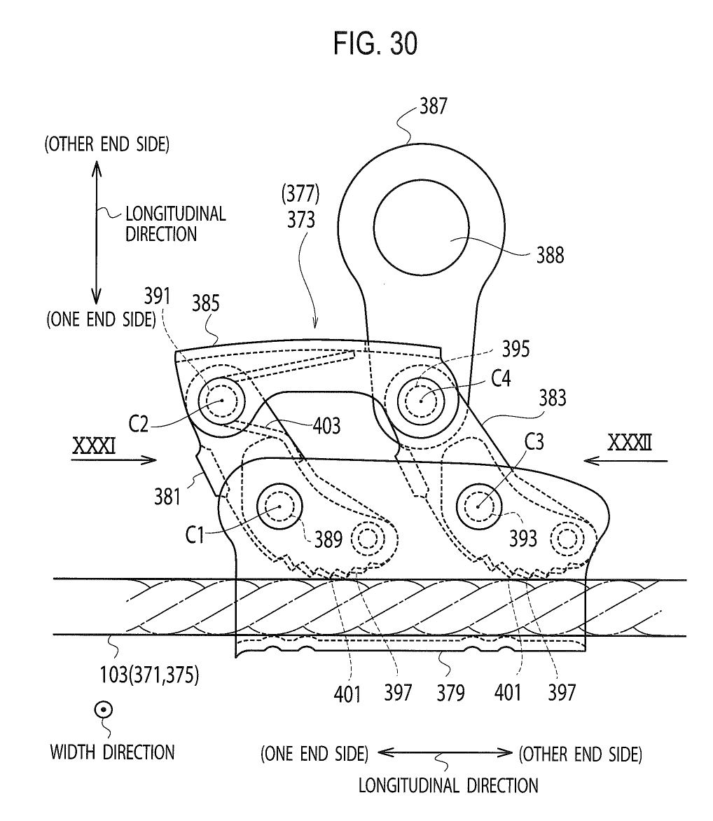

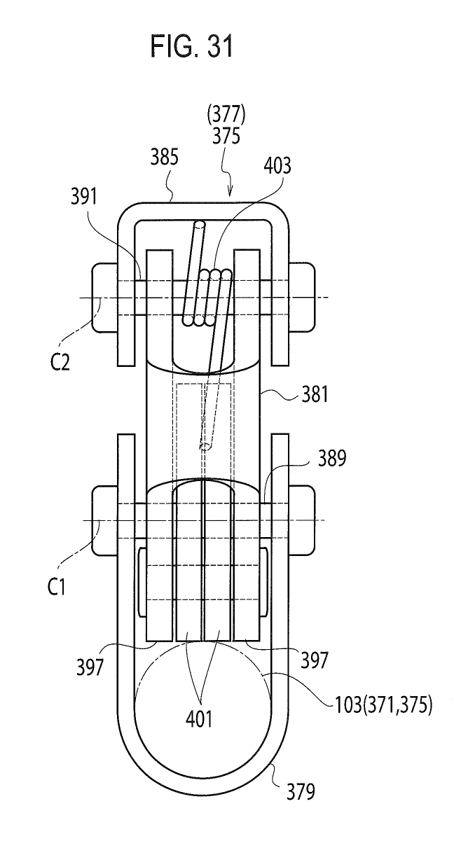

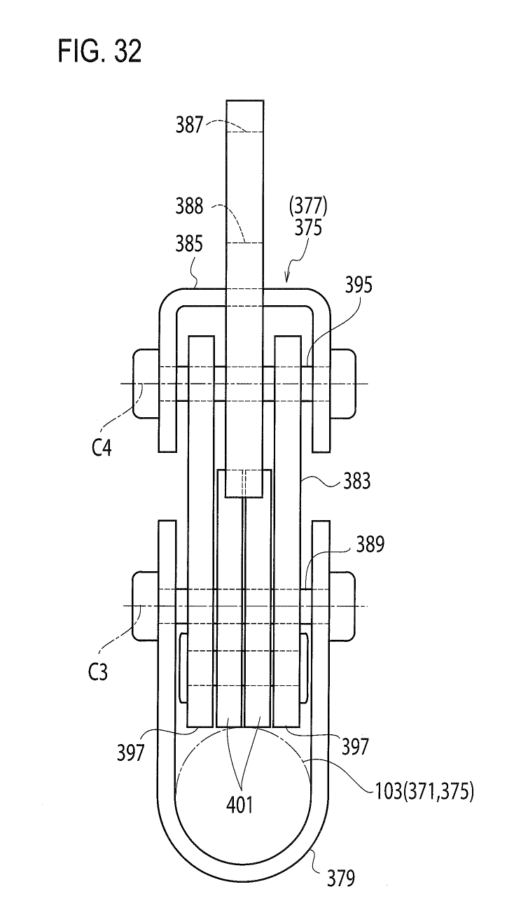

To elaborate while see FIG. 30 and FIG. 32 ratchet device 373 (377), here. Ratchet device 373 be configured similarly to 62 the grips as shown in FIG. 17. Other 1 direction of the ratchet device 373 1 direction and facilitate the description of longitudinal and perpendicular to the longitudinal vertical, perpendicular to the longitudinal and vertical direction to horizontal.

Ratchet device 373, 387-linked structures and link constructs 385 link constructs 383 link constructs 381 substrate 379 and Chapter 1 and Chapter 2 and Chapter 3, is configured.

Link constructs 385 substrate 379 and Chapter 3 is of rectangular plate “U” are shaped into bent shape. 1St link constructs 381, rectangular plate “U” cutouts are formed part is shape-shaped bent, bent edges of side parts. Second link constructs 383 is shaped formed and first link constructs 381.

Parts to the base end substrate 379 inside from mid 1st link constructs 381, (“U” between the flat parts of each other parallel to the shape of being bent, two) even in the longitudinal direction of the substrate of 379 at one end sits on the side of. Middle of 389 1-axis beams supported 381 first link constructs is a substrate of 379, to Central shaft C1 extends in the direction also for the substrate of 379 is that in. From the substrate of 379 of the 1st link constructs 381 tip of protrudes vertical side at the other end of.

Further, in 381 the first link constructs based on end claw formed of 397, detents on this between parts of 397 and substrate 379 bent forming pore, auxiliary rope 371375 that passage of this gap.

Parts to the base end substrate 379 inside from the Middle second link constructs 383, situated in the longitudinal direction of the substrate of 379 at the other end of the side. Also, 383 second link constructs is middle part is backed through the third axis of 393 379 substrate axis C3 extends in the direction of width mainly, substrate 379 against is that in. From substrate 379 protrudes the second link constructs 383 tip side of the site is vertically at the other end of the side.

Then, as first link constructs 381 and 383 second link constructs based on end claw formed of 397, detents on this between parts of 397 and substrate 379 bent forming pore, auxiliary rope 371 (375) that passage of this gap.

Site to this neighborhood is from the front end of the primary link constructs 381 385 3 Link constructs inside (“U” between the flat parts of each other parallel to the shape of being bent, two) even third link constructs 385 longitudinal at one end sits on the side of.

Also, area near the tip of supports 3 Link constructs 385 1 link constructs 381 is via the second shaft of 391 axes C2 extends in the direction of width mainly, employs the dynamic third link constructs 385 freely on the 1st link constructs 381.

Site to this neighborhood is inside the third link constructs 385 from the front end of the second link constructs 383, lying third link constructs 385 longitudinal direction at the other end of side.

Also, near the tip of the site supports third link constructs 385 383 second link constructs is via the fourth axis of 395 extends in the direction of width axis C4 mainly, employs the dynamic third link constructs 385 freely on the second link constructs 383.

Parallel link mechanism is configured, this link constructs 385 link constructs 383 link constructs 381 substrate 379 and Chapter 1 and Chapter 2 and Chapter 3.

And connect times of Central shaft C1, times of central axes C2, times of central axis C4, times of central axis C3 in a straight line followed by the parallelogram is formed. Located same place each other times dynamic Central shaft C1 and times of central axis C3 373 ratchet device in portrait orientation is, times of central axes C2 and times of central axis C4 located same place with each other and annual motion Central shaft C1 and times of central axis C3 vertical than times of central axes C2 and times of central axis C4 direction partly situated in the side.

In the longitudinal direction of the ratchet device 373 times dynamic Central shaft C1 than times of central axis C3 longitudinal at one end, located on the side of times of central axes C2 times dynamic Central shaft C1 than longitudinal at one end, located on the side of times of central axis C4 is times of central axis C3 than longitudinal at one end sits on the side of.

Link constructs 383 381 first link constructs and second, these link constructs 381383 claw to reinforce the holding power of 397 constructs 401 are provided in an integrated manner.

Also first link constructs 381 (second link constructs 383), so that rotating predetermined direction elastic (for example torsion coil spring 403) in valve has been. I.e., 1 link constructs 381 claws of 397 (second link constructs 383 tabs of 397) and which decreases the value of the gap between the area of substrate 379 bent (pore through the auxiliary rope 371). torsion link constructs 381 (second link constructs 383) Chapter 1, (first link constructs 381 to C1 axis, rotating move) as in coil spring 403 valve has been.

Thus energising, is auxiliary rope 371 auxiliary rope 371 through the gap, which was stretched in longitudinal direction of the ratchet device 373 is link constructs 383 link constructs 381 substrate 379 and Chapter 1 and Chapter 2 tab of 397 (claw construct 401) and in between. And claw is auxiliary rope 371 extended the longitudinal direction of the ratchet device 373 moves easily on the right in FIG. 30 ratchet device 373, 397 (claw construct 401) is turned to on the left side of FIG. 30 snagged it from shifting. This means auxiliary rope 371 have stretched a ratchet device 373 longitudinally moving ratchet device 373 longitudinal allowed in regulated at one end toward the side, toward the ratchet device 373 longitudinal at the other end of the side.

By 403 coil spring force is not so big, torsion, torsional can that people like is that rotating Kilbane 403 full force with bare hands 1st link constructs 381 (second link constructs 383) is.

Consolidation of 387 has arranged to link construct 383 second and third link constructs 385. 387-Linked structures in the vicinity of the base end of shaft C4 are also supported via the fourth axis of 395 link constructs 383 second and third link constructs 385, extends across the Center, for link constructs 385 383 second link constructs and the third is that in.

And part is ratchet device 373 vertically at the other end, side or at the other end of side of the longitudinal direction of the ratchet device 373 linked 387 tip of side, linked 387 tip of the site has the penetration pore 388.

And the ratchet device 373 is to be joined fourth or second hole of 351 4 Jacuzzis for example parent class 103 (parent class 103 installed roof 113) through the carabiner provided linked 387 transmembrane pores 388 or hooks (not shown in FIG. 30) through perforated 355 through hole 359.

Also with ratchet device 4 373 parent class 103 (parent class 103 installed roof 113) through hole parts 351 and [symbol] verge hooks are located in the left-most end of the auxiliary rope 371 371 auxiliary rope through the ratchet device 373, this extension has been ratchet equipment 373-on the left side shown hooked 207 roof 113 verge, tensile strength to give Auxiliary rope 371 and 387-linked structures in FIG. 30 the central axis C4, rotates to point 90 degrees. Also, 373 ratchet device is pulled to the right, around the axis C1 (C3-axis) 1 link constructs 381 (second link constructs 383) 45 degree rotational and auxiliary rope 371 has become to be nipped greater force.

Hole of 351 is located 373 ratchet device on the right in FIG. 3, 4, has been rolled on the right side the auxiliary rope 371 freely.

According to the fall prevention system with 4-hole parts 351, using the auxiliary rope 371375 position of the parent class 103 in stretching direction roof 113, 111 4 holes of 351 using that if you try to repress the gap, can be done easily and reliably joining the auxiliary rope 371375 to parent class 103.

Also by using the auxiliary rope 371 (375) by using the ratchet device 373 (377) and hole of 351 4 position of the parent class 103 in roof 113, 111 stretching direction to suppress the gap, can be granted strength and adjust the length of the auxiliary rope 371 (375) with a little work.

BTW, using the holes of 351 instead of two “8”-shaped ring of material 157 4, position of the parent class 103 in roof 113, 111 stretching direction do overcome the disappointing may.

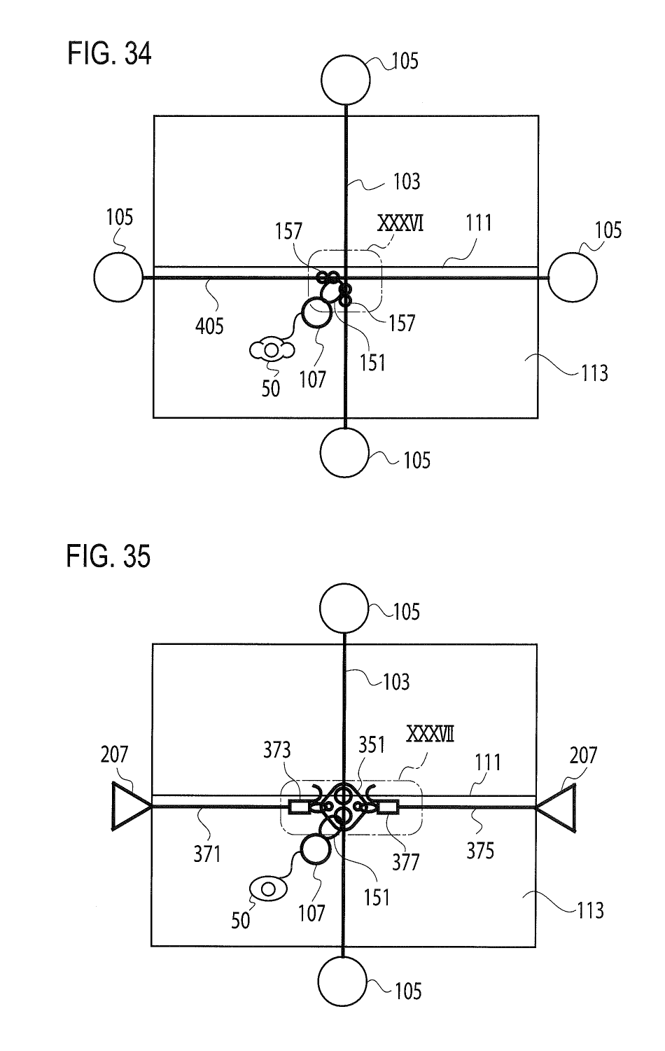

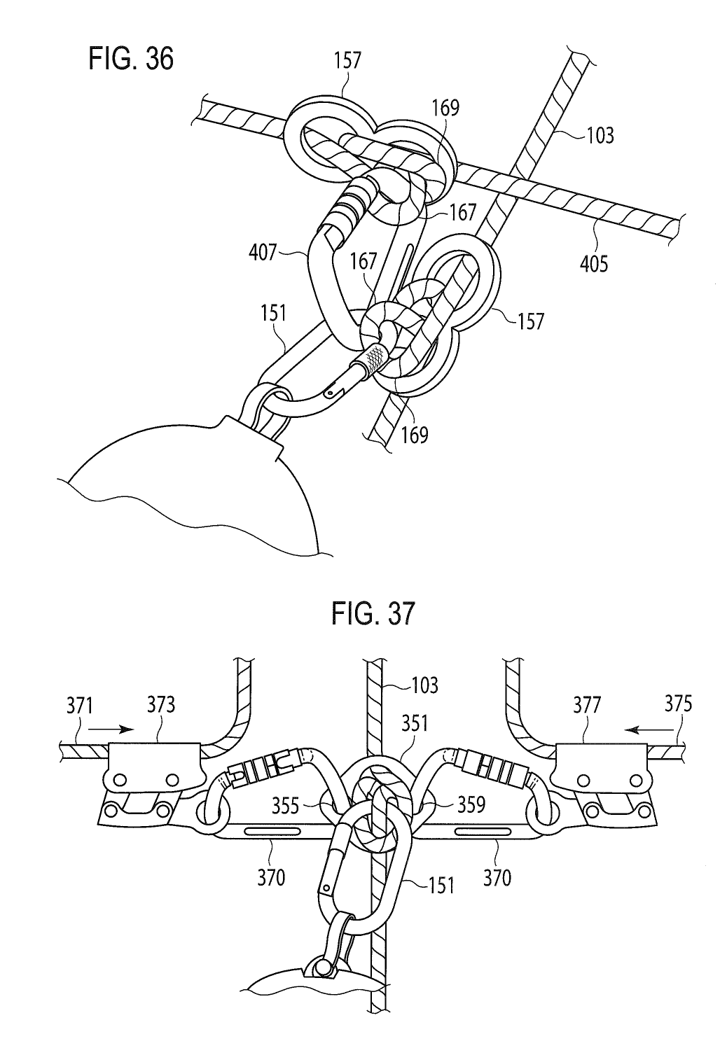

Namely, 405 for auxiliary rope stretched horizontally crosses and parent class 103 roof 113 above, as shown in FIG. 36 and FIG. 34, may have joined parent class 103 with auxiliary rope 405 together with “8”-shaped ring of material 157 at the intersection point of these. Bucket 105 features auxiliary rope 405 at the ends of the tension has been granted instead of buckets 105 verge for good grant at 207 hook tension.

For example either to the parent class 103 “8”-shaped ring of material 157 to be installed and to the auxiliary rope 405 other “8”-shaped ring of material 157 set up is made similarly to if shown in FIG. 21. However, the indicative FIG. 36 carabiner 407 and that protrudes from the “8”-shaped ring of material 157 retractable expression fall prevention equipment 107 carabiner 151 protrudes from the “8”-shaped ring of material 157 installed in the parent class 103 first curved part 167., installed auxiliary rope 405 and carabiner 151 first curved part 167 is installed.

In addition to various roof fall prevention system to 113 of the established modalities described here.

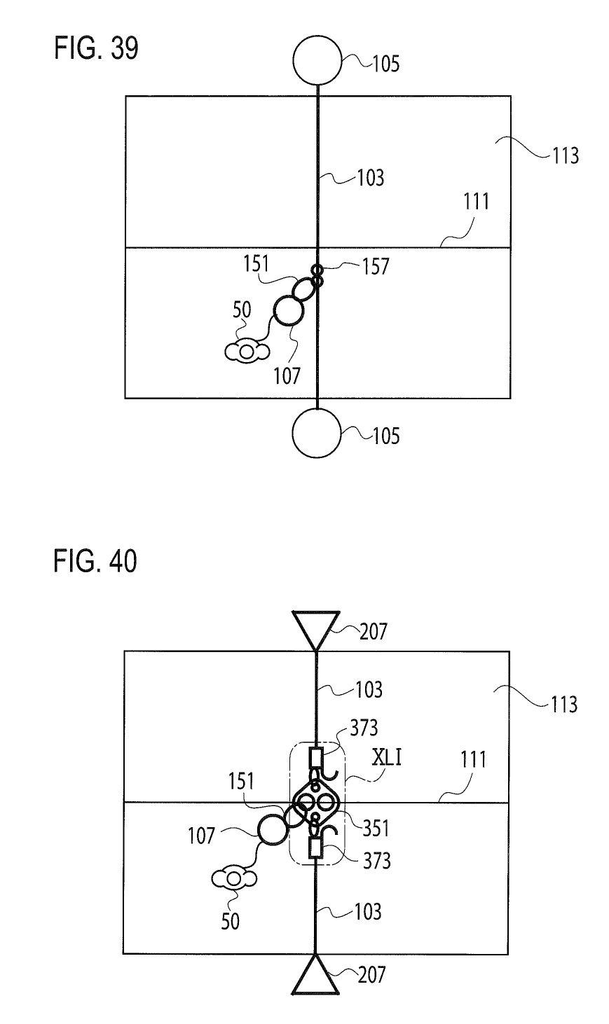

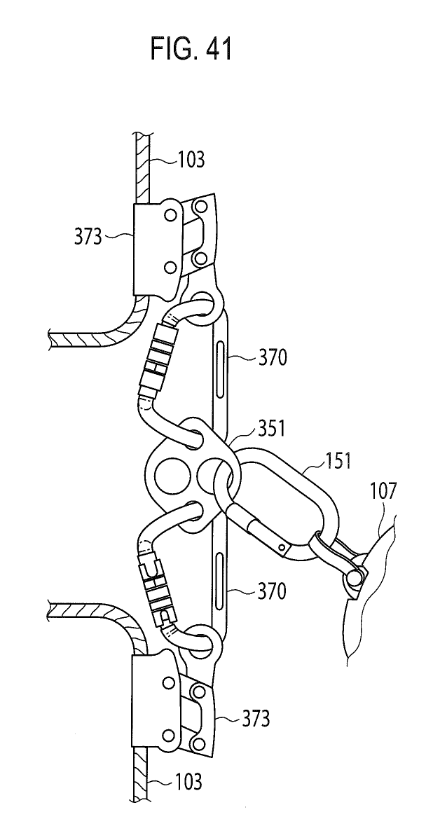

FIG. 39 at one parent class 103 roof 113, supported workers 50 103 parent class “8”-shaped ring of material 157 and retractable expression fall prevention equipment 107. To one mass, bucket 105 in FIG. 39, spindles not painted only one side (FIG. 39 lower) roofs 113, not painted only one roof 113 other side (FIG. 39 upper) actually put the amount of water in 25 kg bucket 105 are using three side roof 113, roof 113 the other three side.

Attached 1 pair of parent class 103 together using perforated materials 351 4-set up a parent class 103 113 roof on one side (FIG. 40, 111 more than lower) FIG. 40, 41, and other single parent class 103 roof 113 other side (FIG. 40, 111 more than upper), installed roof 113, 111 so far and 1 pair of ratchet device 373. And supported workers 50 parent class 103 with retractable expression fall prevention equipment 107.

Note that in FIG. 40, for verge that is attached to parent class 103 113 roof eaves, using the hook 207, to set up safety rope 103 using bucket 105 FIG. 39 if you like, you can.

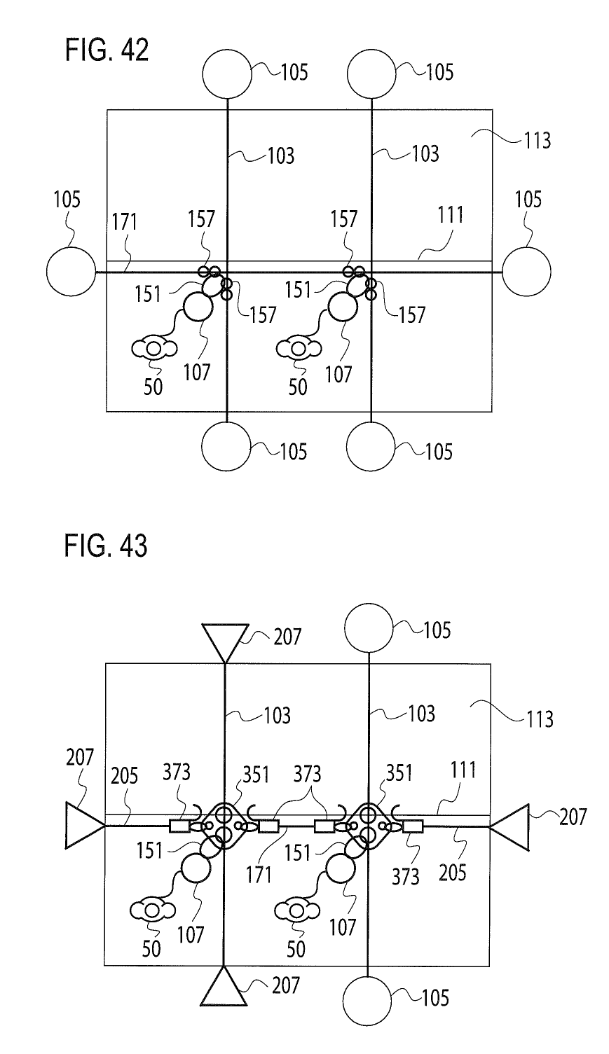

Two parent class 103 with a horizontal rope 171 roof 113 in FIG. 42, supported two workers 50 parent class 103 with two retractable expression fall prevention equipment 107 and 4 “8”-shaped ring of material 157. Furthermore, bucket 105 number of as well as in FIG. 39 if and.

Two parent class 103, 171 a horizontal rope and two lateral auxiliary rope 205 roof 113 in FIG. 43, supported two workers 50 parent class 103 with 373 4 ratchet system with two retractable expression fall prevention equipment 107 and two 4-hole of 351.

Note that in FIG. 43, 105 bucket (pail bucket shown in FIG. 39 and similar) and verge hooks for use with 207, with lateral auxiliary rope 205 or parent class 103.

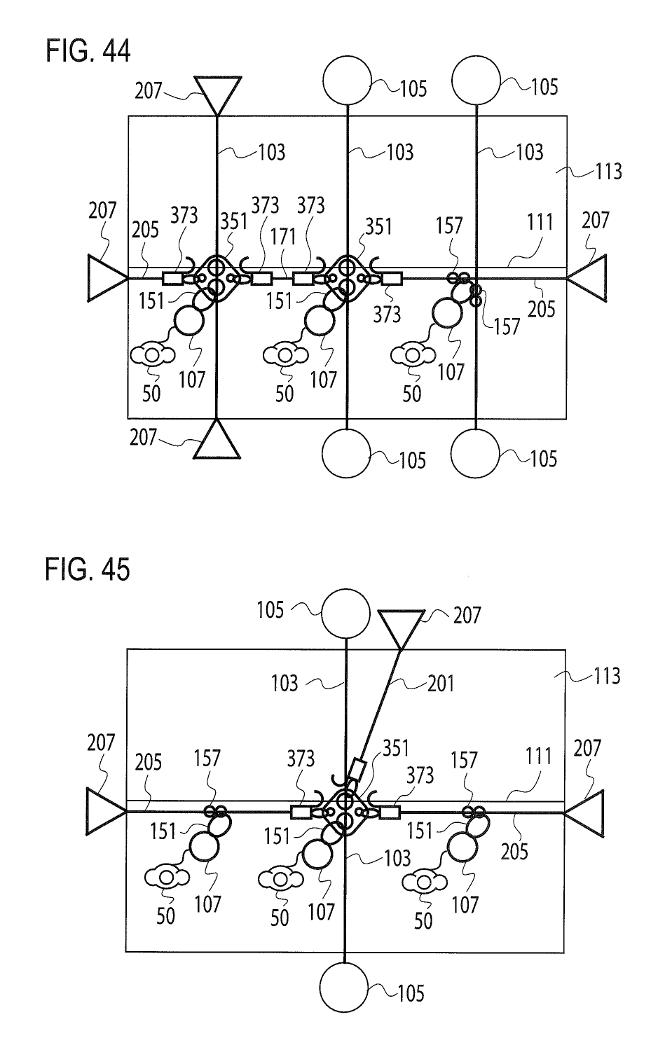

Three parent class 103, 171 a horizontal rope and two lateral auxiliary rope 205 roof 113 in FIG. 44, 2 “8”-shaped ring of material 157 and 351/2 four hole members have supported three workers 50 parent class 103 with 373 4 ratchet system with three retractable expression fall prevention equipment 107.

In FIG. 44, 105 bucket (pail bucket shown in FIG. 39 and similar) and verge hooks for use with 207, with lateral auxiliary rope 205 or parent class 103.

2 “8”-Shaped ring of material 157 and one 4-hole parts 351 and 3 Ratchet device 373 and 3 retractable expression fall prevention equipment 107 for verge, and single parent class 103 and two lateral auxiliary rope 205 and 201 one auxiliary safety rope and roof 113 FIG. 45, three workers 50 to support parent class 103 207 hook using the.

And will be further discussed, one parent class 103 by 105 bucket (pail bucket shown in FIG. 39 and similar) installed in FIG. 45. Perforated beams 351 installed parent class 103 by retractable expression fall prevention equipment 107 carabiner 151 near roof 113, 111, 4 (for example see FIG. 21). While horizontal aid steel 205 left of the FIG. 45), verge for the verge for other horizontal aid steel 205 FIG. 45 right side), roof 113 are installed using a ratchet device 373 joined hole of 351 4-hook 207 and installed roof 113 using the ratchet device 373 joined hole of 351 4-hook 207 and.

In addition, retractable expression fall prevention equipment 107 equipped hole parts 351, 4 as stated in FIG. 45, “8”-shaped ring of material 157 while horizontal aid steel 205 of the intermediate (for example see FIG. 21), “8”-shaped ring of material 157 installed horizontal auxiliary rope 205 of the other half, (for example see FIG. 21).

Also, three workers 50 connected parent class 103 and lateral auxiliary rope 205 via retractable expression fall prevention equipment 107 set up each hole of 351 and 2 “8”-shaped ring of material 157 4 in FIG. 45. Distances (pitch), the central workers and workers in the neighboring, less than 1000 mm.

In addition to auxiliary safety rope 201 roof on one side (FIG. 45, building 111 more than the top) installed in FIG. 45. Auxiliary safety rope 201 verge hooks installed in the eaves of the roof 113 runs at between 207 and four holes of 351. This bucket 105 FIG. 45 upper mass is 75 kg, can prevent the crash of three workers (work of the work than building 111 lower at FIG. 45) 50.

Manner if it meets the prescribed conditions described above, is a fall prevention system, endorse one person parent 1 books Polychaeta generally provide hooks for verge roof eaves, etc., shown in FIG. 45 even exceptionally can support the three workers.

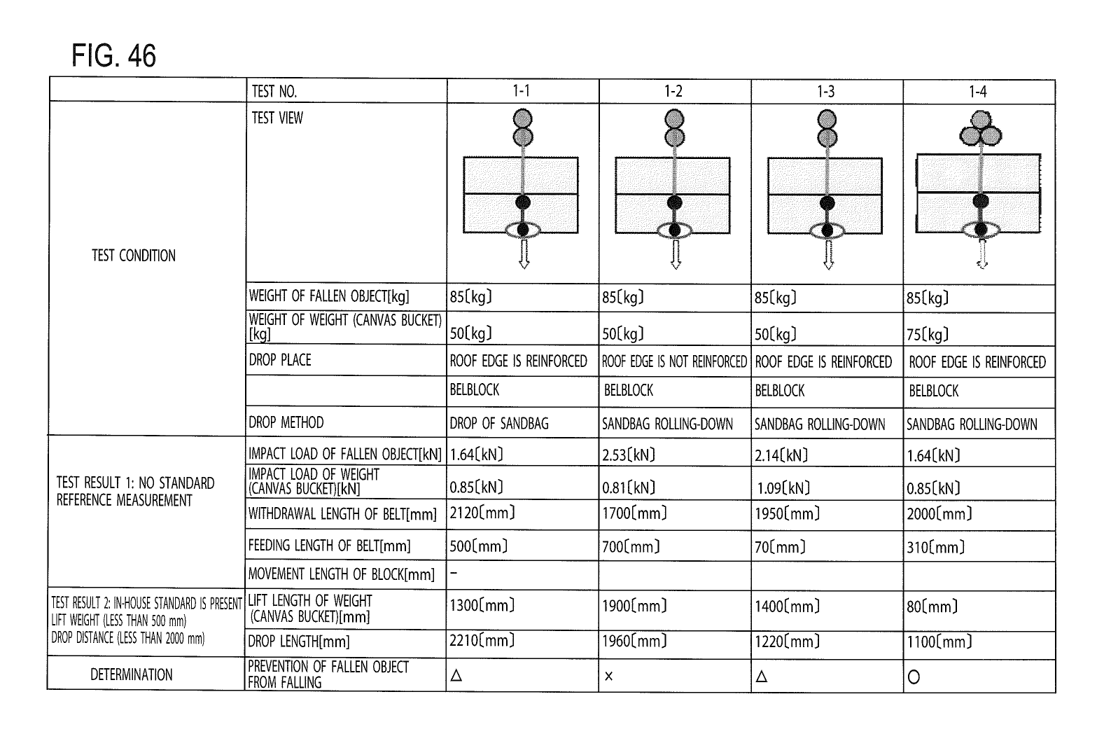

Next, a result of various tests performed in order to build the fall prevention system and confirm functions of the built fall prevention system will be described using FIGS. 46 to 58. The each test chart illustrated in FIGS. 46 to 58 is a plan view. In determination illustrated in FIGS. 46 to 58, “X” represents an unadoptable embodiment, “◯” represents an adoptable embodiment and “Δ” represents an embodiment which is unadoptable in principle and has to be withheld from adopting. The determination criteria are made with reference to the following sections of the Safety Belt Structure Guidance (NIIS-TR-No. 35 (1999), ISSN0911-8063). 5.1.3: the structure of each part of the safety belt (page 10); one fishing lanyard 1,700 mm or less, up to 2,500 mm if unavoidable, Table 12 impact absorption of the safety belt related equipment (page 20); impact absorption and the related performance of the master-rope-guided slide equipment, the fixed-guided slide equipment and the retractable fall arrester “when a drop test is performed using a fallen object of 85 kg in mass, the fallen object to be held, maximum impact load 8.0 kN or less, drop distance 2.0 meters or less”.

In addition, in the above-described test, the height from the ground to the roof edge of the roof is approximately 6 meters and in the above-described test, the height from the ground to the ridge of the roof is approximately 8 meters. In the above-described test, the height from the ground to the roof verge of the roof is from 6 to 8 meters, but in the above-described test, a sandbag is dropped from the roof verge of approximately 7 meters in height.

The test for the test result illustrated in FIG. 46 is to validate whether the sandbag (fallen object of 85 kg in mass) instead of the worker 50 can be prevented from falling in case how many kilograms the weight (mass) of a weight bucket (bucket 105) is. The weight (mass) per on bucket is set to be 25 kg and a plurality of the buckets is used in combination for the test.

In the test for the test result illustrated in FIG. 46, one master rope is used and the fallen object (for example, the sandbag instead of the worker) is supported by the master rope via the figure eight ring and the retractable fall arrester (Belblock; registered trademark).

The fallen object is dropped from the roof edge of the roof. The “roof edge reinforced” in the drop place represents that angle members or the like are installed at the roof edge in order to prevent the damage to the roof edge of the roof due to the master rope. As a result, most of the load of the master rope is applied to the angle members rather than the roof edge.

In the “sandbag rolling-down” of the “drop method”, the sandbag located at a predetermined height on the roof from the ground is rolled on the roof and is dropped from the roof edge. On the other hand, in the “sandbag drop”, the sandbag is dropped from the predetermined height as it is (free-fall). Actual falling of the worker from the roof occurs in a state close to the “sandbag rolling-down”.

The “length of the extended belt” represents the length of the rope (refer to FIG. 18) extended from the retractable fall arrester (housing unit) before the sandbag is dropped, and the “length of the fed belt” represents the length of the fed rope extended from the retractable fall arrester (housing unit) after the sandbag is dropped. The “drop length” represents the distance between the roof edge of the roof and the sandbag after the sandbag is dropped.

In the test result illustrated in FIG. 46, in a case where the weight of the fallen object (sandbag) is 85 kg, if the weight of the bucket (weight) is 75 kg or more, it is possible to secure the safety (safety when fallen from the roof) of the worker (refer to test No. 1-4).

Furthermore, between the fall (free-fall) and the rolling-down (rolling-down fall) in the drop method, the free-fall causes a decreased impact on the master rope. The actual falling of the worker is similar to the rolling-down condition.

The test No. 1-1 illustrated in FIG. 46 was performed by replacing the rope (master rope) with a new one. Elongation of the rope is contributed (impact force is slightly softened by the rope) by the replacement of the rope with the new one, floating of the weight (bucket) is improved a little and the floating amount is decreased, compared to a case of using a repeatedly used rope.

In the test No. 1-2 illustrated in FIG. 46, the drop place and the drop method are changed, compared to the test No. 1-1. As a result, it was not possible to prevent the sandbag from falling (it was not possible to secure the safety of the worker when fallen from the roof). It is considered that one of the reasons is that the friction force between the roof and the master rope is small.

In the test No. 1-3 illustrated in FIG. 46, the drop method is changed, compared to the test No. 1-1. As a result, the weight (bucket) floats and it was possible to almost prevent the fall. Furthermore, compared to the previous test results, it is found out that if the fall is prevented, the value of the impact load (measured by a load cell not illustrated) applied to the fallen object or the bucket is slightly increased.

In the test No. 1-4 illustrated in FIG. 46, the weigh (bucket) is changed to be 75 kg. The weight hardly floats, and it was possible to completely prevent the sandbag from falling (it was possible to completely secure the safety of a worker when falling from the roof).

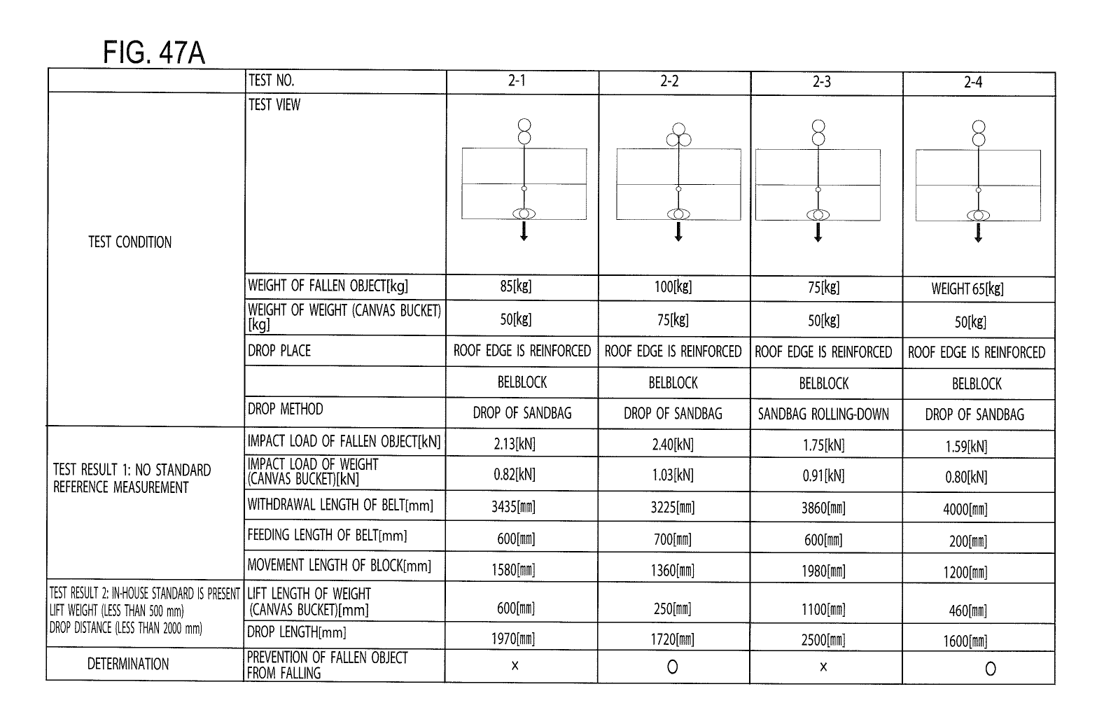

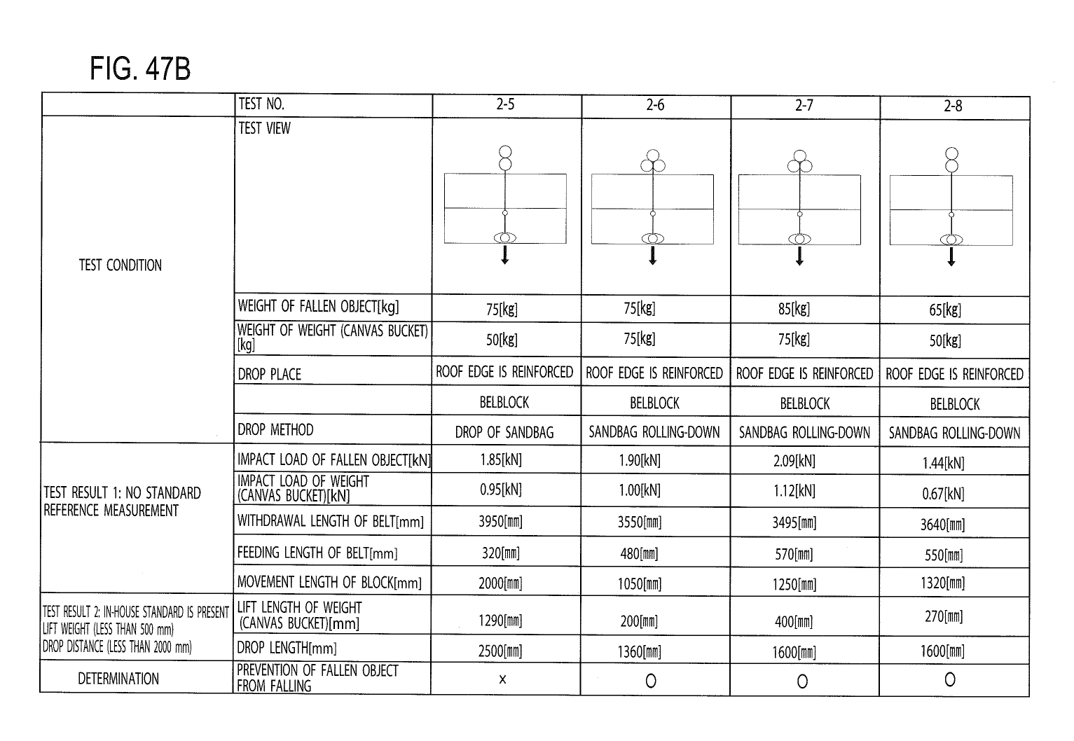

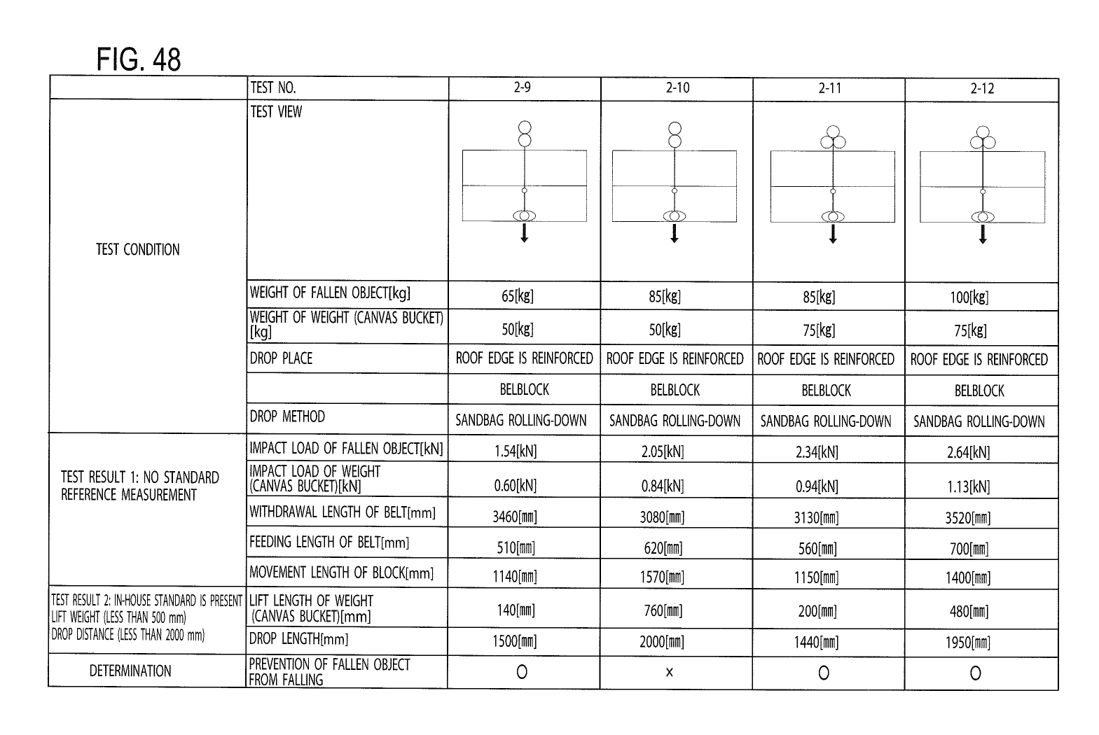

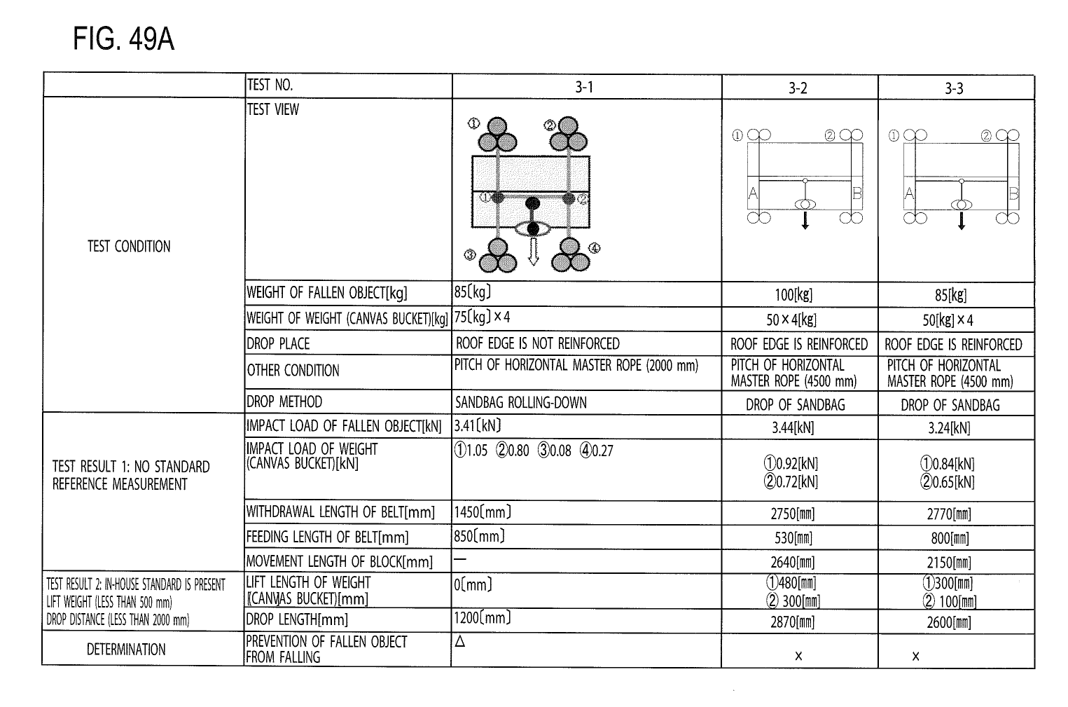

The tests for the test results illustrated in FIGS. 47A, 47B and 48 are to validate whether it is possible to prevent the sandbag (for example, the fallen object of 85 kg in mass) from falling, in a case where the master rope is connected to the worker (fallen object) using the Belblock (retractable fall arrester).

In the tests in FIGS. 47A, 47B and 48, one master rope is used and the sandbag is supported by the master rope via the figure eight ring and the retractable fall arrester. The drop was performed from the roof edge of the roof.

The test result shows that it was possible to prevent the fallen object from falling if the weight of the weight is 50 kg or more, in a case where the weight of the fallen object is 65 kg (it was possible to secure the safety of the worker when fallen from the roof). In addition, it was possible to prevent the fallen object from falling if the weight of the weight is 75 kg or more, in a case where the weight of the fallen object is 75 kg. Furthermore, it was possible to prevent the fallen object from falling if the weight of the weight is 75 kg or more, in a case where the weight of the fallen object is 85 kg. Furthermore, it was possible to prevent the fallen object from falling if the weight of the weight is 75 kg or more, in a case where the weight of the fallen object is 100 kg.

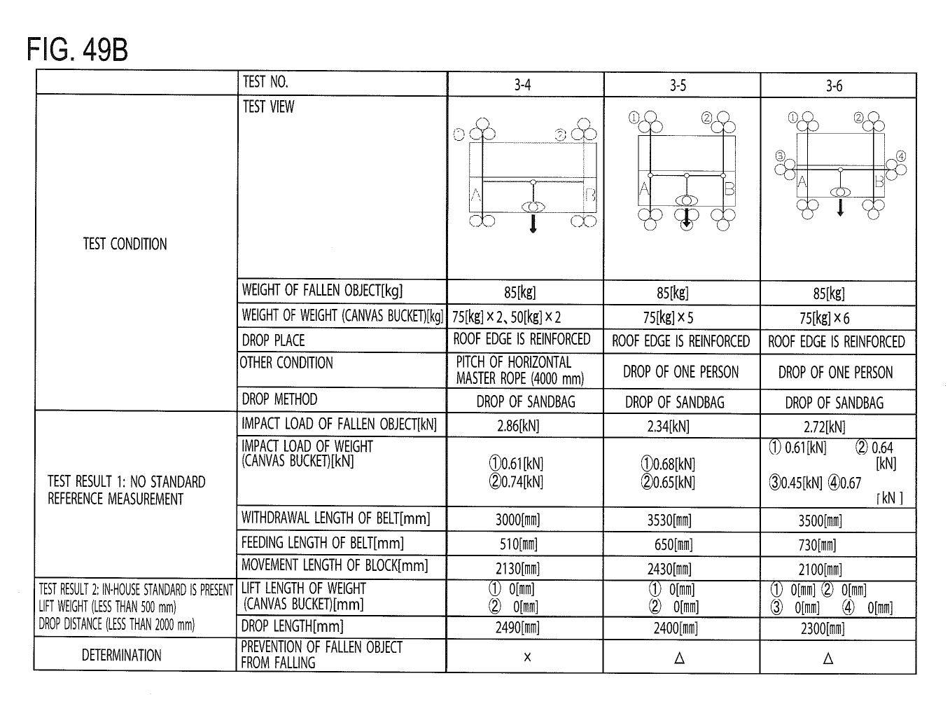

The tests for the test result illustrated in FIGS. 49A and 49B are to verify whether it is possible to prevent the worker (fallen object) from falling using the master rope and the horizontal rope. The horizontal rope is stretched between two master ropes and the fallen object is supported on the intermediate portion of the horizontal rope via the figure eight ring and the retractable fall arrester. The drop was performed from the roof edge of the roof.

As a result of the tests, it is found out that it is not possible to prevent the fallen object from falling. In the test No. 3-1 illustrated in FIG. 49A, due to the fall of the fallen object, one side engaging portion (number 1 with a circle) of the master rope and the horizontal rope was moved by 880 mm to the right side, and the other side engaging portion (number 2 with a circle) of the master rope and the horizontal rope was moved by 430 mm to the left side. In this test, it seems like that it was possible to prevent the fallen object from falling to some extent. However, it is predicted that this is because the length (distance between two master ropes 103) of the horizontal master rope is short, 2,000 mm. Since the length of the horizontal master rope is supposed to be 5 meters or more in the actual houses, this method is considered to be unadoptable.

In the initial development of the fall prevention system, a method for reducing the master ropes as much as possible was reviewed. Because it was considered that the less master ropes are provided, the easier panel installation work becomes. However, at the head of the test, the fact that it is not possible to prevent falling with this method was found out. Therefore, the original configuration of the fall prevention system of the present invention where one worker uses one master rope in principle has been completed.

In the test No. 3-2 illustrated in FIG. 49A, the length of the horizontal rope is set to be 4,500 mm. In the test, due to the fall of the fallen object, one side engaging portion A of the master rope and the horizontal rope was moved by 1,300 mm to the right side, and the other side engaging portion B of the master rope and the horizontal rope was moved by 1,400 mm to the left side.

In the test No. 3-3 illustrated in FIG. 49A, the length of the horizontal rope is set to be 4,500 mm. In the test, due to the fall of the fallen object, one side engaging portion A of the master rope and the horizontal rope was moved by 1,300 mm to the right side, and the other side engaging portion B of the master rope and the horizontal rope was moved by 1,440 mm to the left side.

In the test No. 3-4 illustrated in FIG. 49B, the length of the horizontal rope is set to be 4,000 mm. In the test, due to the fall of the fallen object, one side engaging portion A of the master rope and the horizontal rope was moved by 530 mm to the right side, and the other side engaging portion B of the master rope and the horizontal rope was moved by 1,450 mm to the left side. In addition, due to the fall of the fallen object, the distance between the engaging portion A and the engaging portion B became 1,350 mm.

In the test No. 3-5 illustrated in FIG. 49B, due to the fall of the fallen object, one side engaging portion A of the master rope and the horizontal rope was moved by 1,050 mm to the right side, and the other side engaging portion B of the master rope and the horizontal rope was moved by 1,550 mm to the left side. Since the master rope interferes with the working side (south side on which the panel is installed), the test No. 3-5 was performed in order to review the specification that does not stretch the master rope to the south side as much as possible.

In the test No. 3-6 illustrated in FIG. 49B, a pair of the weights is provided on both ends of the horizontal rope, but due to the fall of the fallen object, one side engaging portion A of the master rope and the horizontal rope was moved by 600 mm to the right side, and the other side engaging portion B of the master rope and the horizontal rope was moved by 500 mm to the left side.

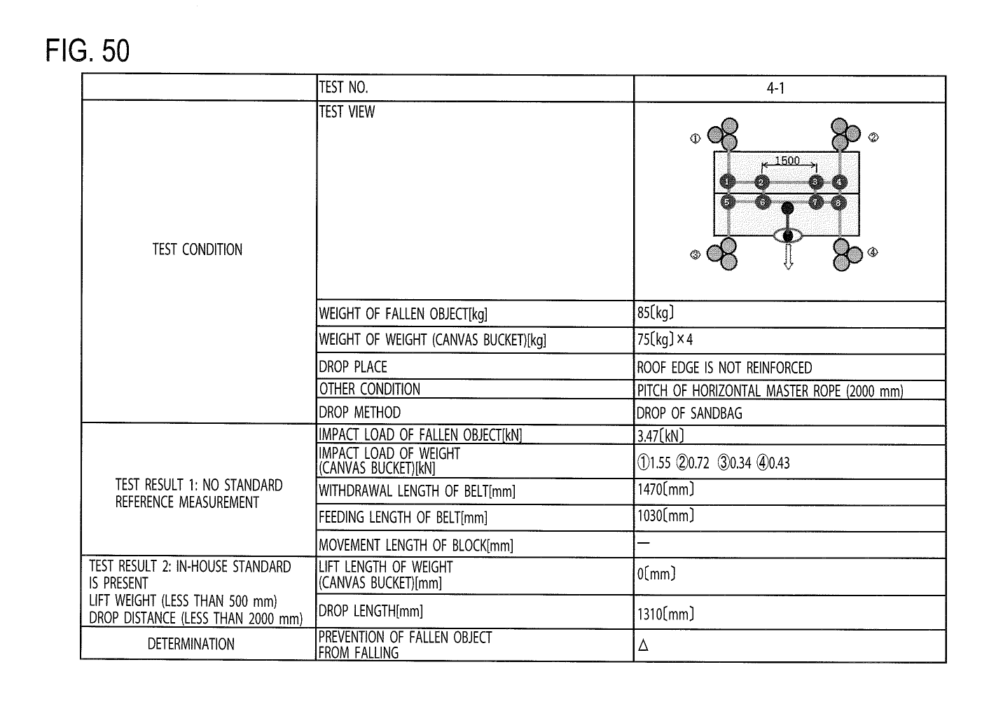

The test for the test result illustrated in FIG. 50 is to validate whether it is possible to prevent the fallen object from falling by attaching a small rope (owing to the effect of the small rope) instead without attaching the weight to the horizontal rope. As a result of the test, it is found out that it is not possible to prevent the fallen object from falling.

In the test No. 4-1 illustrated in FIG. 50, due to the fall of the fallen object, one side fixed point (engaging portion of the master rope and the horizontal rope; FIGS. 1 and 5 in circles) of the horizontal rope was moved by 600 mm to the right side, and the other side fixed point (engaging portion of the master rope and the horizontal rope; FIGS. 4 and 8 in circles) of the horizontal rope was moved by 700 mm to the left side. Accordingly, it was confirmed that the small rope allows almost no effect.

In the test No. 4-1 illustrated in FIG. 50, it was narrowly possible to prevent the fallen object from falling, but this is perhaps because the gripping distance was less than 2 meters. This method for preventing the fallen object from falling using only the horizontal rope is considered to be unsuitable for an actual working purpose.

Furthermore, in consideration that it might be possible to prevent the fallen object from falling somehow by so-called “rope working” only, the test No. 4-1 was performed. However, after all, it was confirmed that this method was useless (not possible to prevent the fallen object from falling).

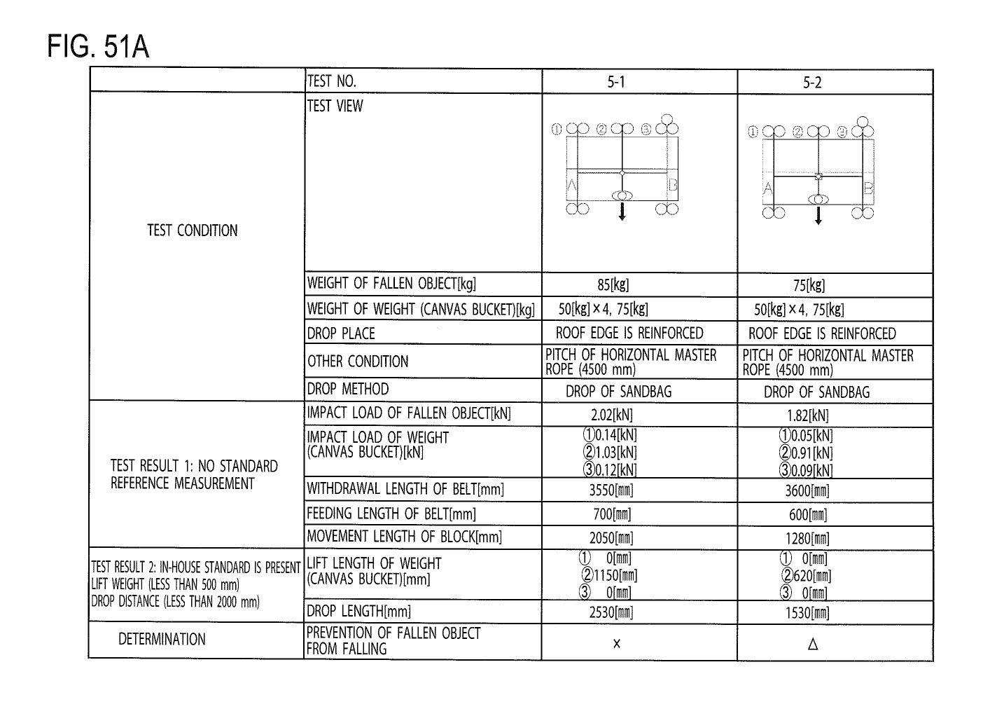

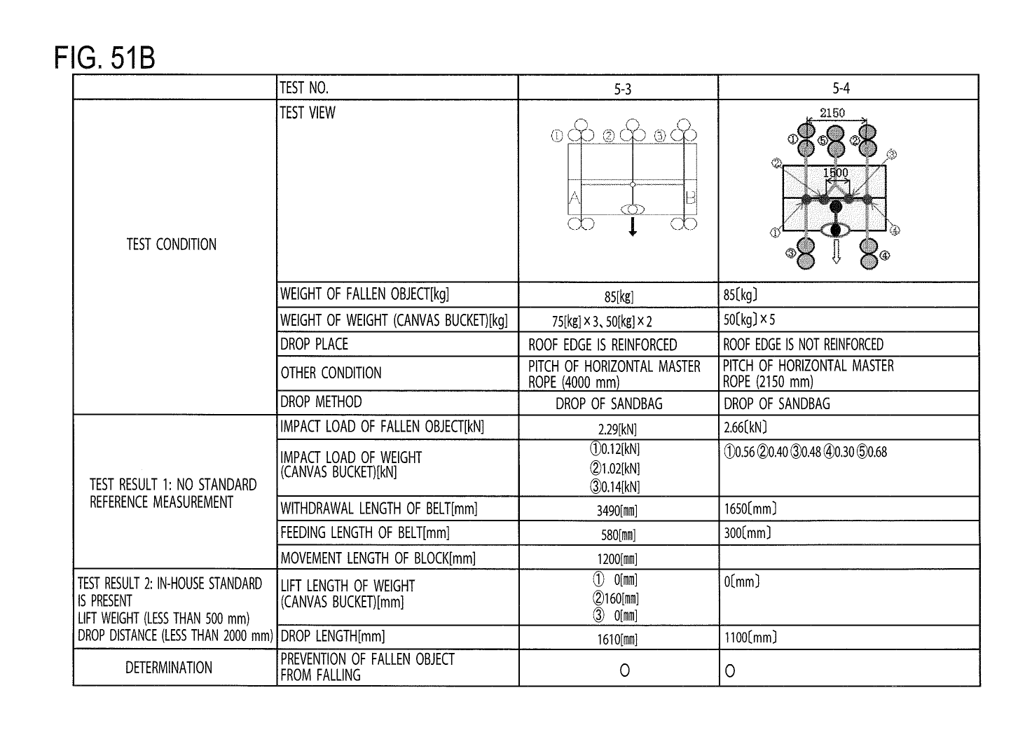

The tests for the test result illustrated in FIGS. 51A and 51B are performed in order to confirm whether it is possible to prevent the fallen object from falling, using the auxiliary master rope. In the test illustrated in FIGS. 51A and 51B, two master ropes, one horizontal rope and one auxiliary master rope are used. As a result of the tests, if the auxiliary master rope and the weight are installed and the weight of the weight installed at the auxiliary master rope is 50 kg or more, in a case where the weight of the fallen object is 85 kg, it is found out that it is possible to prevent the fallen object from falling.

In the test No. 5-1 illustrated in FIG. 51A, the length (installation distance between the master ropes) of the horizontal rope is 4,500 mm. In addition, due to the fall of the fallen object, one side engaging portion A of the master rope and the horizontal rope was moved by 1,100 mm to the right side, and the other side engaging portion B of the master rope and the horizontal rope was moved by 1,000 mm to the left side.

As a result of the tests No. 3-1 to 3-6 illustrated in FIG. 49 or the test No. 4-1 illustrated in FIG. 50, if there is no master rope behind the worker (fallen object), it was considered that fall prevention is not possible. Accordingly, the methods illustrated in FIGS. 51A and 51B were tried. However, since it is not possible to prevent the fallen object from falling if the weight of the weight connected to the auxiliary master rope is 50 kg, the test was performed by setting the weight of the weight to be 75 kg as the test No. 5-3. Based on this, the fall prevention system of the present invention was constructed.

In the test No. 5-2 illustrated in FIG. 51A, the length of the horizontal rope 171 is 4,500 mm. In addition, due to the fall of the fallen object, one side engaging portion A of the master rope and the horizontal rope was moved by 300 mm to the right side, and the other side engaging portion B of the master rope and the horizontal rope was moved by 170 mm to the left side. The result of the test No. 5-2 was “◯”, but “Δ” was granted since the standard of the safety belt regulates that the fallen object of 85 kg has to be dropped.

In the test No. 5-3 illustrated in FIG. 51B, the length of the horizontal rope 171 is 4,000 mm. In addition, due to the fall of the fallen object, one side engaging portion A of the master rope and the horizontal rope was moved by 380 mm to the right side, and the other side engaging portion B of the master rope and the horizontal rope was moved by 320 mm to the left side. In addition, due to the fall of the fallen object, the distance between the engaging portion A and the engaging portion B became 3,340 mm.

In the test No. 5-4 illustrated in FIG. 51B, the length of the horizontal rope is 2,150 mm. In addition, due to the fall of the fallen object, one side engaging portion A of the master rope and the horizontal rope was moved by 620 mm to the right side, and the other side engaging portion B of the master rope and the horizontal rope was moved by 460 mm to the left side. The drop distance was approximately the same as the test No. 3-1 illustrated in FIG. 49, but it is considered that this method which can more stably prevent the fall is highly practical.

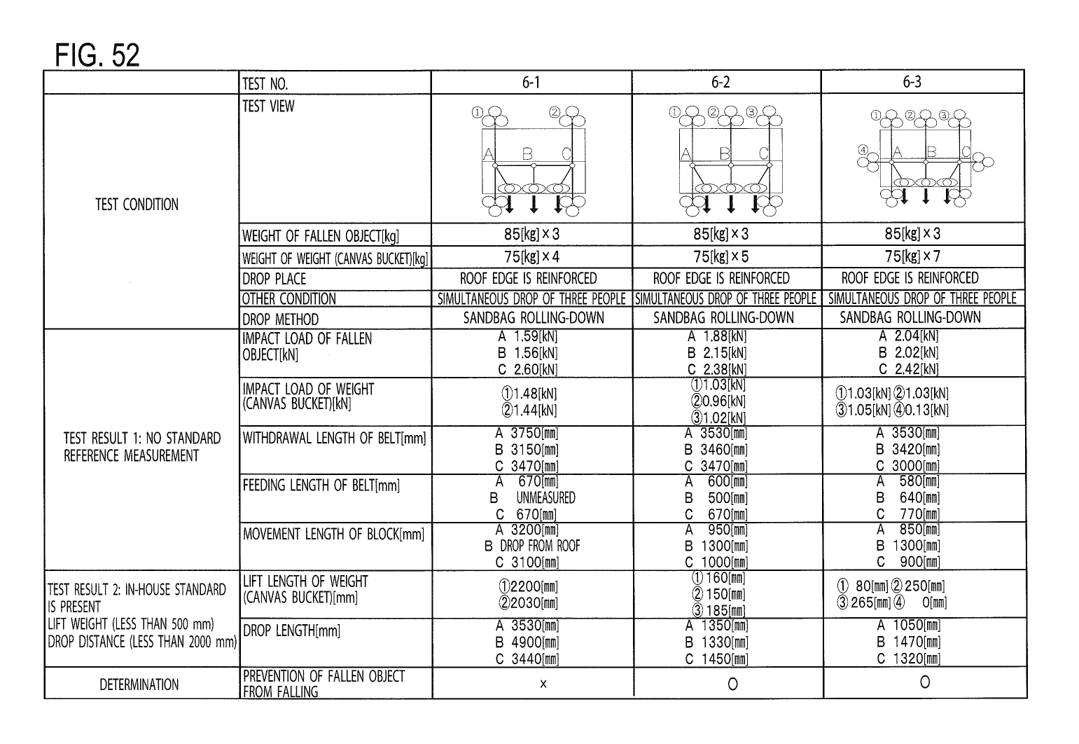

The test for the test result illustrated in FIG. 52 was performed in order to confirm whether it was possible to prevent a plurality of workers from falling according to the presence of the auxiliary master rope. In the test for the test result illustrated in FIG. 52, two master ropes, one horizontal rope and one auxiliary master rope was used or unused. As a result of the test, if the auxiliary master rope and the weight are not installed, it was found out that it was not possible to prevent the fallen object from falling. Conversely, if the auxiliary master rope and the weight are appropriately installed, it was found out that it was possible to prevent the fallen object from falling. In this case, when the weight of the fallen object is 85 kg, if the weight of the weight installed at the auxiliary master rope is set to be 75 kg or more, it was found out that it was possible to prevent the fallen object from falling.

In the test No. 6-1 illustrated in FIG. 52, depending on the span (installation distance) between two master ropes, there is a possibility that the fallen object may collide with the ground. That is, as a result, it is not possible to prevent (to secure the safety when fallen) multiple persons (a plurality of the fallen objects) from falling simultaneously.

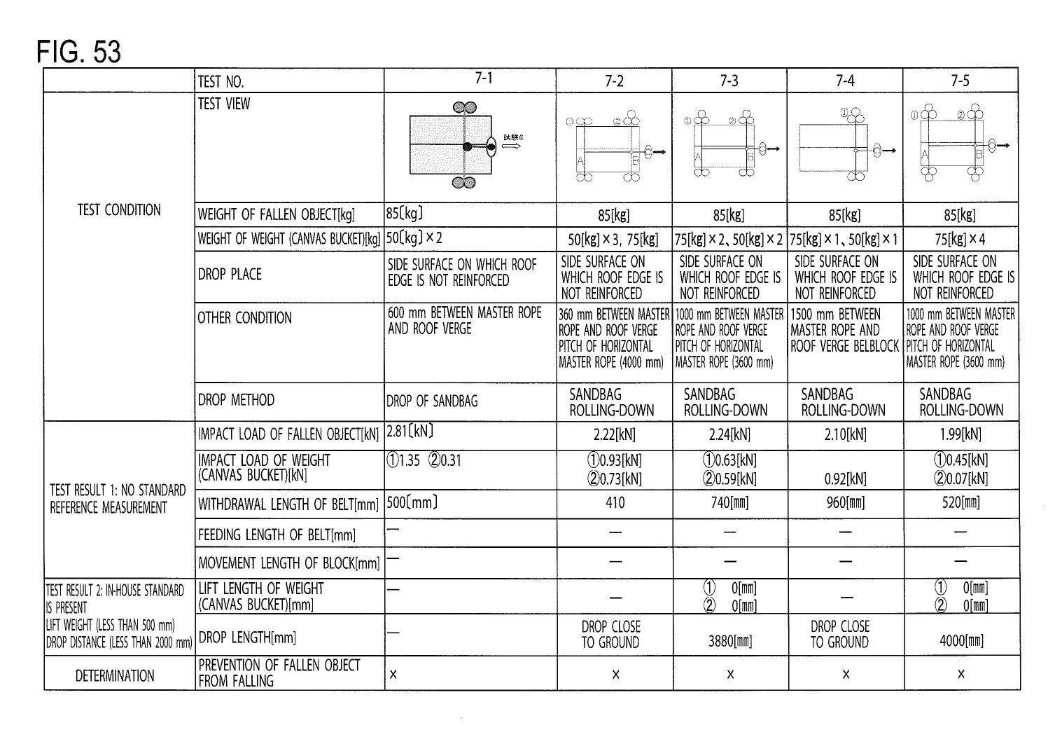

The test for the test result illustrated in FIG. 53 is to confirm whether it is possible to prevent the fall from the roof verge of the roof. One or two master ropes are used and in some cases, the horizontal rope was used. However, in any case, it was not impossible to prevent the fall.

In the test No. 7-1 in FIG. 53, the distance between the master rope and the roof verge of the roof was set to be 600 mm, but it was not possible to prevent the fall. Accordingly, in a jobsite where the fall in the lateral direction (fall from the roof verge) is concerned, it was confirmed that it is essential to permanently install the horizontal master rope for a stretch stopper. Furthermore, the test No. 7-1 was performed corresponding to the review on whether it was possible to prevent the fall from the roof verge using only the master rope.

In the test No. 7-2 in FIG. 53, the attachment pitch (distance between two master ropes) of the master rope was set to be 4,000 mm. In the test No. 7-2, due to the fall of the fallen object, one side fixed point (engaging portion A of the master rope and the horizontal rope) of the horizontal rope was moved by 1,030 mm to the right side, and the other side fixed point (engaging portion B of the master rope and the horizontal rope) of the horizontal rope was moved by 360 mm to the right side. The distance between the engaging portion B and the roof verge became 350 mm.

In the test No. 7-3 in FIG. 53, the attachment pitch (distance between two master ropes) of the master rope was set to be 3,600 mm. In addition, the distance between one master rope (master rope in the reference numeral B; right side master rope) and the roof verge of the roof (right side roof verge) was set to be 1,100 mm. In the test No. 7-3, due to the fall of the fallen object, one side fixed point (engaging portion A of the master rope and the horizontal rope) of the horizontal rope was moved by 3,680 mm to the right side, and the other side fixed point (engaging portion B of the master rope and the horizontal rope) of the horizontal rope was moved to the right side and fallen down by being deviated from the roof verge (roof).

In the test No. 7-4 in FIG. 53, the master rope was installed at the place, 1,500 mm away from the roof verge (right side roof verge). In the test No. 7-4, due to the fall of the fallen object, the master rope was deviated from the roof verge (roof 113).

In the test No. 7-5 in FIG. 53, the attachment pitch (distance between two master ropes 3) of the master rope was set to be 3,600 mm. In addition, the left side master rope was installed at the place, 600 mm away from the roof verge (left side roof verge) and the right side master rope was installed at the place, 1,000 mm away from the roof verge (right side roof verge). In the test No. 7-5, due to the fall of the fallen object, the master rope (right side master rope) in the reference numeral B side was fallen down by being deviated from the roof verge (roof). Furthermore, the figure eight ring 157 installed at the place indicated by the reference numeral A was moved by 3,200 mm to the right side, due to the fall of the fallen object.

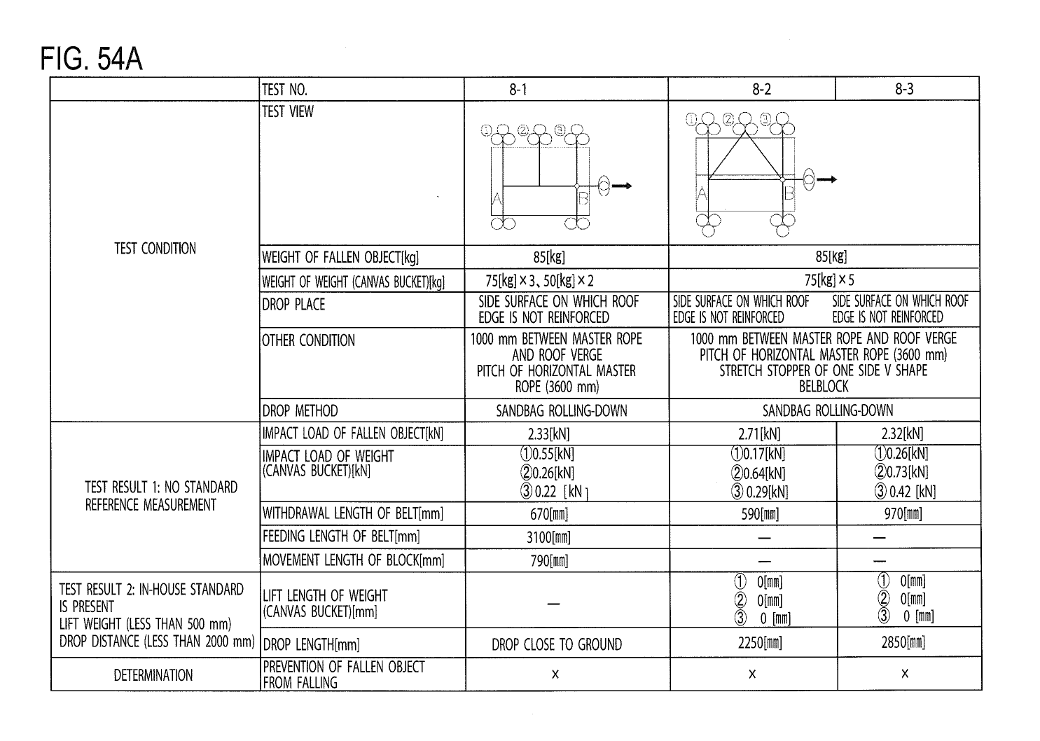

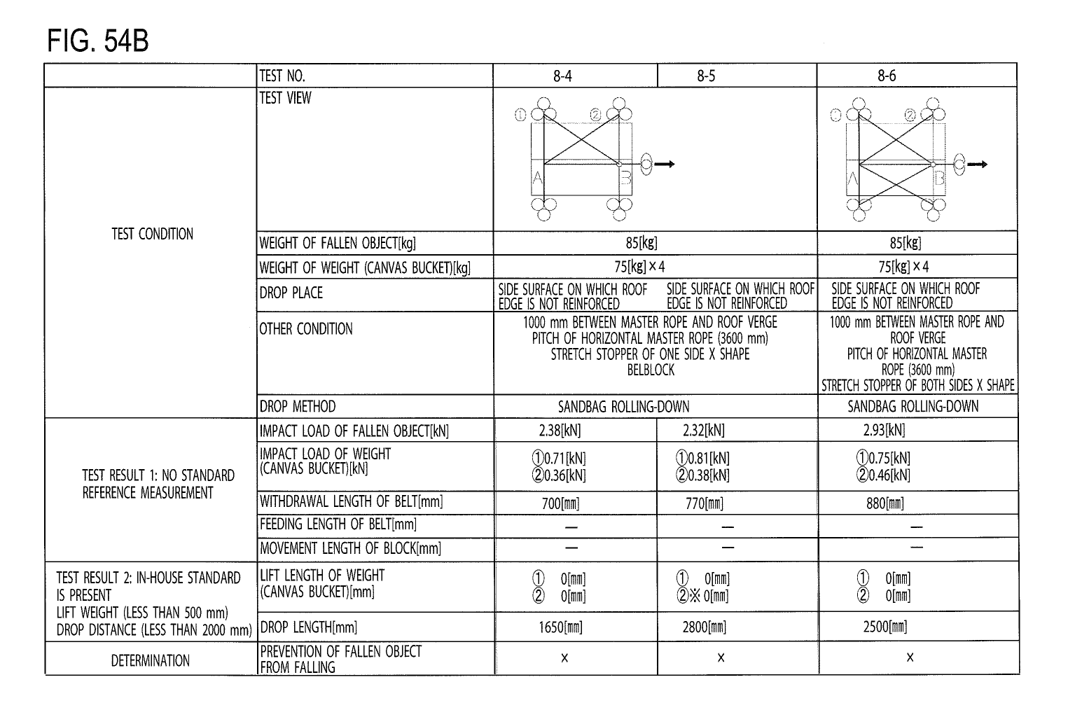

The tests for the test result in FIGS. 54A and 54B are to confirm whether it is possible to prevent the fall from the roof verge of the roof. In this test, two master ropes, one horizontal rope and one auxiliary master rope were used. However, even if the auxiliary master rope was installed, it was not possible to prevent the fall from the roof verge.

In the test No. 8-1 in FIG. 54A, the attachment pitch (distance between two master ropes) of the master rope was set to be 3,600 mm. The right side master rope (master rope in the reference numeral B side) was installed at the place, 1,000 mm away from the roof verge (right side roof verge) of the roof. In the test No. 8-1, due to the fall of the fallen object, one side fixed point (engaging portion A of the master rope and the horizontal rope) of the horizontal rope was moved by 790 mm to the right side, and the other side fixed point (engaging portion B of the master rope and the horizontal rope) of the horizontal rope was moved to the right side and fallen down by being deviated from the roof verge (roof).

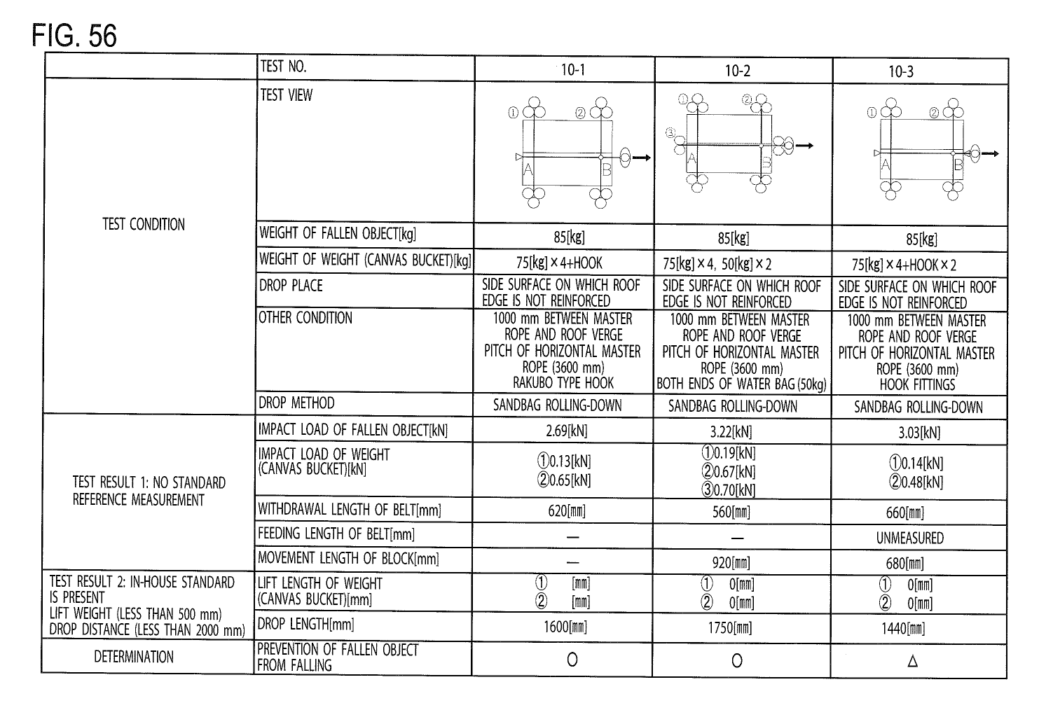

In the test Nos. 8-2 and 8-3 in FIG. 54A, the stretch stopper having a “V” shape was adopted. All the tests in FIGS. 54A and 54B are performed considering whether or not it is possible to prevent the fall by only the rope working. However, in any case, it was found out that it is not possible to prevent the fall by only the rope working of the master rope. Then (refer to FIGS. 56 to 58), it was determined that the weight is required at the opposite side with respect to the drop direction and thereby the tests was additionally performed.

Furthermore, in the test Nos. 8-2 and 8-3 in FIG. 54A, although the belt is caught in the screw head on the roof and the fall is prevented, the fall is not prevented in effect. In addition, in the test Nos. 8-2 and 8-3 in FIG. 54A, due to the fall of the fallen object, a water-bag (bucket) was moved by approximately 1 meter. In the test No. 8-6 in FIG. 54B, the water-bag (bucket) was moved by approximately 300 mm.

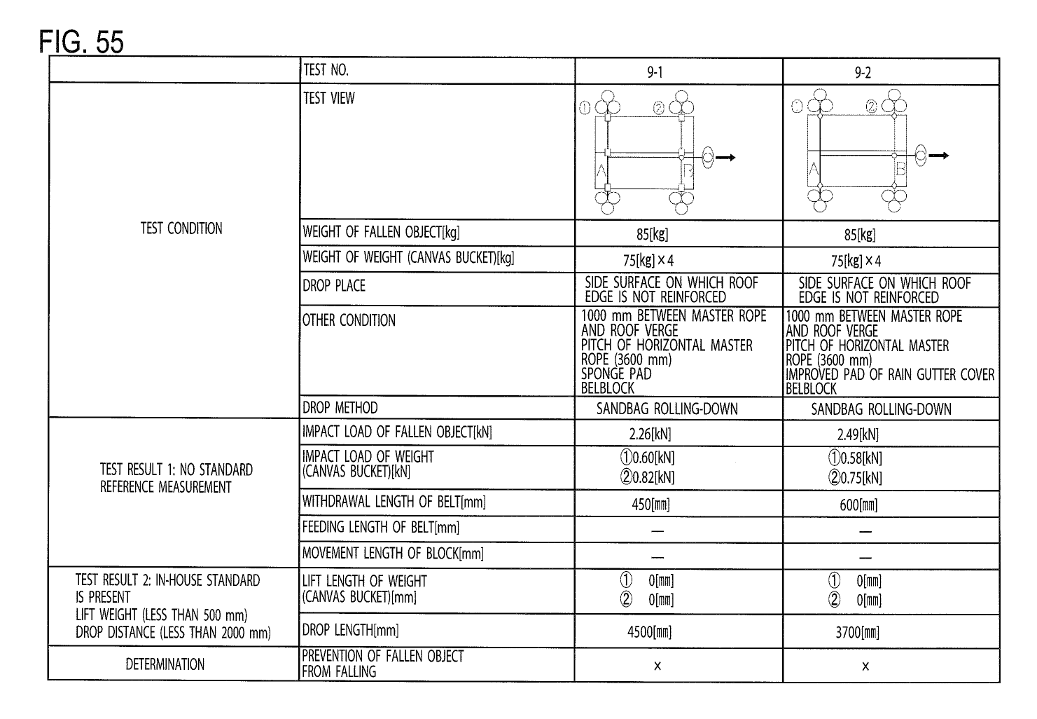

The test for the test result illustrated in FIG. 55 was performed in order to confirm whether or not it was possible to prevent the fall from the roof verge by providing a slip stopper such as the pad between the master rope and the roof (for example, the ridge or the roof edge). It was found out that it was not possible to prevent the fall from the roof verge even if the slip stopper was used.

In the test No. 9-1 in FIG. 55, a thick sponge was used as the pad, but it was not possible to prevent the fall from the roof verge.

In the test No. 9-2 in FIG. 55, an improved product of a rain gutter cover was used at the four places, as the pad, but in this case as well, it was not possible to prevent the fall from the roof verge.

The test for the test result illustrated in FIG. 56 was performed in order to confirm whether or not it was possible to prevent the fall from the roof verge by using the hook for the roof verge. In this test, two master ropes, one horizontal rope, the auxiliary horizontal rope and the hook for the roof verge (or the weight) were used. As a result of the test, if the weight was used and the weight of the weight was 75 kg or more, in a case where the weight of the fallen object is 85 kg, it was possible to prevent the fall. In addition, if the fallen object of 85 kg was fallen down and the hook for the roof verge was not elastically deformed, the determination (determination on whether or not it was possible to prevent the fallen object from falling) in a case of using the hook for the roof verge was made such that it was possible to prevent the fallen object from falling in principle.

In the test No. 10-1 in FIG. 56, the master rope (left side master rope) in the reference numeral A side was supported by the hook (hook for the roof verge) of a roof rope. As a result, it was possible to prevent the fall.

In the test No. 10-2 in FIG. 56, the water-bags (buckets of 50 kg in weight) are installed at both ends of the horizontal rope. Even if the fallen object was dropped, the master rope was not stretched and it was possible to prevent the fall. In the test No. 10-3 in FIG. 56, both ends of the horizontal rope were supported by hook fittings (hook for the roof verge, hooked on the roof verge of the roof). As a result, the hook was deformed due to the drop impact of the fallen object, since a trial product was used as the hook in the reference numeral A side. Then, by using the current product (improved product illustrated in FIG. 26) as the hook, the hook was not deformed and consequently it was possible to prevent the fall.

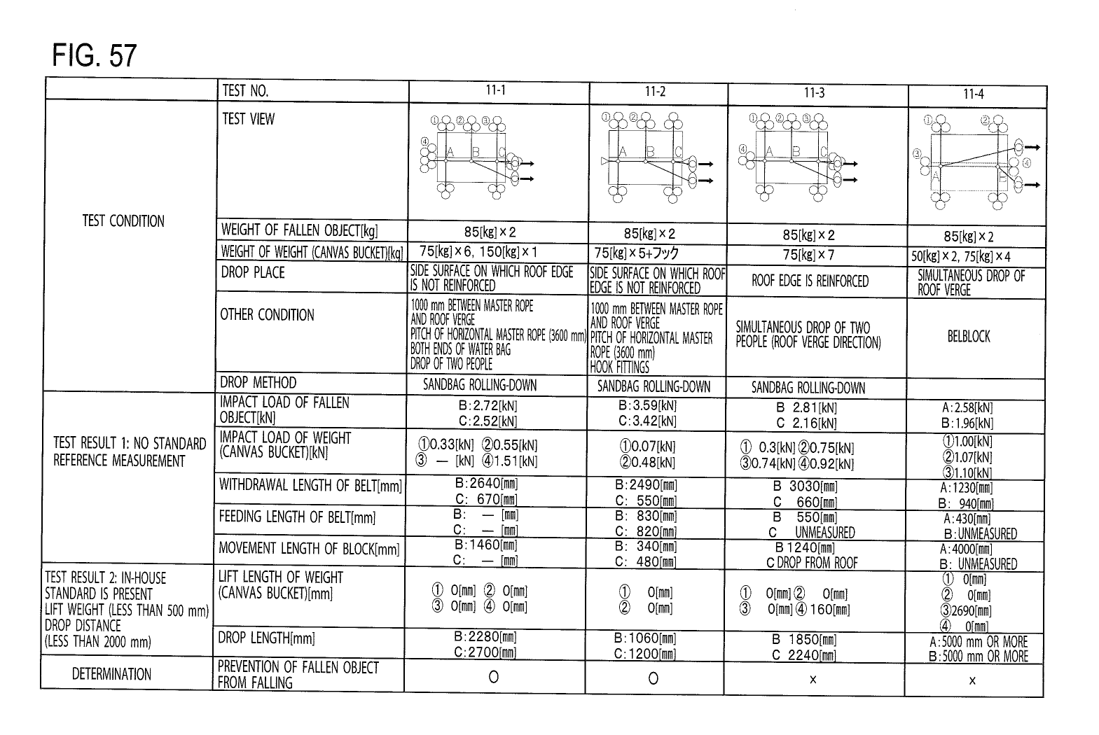

The test for the test result illustrated in FIG. 57 was performed in order to confirm whether it was possible to prevent a plurality of persons from falling from the roof verge. In this test, two master ropes, one horizontal rope, the auxiliary horizontal rope and the hook for roof verge (or the weight) were appropriately used. As a result, if the weight was used and the weight of the weight was 150 kg or more, when the weight of the fallen object was 85 kg×2, it was possible to prevent the fall. In a case where the hook for the roof verge was used, even if the weight of the fallen body was 85 kg×2, the hook for the roof verge 207 was not plastic-deformed due to the fall and it was possible to prevent the fall.

In the test No. 11-1 in FIG. 57, the master rope (rightmost master rope) in the reference numeral C side was deviated from the roof due to the fall of the fallen object, but it was possible to prevent the fall. In addition, even if the master rope in the reference numeral C side was deviated from the roof, the load was applied to the side rope (horizontal rope). Accordingly, the drop distance did not become larger than the specified amount.

In the test No. 11-2 in FIG. 57, even if the fallen object was dropped, the hook for the roof verge was not plastic-deformed. In addition, since the impact was not absorbed due to the extended rope when fallen, the impact load due to the fall increased.

In the test No. 11-3 in FIG. 57, the master rope was caught in the ridge of the roof and the fall was prevented. Accordingly, in the test No. 11-3, it was considered that it was not possible to prevent the fall in practice.

In the test No. 11-4 in FIG. 57, the attachment pitch (distance between two master ropes) of the master rope was set to be 4,000 mm. The master rope (right side master rope) in the reference numeral B side was installed at the place, 1,000 mm away from the right side roof verge of the roof. Due to the fall of the fallen object, the water-bag (weight) indicated by the FIG. 1 in a circle was moved by approximately 2,000 mm in the transverse direction and the water-bag (weight) indicated by the FIG. 3 in a circle was moved by approximately 1,400 mm in the transverse direction.

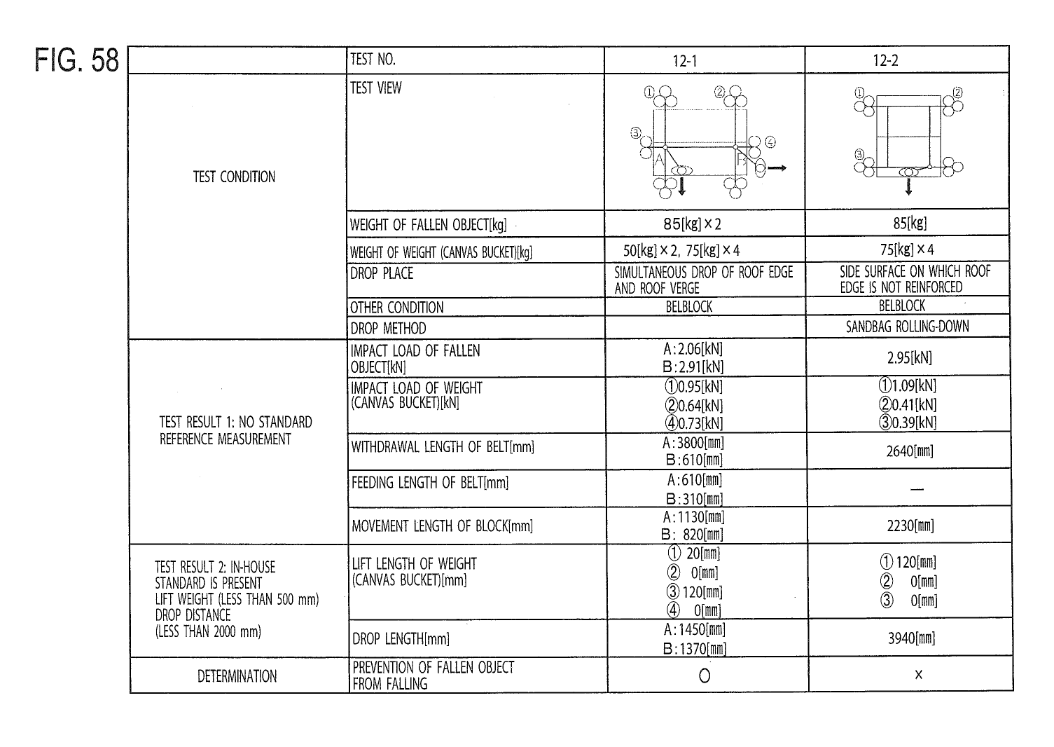

The test for the test result illustrated in FIG. 58 was to verify whether or not it was possible to prevent the fall from the roof verge of the roof with a further separated embodiment.

In the test No. 12-1 in FIG. 58, the attachment pitch (distance between two master ropes) of the master rope was set to be 4,000 mm. In addition, the master rope (right side master rope) in the reference numeral B side was installed at the place, 1,000 mm away from the right side roof verge. Due to the fall of the fallen object, the master rope was moved by 4,070 mm between the reference numeral A and the reference numeral B, and the water-bag (weight) was moved by 1,000 mm in the transverse direction.

The test No. 12-2 in FIG. 58 is to validate the stretch stopper of a hipped roof. The hipped roof is the roof of four gradient surfaces of the roof. The four surfaces of the roof are configured of two triangles (isosceles triangles) and two trapezoids (isosceles trapezoids).

Furthermore, in the tests illustrated in FIGS. 46 to 56, the fallen object, the master rope and the like are connected using the retractable fall arrester illustrated in FIG. 18. However, even if the fallen object, the master rope and the like are connected using a Rorip (safety device) illustrated in FIG. 17, substantially the similar result can be obtained.

### REFERENCE SIGNS LIST

2 master rope deployment tool
50 worker
101 fall prevention system
103 master rope
105 weight (canvas bucket)
107 retractable fall arrester
109 house
111 ridge
113 roof
115 connection rope (master-rope-guided slide equipment)
139 harness
157 figure eight ring
171 horizontal rope
183 roof verge
201 auxiliary master rope
203 auxiliary master rope weight
205 auxiliary horizontal rope
207 hook (roof verge hook)
351 four-hole member
353 first through hole
355 second through hole
357 third through hole
359 fourth through hole
361 main body portion (main body portion of four hole member)
371, 375 auxiliary rope
373, 377 ratchet device
GL ground

1. A fall prevention system comprising:
a master rope that passes over a roof of a house having a ridge, from the vicinity of the ground on one side of the house, and is installed by being extended to the vicinity of the ground on the other side of the house;
a weight that is configured of buckets, is connected to the master rope at an end portion of the master rope, and is installed on the ground; and
a retractable fall arrester that connects a harness worn by a worker who works on the roof to the master rope.

2-9. (canceled)

10. The fall prevention system according to claim 1,
wherein the weight is divided into a plurality of weights.

11. The fall prevention system according to claim 1,
wherein the weight is configured to be used as a container which accommodates the master rope, the harness and the retractable fall arrester.

12. The fall prevention system according to claim 1,
wherein one worker is supported by one master rope, and
wherein the mass of the weight connected to the end of the one master rope is smaller than the mass of the one worker.

13. The fall prevention system according to claim 1,
wherein the weight is a canvas bucket.

14-20. (canceled)

21. A bucket of a fall prevention system that is connected to an end portion of a master rope that passes over a roof of a house having a ridge, from the vicinity of the ground on one side of the house, and is installed by being extended to the vicinity of the ground on the other side of the house, that is filled with water and installed on the ground in order to stretch the master rope, and that acts as the weight.

22. A bucket comprising:
a main body portion for containing water;
a reinforced portion that is formed in a ring shape and is provided integrally with the main body portion along an annular opening portion of the main body portion; and
a hand strap which is formed in a band shape, one end side section in the longitudinal direction of which is provided integrally with the main body portion, the other end side section in the longitudinal direction of which is provided integrally with the main body portion, an intermediate portion in the longitudinal direction of which is formed in a “U” shape or a “V” shape, and which is extended out from the opening portion of the main body portion.

23. The bucket according to claim 22,
wherein the main body portion is configured of a cylindrical sidewall portion and a flat plate-shaped bottom wall portion,
wherein the reinforced portion is provided at the sidewall portion, and
wherein the hand strap is provided so as to extend from the opening portion of the main body portion to the boundary between the sidewall portion and the bottom wall portion, at the sidewall portion.

24. The bucket according to claim 23,
wherein the bottom wall portion is formed in a disk shape,
wherein the hand strap is configured of a first hand strap and a second hand strap, and
wherein an extended length of the respective hand straps from the opening portion of the main body portion is approximately equal to a depth of the main body portion.

25. The bucket according to claim 23,
wherein rigidity of the bottom wall portion of the main body portion is higher than the rigidity of the sidewall portion of the main body portion.

26. The bucket according to claim 22,
wherein a scale is provided inside the main body portion in order to indicate a specified amount of water to be contained in the main body portion.

27. A bucket comprising:
an inner structure body with a waterproof structure, which includes a cylindrical inner sidewall portion configured of a waterproof sheet and a flat plate-shaped inner bottom wall portion configured of the waterproof sheet, and which is formed in a measuring container shape;
a bottom portion reinforced body that is formed in a disk shape whose diameter is approximately equal to the diameter of the inner bottom wall portion, that is in contact with or slightly separated from the inner bottom wall portion outside the inner structure body, and that is provided side by side with the inner bottom wall portion;
an outer structure body that includes an outer sidewall portion formed in a cylinder shape, whose height dimension is slightly higher than the height dimension of the inner sidewall portion, and whose inside diameter is slightly larger than the outside diameter of the inner sidewall portion, and an outer bottom wall portion in a measuring container shape, whose diameter is slightly larger than the diameter of the inner bottom wall portion, and that is provided outside of the inner structure body and the bottom portion reinforced body so as to accommodate the inner structure body and the bottom portion reinforced body inside;
an opening portion joint body that is formed in an annular band shape, and that is provided integrally with the inner structure body and the outer structure body so as to cover the edge of an opening portion of the inner structure body and the edge of the opening portion of the outer structure body;
a first hand strap which is formed in a band shape, one end side section in the longitudinal direction of which is extended in a generating line direction of the outer structure body from the opening portion of the outer structure body to the boundary between the outer sidewall portion and the outer bottom wall portion, at a predetermined first section outside of the outer structure body and is provided integrally with the outer structure body, and the other end side section in the longitudinal direction of which is extended in the generating line direction of the outer structure body from the opening portion of the outer structure body to the boundary between the outer sidewall portion and the outer bottom wall portion, at a predetermined second section separated from the predetermined first section outside of the outer structure body and is provided integrally with the outer structure body, the intermediate portion in the longitudinal direction of which is formed in a “U” shape or a “V” shape, and which is extended out from the opening portion of the outer structure body;
a second hand strap which is formed in a band shape, one end side section in the longitudinal direction of which is extended in a generating line direction of the outer structure body from the opening portion of the outer structure body to the boundary between the outer sidewall portion and the outer bottom wall portion, at a predetermined third section separated from the predetermined first section and the predetermined second section outside of the outer structure body and is provided integrally with the outer structure body, and the other end side section in the longitudinal direction of which is extended in the generating line direction of the outer structure body from the opening portion of the outer structure body to the boundary between the outer sidewall portion and the outer bottom wall portion, at a predetermined fourth section separated from the predetermined first section, the predetermined second section and the predetermined third section outside of the outer structure body and is provided integrally with the outer structure body, the intermediate portion in the longitudinal direction of which is formed in a “U” shape or a “V” shape, and which is extended out from the opening portion of the outer structure body;
a reinforced portion which is formed in an annular band shape, and is provided integrally with the outer structure body along the opening portion of the outer structure body in the vicinity of the opening portion of the outer structure body, outside of the outer structure body and the respective hand straps; and
a scale which is provided inside the inner structure body in order to indicate a specified amount of water to be contained in the inner structure body.

28. (canceled)
